(19) United States
(12) Patent Application Publication
(10) Pub. No.: US 2009/0217008 A1
(43) Pub. Date: Aug. 27, 2009

(54) Program conversion device, and secret keeping program

(76) Inventors: Taichi Sato, Osaka (JP); Motoji Ohmori, Osaka (JP); Rieko Asai, Osaka (JP); Yuichi Futa, Osaka (JP); Tomoyuki Haga, Nara (JP); Masahiro Mambo, Ibaraki (JP)

Correspondence Address: WENDEROTH, LIND & PONACK L.L.P., 1030 15th Street, N.W., Suite 400 East, Washington, DC, 20005-1503, US

(21) Appl. No.: 11/918,785

(22) PCT Filed: Apr. 21, 2006
(86) PCT No.: PCT/JP2006/308454

§ 371 Date: Dec. 2, 2008

(30) Foreign Application Priority Data
Apr. 21, 2005 (JP) 2005-124115
Dec. 28, 2005 (JP) 2005-379128

(51) Int. Cl. G06F 9/302; G06F 9/30

(52) U.S. Cl. 712/221; 712/E09.016; 712/220; 712/E09.017

(57) ABSTRACT

Provided is a program conversion apparatus for generating a secret holding program, which disables a malicious analyzer from analyzing the an original program easily.

The program conversion apparatus generates a first instruction group for acquiring values to assign to selection parameters; a second instruction group that includes an instruction group for acquiring, based on an arithmetic expression that uses the selection parameters, a selection identifier showing a selection-target data piece to be processed next; a third instruction group for updates a value of each selection parameter so as to reflect one of (a) a selection identifier showing one of the selection-target data pieces that has already been processed, and (b) at least one of one or more values that have already been assigned to the selection parameters; and selection-target data pieces that, by processing in a predetermined order, output an execution result identical to a result of the original program, each of the selection-target data pieces being in correspondence with a different selection identifier. The program conversion apparatus generates the secret holding program so as to include the first instruction group, the second instruction group, the third instruction group and the selection-target data pieces.

### TECHNICAL FIELD

The present invention relates to a technique for converting a program that is executed holding secret information into a program that makes malicious analyzing of secret information difficult.

### BACKGROUND ART

Conventionally, there is a demand to prevent malicious analyzers from analyzing programs that perform processing using secret elements. One example of such a program is an encryption program. An encryption program performs processing using an encryption key which is secret information, and there is a desire to prevent this from being analyzed.

A further example is a program that performs detection of a watermark showing copy control information embedded in an image. There is a danger that a tool to remove that watermark embedded in The image will be created if the watermark detection program is analyzed by a malicious analyzer, and there is therefore a desire to make this kind of program difficult to analyze by a malicious analyzer. One example of a response to such a desire is to encrypt the program in advance, and then when the program is to be executed, decrypt the program before actually executing it. However, even if with this method, the program will be a plaintext on the memory when executed, and therefore will potentially be abstracted from the memory and analyzed. In response to this kind of danger, if the order in which the program instruction groups in the abstracted program are executed is made difficult to ascertain, it will be difficult to create a tool to remove the watermark.

One conventional method that has been conceived for preventing malicious analysis/modifying of a program that performs processing with secret elements is obfuscation of the program to make the control structure more complicated. This is done by converting the control structure/processing of the program to a different format from the original program, thus making the program difficult to analyze (see Non-Patent Document 1, for instance).

With the method disclosed in Non-Patent Document 1, the program is obfuscated by replacing program instructions that include secret information with a plurality of program instruction groups. For instance, if the confidential information in a program instruction “d0=1234” is “1234”, the program instruction “d0=1234” is replaced with a program instruction group “d0=100”, “d0=d0×2”, “d0=d0+30”, “d0=d0+1000”, “d0=d0+4”. The instructions in this group are arranged apart from each other in the program. With this kind of method, even if data of constants in the program is collected, the confidential information therein will not be able to be found.

However, if a malicious analyzer discovers the order of execution of the instruction groups in the program, the analyzer will able to find the confidential information by calculating the value of d0 by following the order of execution.

In response, one conventional method for making the order of execution of the program difficult to analyze is to control the order of execution of the instruction groups by utilizing a branch instruction that determines a branch destination based on a value showing an instruction group to be executed (e.g., a switch statement), and the array (see Non-Patent Document 2). Assume an example of a plurality of instruction groups in an original program being instruction groups 1 to 3 which are executed in the stated order. The instruction groups are in one-to-one correspondence with values that each show an instruction group to be executed, and at the end of each instruction group a program instruction is inserted for calculating a value showing the instruction group to be executed next according to a calculation formula using the array, and storing the calculated value in a variable Var used in a switch statement. Taking an example of the number of elements in the array being 10, the inserted program instruction may be Var=g[3]+g[4].

Accordingly, even if the instruction groups 1 to 3 are arranged out of order, the correct order of execution will be maintained due to the switch statement, and arranging the instruction groups 1 to 3 out of order makes the structure of the original program more difficult to ascertain. In other words, this makes analysis of a watermark detection program, acquisition of the confidential information, and the like more difficult.

Non-Patent Document 1: Kamoshida, Matsumoto, Inoue, “On Constructing Tamper Resistant Software”, ISEC 97-59

Non-Patent Document 2: Chenxi Wang, “A Security Architecture for Survivability Mechanisms”, Ph. D. Dissertation (2000)

### DISCLOSURE OF THE INVENTION

### Problem to be Solved by the Invention

However, the program instruction at the end of each instruction group and the data stored in the array may potentially be acquired from the storage area of a computer apparatus. If, the program instruction at the end of each instruction group and the data stored in the array become known to a malicious analyzer, the analyzer will be able to acquire the value of the variable used in the switch statement, and by reconstructing the control structure of the original program, will easily be able to analyze the original program.

In view of this problem, an object of the present invention is to provide a program conversion apparatus that generates a secret holding program of which an original program cannot be easily analyzed by a malicious analyzer, a secret processing apparatus that executes the secret holding program, a conversion method, and a secret processing method.

### Means to Solve the Problem

In order to achieve the stated object, the present invention is a program conversion apparatus for generating a secret holding program from an original program, including: a program acquisition unit operable to acquire an original program; a selection-target data generation unit operable to generate a plurality of selection-target data pieces that, by processing in a predetermined order, output an execution result identical to a result of the original program, each of the selection-target data pieces being in correspondence with a different selection identifier; a preprocessing instruction group generation unit operable to generate a preprocessing instruction group that assigns a value to each of a plurality of selection parameters; a selection processing instruction group generation unit operable to generate a selection processing instruction group that includes an instruction group that acquires, in accordance with an arithmetic expression that uses the selection parameters, a selection identifier that shows a one of the selection-target data pieces that is to be processed next; an update processing instruction group generation unit operable to generate an update processing instruction group that updates a value of each selection parameter so as to reflect one of (a) a selection identifier showing one of the selection-target data pieces that has already been processed, and (b) at least one of one or more values that have already been assigned to the selection parameters; and a secret holding program generation unit operable to generate a secret holding program that (a) includes the preprocessing instruction group, the processing selection instruction group, the update processing instruction group, and the selection-target data pieces, and (b) repeatedly performs (i) processing to execute the processing selection instruction group, (ii) processing to process a one of the selection-target data pieces that is shown by the selection identifier acquired by the selection processing instruction group, and (iii) processing to execute the update processing instruction group when the selection-target data piece shown by the acquired selection identifier has been processed.

### EFFECTS OF THE INVENTION

According to the stated structure, when updating the selection parameters of the arithmetic expression, the secret holding program generated by the program conversion apparatus updates a value of each selection parameter so as to reflect one of (a) a selection identifier showing one of the selection-target data pieces that has already been processed, and (b) at least one of one or more values that have already been assigned to the selection parameters. Conventionally, an array that stores a plurality of fixed values is used when determining the next block to be executed. However, after determining the next block to be executed, the secret holding program generated by the program conversion apparatus of the present invention always updates the parameters used in the arithmetic expression. This makes it difficult to specify the values, stored in the selection parameters, and therefore amalicious analyzer cannot easily analyze the original program.

Here, the predetermined order may be an order of selection identifiers successively calculated by, after giving a predetermined initial value to each selection parameter, repeatedly executing the selection processing instruction group and the update processing instruction group.

According to the stated structure, the program conversion apparatus generates a secret holding program that outputs the same execution result as the execution result of the original program when predetermined initial values are given to the selection parameters.

Here, each selection-target data piece may be composed of one or more data pieces.

According to the stated structure, the program conversion apparatus generates a secret holding program that processes selection-target data as data.

Here, the original program may include secret information that is to be kept confidential, the selection processing instruction group generation unit may generate a selection processing instruction group composed of an instruction group that calculates the selection identifier according to a first arithmetic expression that uses the selection parameters, the update processing instruction group generation unit may generate an update processing instruction group for updating the selection parameters in accordance with a value of the one of the selection-target data pieces shown by the calculated selection target identifier, and the program conversion apparatus may, further include: a transition processing instruction group generation unit operable to generate a transition processing instruction group for calculating a value the same as a value of the secret information, according to a second arithmetic expression that uses the updated selection parameters, wherein the secret holding program generation unit arranges the generated transition processing instruction group in a position that is between a position of the update processing instruction group and a position of the secret information, and replaces the secret information with processing for calculating the secret information by way of the transition processing instruction group.

According to the stated structure, with the preprocessing instruction group, the update processing instruction group and the transition processing instruction group, the secret holding program generated by the program conversion apparatus keeps confidential the method for calculating values the same as the values of the secret information. Therefore a malicious analyzer cannot easily analyze the secret information.

Here, the program conversion apparatus may further include: a dividing unit operable to divide the original program into one or more blocks, wherein each of the selection-target data pieces includes a different one of the blocks.

According to the stated structure, the program conversion apparatus generates a secret holding program that processes selection-target data pieces as blocks obtained by dividing the original program.

Here, each of the selection parameters may be a different one of first to n-th selection parameters, the update processing instruction group generation unit may generate an update processing instruction processing group for, with respect to each selection-target data piece, shifting a value stored in a (j−1)-th selection parameter to a j-th selection parameter, and storing a constant value in the first selection parameter, where j is an integer no less than 2 and no greater than n.

According to the stated structure, the secret holding program generated by the program conversion apparatus updates a value of each selection parameter so as to reflect at least one of one or more values that have already been assigned to the selection parameters in the arithmetic expression.

Here, the number of selection-target data pieces may be a predetermined number that is equal to or greater than the number of blocks, the arithmetic expression may calculate a Pi×i-th selection parameter with respect to each of the first to n-th selection parameters, adds each of results of the calculations, subject a result of the addition to a modulo operation in which a modulo value N is the predetermined number, and thereby generate a selection identifier, where i is an integer no less than 1 and no greater than n, and Pi and the modulo value N are coprimes.

According to the stated structure, the program conversion apparatus is able to reliably determine a selection-target data piece with use of the arithmetic expression.

Here, the selection-target data generation unit may include: an identifier storage sub-unit operable to store each selection identifier that has been calculated according to the arithmetic expression up to a current point in time; an execution sub-unit operable to select one value for one of the blocks, shift a value stored in a (j−1)-th selection parameter to a j-th selection parameter, store the selected value in a first selection parameter, and then execute the arithmetic expression, where j is an integer no less than 2 and no greater than n; a judgment sub-unit operable to judge whether or not any of the selection identifiers stored in the storage sub-unit is identical to a calculated value; a block storing sub-unit operable to, when a result of the judgment by the judgment sub-unit is negative, set the selection value as the constant value for the one block, and store the one block in a one of the selection-target data pieces shown by the calculated value; and a repeat control unit operable to, when the result of the judgment by the judgment sub-unit is affirmative, control such that the processing by the execution sub-unit and the judgment sub-unit is repeated until the constant value is determined and the one selection block is stored in the one of the selection-target data pieces, wherein the processing by the selection-target data generation unit is executed with respect to all of the blocks.

According to the stated structure, with use of the arithmetic expression of the update processing instruction group, the program conversion apparatus updates the selection parameters such that the selection-target data piece selected to storing the next block will be a selection-target data piece that has not stored a block up to the present. As a result, the program conversion apparatus is able to reliably determine a selection-target data piece with use of the arithmetic expression that uses the selection parameters. Therefore, the secret holding program is able to provide a function equivalent to the function of the original program.

Here, the selection processing instruction group generation unit may generate a selection processing instruction group that always acquires an identifier showing an unexecuted selection-target data piece.

According to the stated structure, the secret holding program generated by the program conversion apparatus always acquires a selection-target data piece that includes an unexecuted block. Furthermore, with the selection processing instruction group, the secret holding program always selects a different selection-target data piece as the next selection-target data piece to be executed. Therefore, it is difficult for a malicious analyzer to specify the correct execution order.

Here, the selection processing instruction group generation unit may generate a selection processing instruction group for acquiring an identifier showing an unexecuted selection-target data piece with use of management information that shows, for each of the selection-target data pieces, whether the selection-target data piece has already been executed or not.

According to the stated structure, with use of the management information, the secret holding program generated by the program conversion apparatus always acquires a selection-target data piece that includes an unexecuted block.

Here, each of the selection parameters may be a different one of first to n-th selection parameters, the management information may be an array table showing a status of each of the selection-target data pieces at a current point in time, the status being one of already-executed and unexecuted, the number of selection-target data pieces may be a predetermined number that is equal to or greater than the number of blocks, the selection processing instruction group generation unit may generate (a) the array table, (b) the arithmetic expression that calculates a Pi×i-th selection parameter with respect to each of the first to n-th selection parameters, adds each of results of the calculations, subjects a result of the addition to a modulo operation in which a modulo value N is the predetermined number, and thereby generates a provisional selection identifier showing a one of the selection-target data pieces that includes a one of the blocks to be executed next, where i is an integer no less than 1 and no greater than n, and (c) an acquisition program generation group for, (i) when the one of the selection-target data pieces shown by the calculated provisional selection identifier is shown in the array table as being unexecuted, setting the provisional selection identifier as a true selection identifier showing a one of the selection-target data pieces that includes the block to be executed next, and (ii) when the one of the selection-target data pieces shown by the calculated provisional selection identifier is shown in the array table as being already-executed, continue to acquire provisional selection identifiers in accordance with a predetermined selection order, until an unexecuted one of the selection-target data pieces is acquired, and the selection processing instruction group may include the array table, the arithmetic expression, and the acquisition program instruction group, where Pi and the modulo value N are coprimes.

According to the stated structure, with use of the array table, the secret holding program generated by the program conversion apparatus is able to reliably acquire a selection-target data piece that includes an unexecuted block.

Here, the update processing instruction group generation unit may generate the update processing instruction group for shifting a value stored in a j-th selection parameter to a (j−1)-th selection parameter, and storing the true selection identifier in an n-th variable, where j is an integer no less than 2 and no greater than n.

According to the stated structure, when updating the selection parameters, the secret holding program generated by the program conversion apparatus always updates a value of each selection parameter so as to reflect one of (a) a selection identifier showing one of the selection-target data pieces that has already been processed, and (b) at least one of one or more values that have already been assigned to the selection parameters. This makes it difficult to specify the values stored in the selection parameters.

Here, the arithmetic expression may be a first acquisition program instruction group that acquires one selection parameter from among the selection parameters, with use of an index showing the one selection parameter, the management information may be an array table showing a status of each of the selection-target data pieces at a current point in time, the status being one of already-executed and unexecuted, the selection processing instruction group generation unit may generate (a) the first program instruction group, (b) the array table, and (c) a second acquisition program instruction group that, in accordance with an array order of one or more selection identifiers showing one or more selection-target data pieces that are shown in the array table as being unexecuted, acquires a selection identifier whose place in the order is shown by a value of the selection parameter acquired by the acquisition program instruction group, and the selection processing instruction group may include the first program instruction group, the array table, and the second acquisition program instruction group.

According to the stated structure, the secret holding program generated by the program conversion apparatus uses the index to acquire a selection identifier that shows the next selection-target data piece to be executed.

Here, the update processing instruction group generation unit may generate the update processing instruction group that increments a value of the index.

According to the stated structure, the secret holding program generated by the program conversion apparatus updates the index. Since a malicious analyzer will not know the value of the index, even if he/she finds out one block, he will not be able to specify the next block to be executed. Therefore a malicious analyzer cannot easily analyze the original program.

Here, the number of selection-target data pieces may be a predetermined number that is equal to or greater than the number of blocks, each of the selection parameters may be a different one of first to n-th selection parameters, the management information may be an array table showing a status of each of the selection-target data pieces at a current point in time, the status being one of already-executed and unexecuted, the selection processing instruction group generation unit may generate (a) the array table, (b) the arithmetic expression that calculates a Pi×i-th selection parameter with respect to each of the first to n-th selection parameters, adds each of results of the calculations, subjects a result of the addition to a modulo operation in which a modulo value N is the predetermined number, and thereby calculates a value showing a one of the selection-target data pieces that includes a one of the blocks to be executed next, where i is an integer no less than 1 and no greater than n, and (c) an acquisition program generation group for, in accordance with an array order of one or more selection identifiers showing one or more selection-target data pieces that are shown as being unexecuted in a table that is identical to the array table, acquiring a selection identifier whose place in the order is shown by a value of the selection parameter acquired according to the arithmetic expression, and the selection processing instruction group may include the array table, the arithmetic expression, and the acquisition program instruction group.

According to the stated structure, the secret holding program generated by the program conversion apparatus can reliably acquire a selection-target data piece that includes an unexecuted block. Furthermore, with the selection processing instruction-group, the secret holding program always selects a different selection-target data piece as the next selection-target data piece to be executed. Therefore, it is difficult for a malicious analyzer to specify the correct execution order.

Here, the number of selection-target data pieces may be a predetermined number that is equal to or greater than the number of blocks, and after the blocks have been incorporated into the selection-target data pieces, the secret holding program generation unit may insert a dummy block in each one or more of the selection-target data pieces into which none of the blocks has been incorporated, each dummy block being composed of one or more program instructions.

According to the stated structure, the secret holding program generated by the program conversion apparatus includes dummy blocks. This makes analysis difficult for a malicious analyzer.

Furthermore, the present invention is a secret processing apparatus for executing secret processing to be kept confidential, by processing a plurality of selection-target data pieces that have a predetermined order of processing, the secret processing apparatus including: a preprocessing execution unit operable to assign a value to each of a plurality of selection parameters; a selection processing execution unit operable to, in accordance with an arithmetic expression that uses the selection parameters, acquire a selection identifier that shows a one of the selection-target data pieces that is to be processed next; an update processing execution unit operable to update a value of each selection parameter so as to reflect one of (a) a selection identifier showing one of the selection-target data pieces that has already been processed, and (b) at least one of one or more values that have already been assigned to the selection parameters; and a selection-target data execution unit operable to process the one of the selection-target data pieces shown by the acquired selection identifier, wherein the processing by the selection processing execution unit, the update processing instruction execution unit and the selection-target data execution unit is repeated until it is deemed that the secret holding program ends.

According to the stated structure, when updating the selection Parameters of the arithmetic expression, the secret processing apparatus updates a value of each selection parameter so as to reflect one of (a) a selection identifier showing one of the selection-target data pieces that has already been processed, and (b) at least one of one or more values that have already been assigned to the selection parameters. Conventionally, an array that stores a plurality of fixed values is used when determining the next block to be executed. However, after determining the next block to be executed, the secret processing apparatus of the present invention always updates the parameters used in the arithmetic expression. This makes it difficult to specify the values stored in the selection parameters, and therefore a malicious analyzer cannot easily analyze the original program.

Here, each selection-target data piece may be composed of one or more data pieces.

According to the stated structure, the secret processing apparatus processes selection-target data as data.

Here, the secret processing may be processing that calculates the secret information by executing predetermined processing instead of using the secret information to be kept confidential, the selection processing execution unit may calculate the selection identifier according to the arithmetic expression that uses the selection parameters, the update processing execution unit may update the selection parameters in accordance with a value of the one of the selection-target data pieces shown by the selection identifier, and the secret processing apparatus may further include: a transition processing instruction unit operable to calculate a value the same as a value of the secret information, according to the predetermined processing that uses the updated selection parameters.

According to the stated structure, the secret processing apparatus keeps confidential that method for calculating values the same as the values of the secret information. Therefore a malicious analyzer cannot easily analyze the secret information.

Here, the secret processing may be processing is processing that executes an original program that has been divided into one or more blocks by an external apparatus, each block may include one or more program instructions, and each of the selection-target data pieces may include a different one of the blocks.

According to the stated structure, the secret processing apparatus processes selection-target data pieces as blocks obtained by dividing the original program.

Here, each of the selection parameters may be a different one of first to n-th selection parameters, the update processing execution unit, with respect to each selection-target data piece, may shift a value stored in a (j−1)-th selection parameter to a j-th selection parameter, and store a constant value in the first selection parameter, where j is an integer no less than 2 and no greater than n, and the constant value may be a value that is set in advance when the external apparatus generates the secret holding program, and set such that a selection identifier showing a one of the selection-target data piece to be executed next is calculated using the arithmetic expression.

According to the stated structure, the secret processing apparatus updates a value of each selection parameter so as to reflect at least one of one or more values that have already been assigned to the selection parameters in the arithmetic expression.

Here, the number of selection-target data pieces may be a predetermined number that is equal to or greater than the number of blocks, and the arithmetic expression may calculate a Pi×i-th selection parameter with respect to each of the first to n-th selection parameters, add each of results of the calculations, subject a result of the addition to a modulo operation in which a modulo value N is the predetermined number, and thereby generate a selection identifier, where i is an integer no less than 1 and no greater than n, and Pi and the modulo value N are coprimes.

According to the stated structure, the secret processing apparatus is able to reliably determine a selection-target data piece with use of the arithmetic expression.

Here, the selection processing execution unit may always acquire an identifier showing an unexecuted selection-target data piece.

According to the stated structure, the secret processing apparatus always acquires a selection-target data piece that includes an unexecuted block. Furthermore, with the selection processing, the secret processing apparatus always selects a different selection-target data piece as the next selection-target data piece to be executed. Therefore, it is difficult for a malicious analyzer to specify the correct execution order.

Here, the selection processing execution unit may acquire an identifier showing an unexecuted selection-target data piece with use of management information that shows, for each of the selection-target data pieces, whether the selection-target data piece has already been executed or not.

According to the stated structure, with use of the management information, the secret processing apparatus always acquires a selection-target data piece that includes an unexecuted block.

Here, each of the selection parameters may be a different one of first to n-th selection parameters, the number of selection-target data pieces may be a predetermined number that is equal to or greater than the number of blocks, the management information may be an array table showing a status of each of the selection-target data pieces at a current point in time, the status being one of already executed and unexecuted, the selection processing execution unit may hold the array table, the arithmetic expression may calculate a Pi×i-th selection parameter with respect to each of the first to n-th selection parameters, add each of results of the calculations, subject a result of the addition to a modulo operation in which a modulo value N is the predetermined number, and thereby generate a provisional selection identifier showing a one of the selection-target data pieces that includes a one of the blocks to be executed next, where i is an integer no less than 1 and no greater than n, and the selection processing execution unit, (i) when the one of the selection-target data pieces shown by the calculated provisional selection identifier is shown in the array table as being unexecuted, may set the provisional selection identifier as a true selection identifier showing a one of the selection-target data pieces that includes the block to be executed next, and (ii) when the one of the selection-target data pieces shown by the calculated provisional selection identifier is shown in the array table as being already-executed, may continue to acquire provisional selection identifiers in accordance with a predetermined selection order, until an unexecuted one of the selection-target data pieces is acquired, where Pi and the modulo value N are coprimes.

According to the stated structure, with use of the array table, the secret processing apparatus is able to reliably acquire a selection-target data piece that includes an unexecuted block.

Here, the update processing execution unit may shifts a value stored in a j-th selection parameter to a (j−1)-th selection parameter, and store the true selection identifier in an n-th variable, where j is an integer no less than 2 and no greater than n.

According to the stated structure, when updating the selection parameters, the secret processing apparatus always updates a value of each selection parameter so as to reflect one of (a) a selection identifier showing one of the selection-target data pieces that has already been processed, and (b) at least one of one or more values that have already been assigned to the selection parameters. This makes it difficult to specify the values stored in the selection parameters.

Here, the management information may be an array table showing a status of each of the selection-target data pieces at a current point in time, the status being one of already-executed and unexecuted, and the selection processing execution unit (a) may hold the array table, and may include: a first acquisition sub-unit operable to, using an index that shows a selection parameter, execute the arithmetic expression, to acquire the first selection parameter from the plurality of selection parameters; and a second acquisition sub-unit operable to, in accordance with an array order of one or more selection identifiers showing one or more selection-target data pieces that are shown in the array table as being unexecuted, acquire a selection identifier whose place in the order is shown by a value of the selection parameter acquired by the acquisition program instruction group.

According to the stated structure, the secret processing apparatus uses the index to acquire a selection identifier that shows the next selection-target data piece to be executed.

Here, the update processing execution unit may increment a value of the index.

According to the stated structure, the secret processing apparatus updates the index. Since a malicious analyzer will not know the value of the index, even if he/she finds out one block, he will not be able to specify the next block to be executed. Therefore a malicious analyzer cannot easily analyze the original program.

Here, the number of selection-target data pieces may be a predetermined number that is equal to or greater than the number of blocks, each of the selection parameters may be a different one of first to n-th selection parameters, the management information may be an array table showing a status of each of the selection-target data pieces at a current point in time, the status being one of already-executed and unexecuted, the selection processing execution unit may hold the array table, the arithmetic expression may calculate a Pi×i-th selection parameter with respect to each of the first to n-th selection parameters, add each of results of the calculations, subject a result of the addition to a modulo operation in which a modulo value N is the predetermined number, and thereby calculate a provisional selection identifier showing a one of the selection-target data pieces that includes a one of the blocks to be executed next, where i is an integer no less than 1 and no greater than n, and the selection processing execution unit, in accordance with an array order of one or more selection identifiers showing one or more selection-target data pieces that are shown as being unexecuted in a table that is identical to the array table, may acquire a selection identifier whose place in the order is shown by a value of the selection parameter acquired according to the arithmetic expression.

According to the stated structure, the secret processing apparatus can reliably acquire a selection-target data piece that includes an unexecuted block. Furthermore, with the selection processing, the secret processing apparatus always selects a different selection-target data piece as the next selection-target data piece to be executed. Therefore, it is difficult for a malicious analyzer to specify the correct execution order.

Here, the secret processing may be processing that executes a secret holding program generated from the original program by the external apparatus, the number of selection-target data pieces may be a predetermined number that is equal to or greater than the number of blocks, each of one or more of the selection-target data pieces that do not include a block may include a dummy block, each dummy block being composed of one or more program instructions, and the secret holding program may include the blocks divided from the original program, and one or more dummy blocks.

According to the stated structure, the secret holding program executed in the secret processing apparatus includes dummy blocks. This makes analysis difficult for a malicious analyzer.

### BRIEF DESCRIPTION OF THE DRAWINGS

FIG. 1 is a block diagram showing the structure of a secret holding system 1;

FIG. 2 shows the structure of a secret holding program 100;

FIG. 3 shows the secret holding program 100 concretely;

FIG. 4 is a flowchart showing operations for processing when the secret holding program 100 is executed in general use;

FIG. 5 is a block diagram showing the structure of a program obfuscation apparatus 10;

FIG. 6 is a block diagram showing the structure of a secret holding program generation unit 203;

FIG. 7 is a flowchart showing an outline of operations by the program obfuscation apparatus 10;

FIG. 8 is a flowchart showing operations for processing for generating selection-target data, and is continued in FIG. 9;

FIG. 9 is a flowchart showing operations for processing for generating selection-target data, and is continued from FIG. 8;

FIG. 10 is a block diagram showing the structure of a secret holding system 2;

FIG. 11 shows the structure of a secret holding program 300;

FIG. 12 is a flowchart showing operations for processing when the secret holding program 300 is executed in general use;

FIG. 13 is a block diagram showing the structure of a program obfuscation apparatus 30;

FIG. 14 is a flowchart showing an outline of operations by the program obfuscation apparatus 30;

FIG. 15 is a block diagram showing the structure of a secret holding system 3;

FIG. 16 shows the structure of a secret holding program 500;

FIG. 17 shows the control flow of an obfuscation-target program;

FIG. 18 is a diagram of blocks of the secret holding program 500 written schematically;

FIG. 19 shows a secret holding program 500 concretely;

FIG. 20 shows a concrete example of blocks of the secret holding program 500 written in C language;

FIG. 21 is a block diagram showing the structure of a secret processing apparatus 60;

FIG. 22 shows an example of the data structure of a management information table T700;

FIG. 23 is a block diagram showing the structure of a control unit 700;

FIG. 24 is a flowchart showing operations of the secret processing apparatus 60;

FIG. 25 is a block diagram showing the structure of a program obfuscation apparatus 50;

FIG. 26 is a block diagram showing the structure of an arrangement order determination unit 804;

FIG. 27 is a flowchart showing an outline of operations by the program obfuscation apparatus 50;

FIG. 28 is a flowchart showing operations for arrangement determination processing;

FIG. 29 is a flowchart showing operations for initial value calculation processing;

FIG. 30 shows the execution order of function provision instruction groups 1 to 3;

FIG. 31 is a block diagram showing the structure of a selection processing unit 722b;

FIG. 32 shows the flow of operations for selection identifier acquisition processing;

FIG. 33 shows the control flow of an obfuscation-target program;

FIG. 34 is a block diagram showing the structure of a program obfuscation apparatus 50c;

FIG. 35 shows the control flow shown in FIG. 33 when three generated function provision instruction groups have been replaced therein;

FIG. 36 shows the control flow of a program when function provision instruction groups are expanded;

FIG. 37 is a block diagram showing the structure of an arrangement order determination unit 804c;

FIG. 38 shows the structure of a secret holding program 1800;

FIG. 39 shows the flow of operations by an arrangement order determination unit 804d;

FIG. 40 shows a specific example of blocks of a secret holding program 500e written in C language;

FIG. 41 shows the structure of a secret holding program 2000;

FIG. 42 is a flowchart showing a specific example of operations by the secret holding program 2000;

FIG. 43 is a block diagram showing the structure of a program obfuscation apparatus 1010;

FIG. 44 is a flowchart showing operations for arrangement determination processing;

FIG. 45 shows the structure of a secret holding program 2200;

FIG. 46 is a flowchart showing a specific example of operations by the secret holding program 2200;

FIG. 47 is block diagram showing the structure of a program obfuscation apparatus 3010; and

FIG. 48 is a flowchart showing operations for arrangement determination processing.

### DESCRIPTION OF NUMERICAL REFERENCES

1 Secret holding systems
10 Program obfuscation apparatus
20 Program execution apparatus
100 Secret holding program
200 Input unit
201 Function provision instruction group generation unit
202 Dummy function provision instruction group generation unit
203 Secret holding program generation unit
2 Secret holding system
30 Program obfuscation apparatus
40 Program execution apparatus
300 Secret holding program
400 Input unit
401 Function provision instruction group generation unit
402 Transition processing instruction group generation unit
403 Secret holding program generation unit
3 Secret holding system
50 Program obfuscation apparatus
60 Secret processing apparatus
500 Secret holding program
700 Control unit
701 Storage unit
702 First program storage unit
703 Second program storage unit
704 Management information holding unit
705 Selection parameter group holding unit
800 Program storage unit
801 Input unit
802 Function provision instruction generation unit
803 Dummy function provision instruction group generation unit
804 Arrangement order determination unit
805 Management instruction group generation unit
806 Secret holding program generation unit
807 Output unit
1010 Program obfuscation apparatus
1020 Secret processing apparatus
2000 Secret holding program
2200 Secret holding program
3010 Program obfuscation apparatus
3020 Secret processing apparatus

### BEST MODE FOR CARRYING OUT THE INVENTION

### 1. First Embodiment

Referring to the drawings, the following describes a secret holding program 100 and a program obfuscation apparatus 10 as a first embodiment of the present invention.

1.1 Outline of Secret Holding System 1

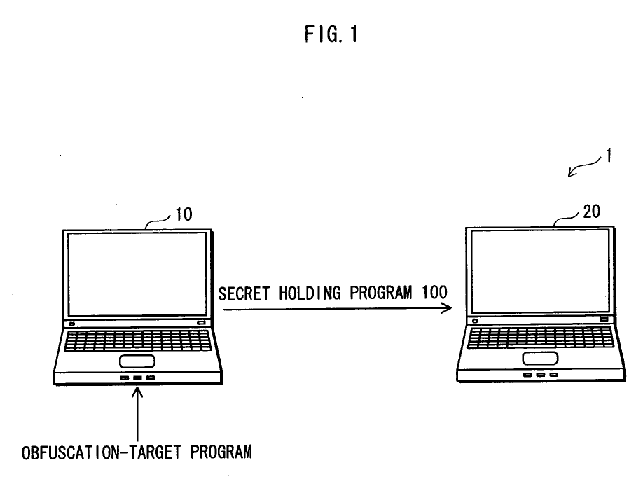

As shown in FIG. 1, a secret holding system 1 is composed of the program obfuscation apparatus 10 and a program execution apparatus 20.

The program obfuscation apparatus 10 generates a secret holding program 100 from an obfuscation-target program whose execution order is to be kept secret, and distributes the generated secret holding program 100 to the program execution apparatus 20.

The program execution apparatus 20 executes the secret holding program 100 distributed by the program obfuscation apparatus 10.

Here, the obfuscation target program is composed of three instructions groups, namely an instruction group A, an instruction group B and an instruction group C. The obfuscation target program operates correctly if the instruction groups A, B and C are executed in the stated order.

1.2 Structure of the Secret Holding Program 100

Here, a description is given of the structure of the secret holding program 100 generated by the program obfuscation apparatus 10 and executed in the program execution apparatus 20.

The secret holding program 100 is a program that uses secret elements in processing, and a malicious analyzer should not be able to discover the order in which the program instruction groups in the program are executed. In the secret holding program 100, a program instruction that handles secret information is replaced with a program instruction group, and the program instructions in the group are arranged apart from each other in the program by using, for instance, a watermark detection program or the method described in Non-Patent Document 1. With the latter, if the program instruction group is collected by a malicious analyzer and executed in the correct order, the malicious analyzer will be able to calculate the secret information. As such, it is desirable that the execution path is made difficult to ascertain.

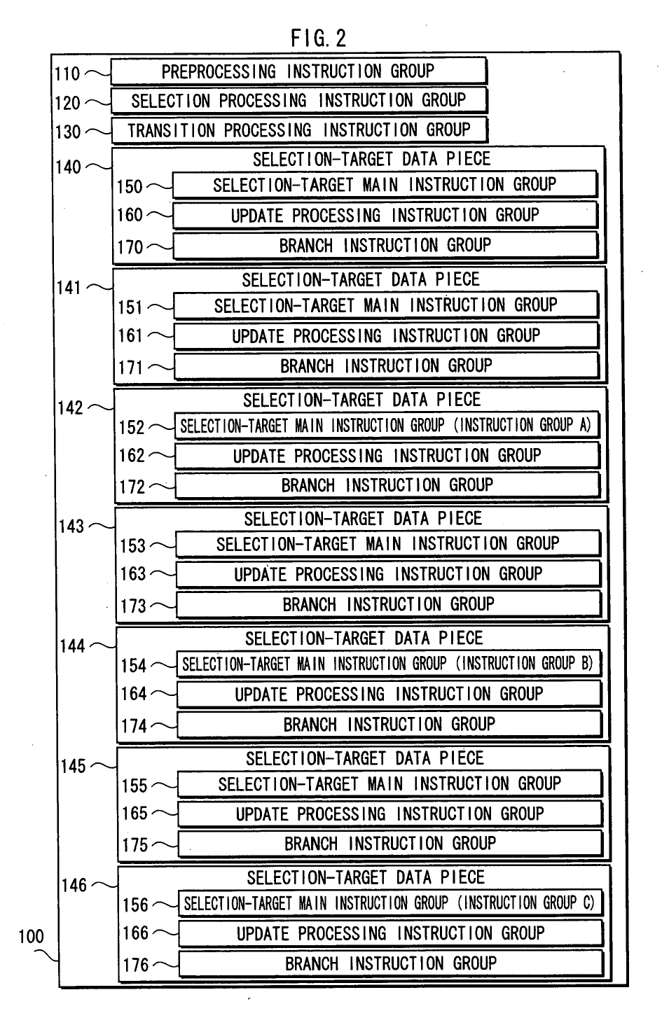

The secret holding program 100 is a program for which it is largely difficult to analyze the order in which a plurality of selection-target data pieces 140 to 146 are executed. Note that the selection-target data pieces 140 to 146 include selection-target data that is not executed when the secret holding program 100 is executed in general use. This selection-target data that is not executed is incorporated in order to increase the number of possible execution orders that could be conceived by a malicious analyzer who does not know the correct execution order. Here, executing in general use refers to processing without performing any special operations to forcedly change a program counter or selection parameters using a debugger or the like. As shown in FIG. 2, the secret holding program 100 is composed of a preprocessing instruction group 110, a selection processing instruction group 120, a transition processing instruction group 130, and selection target data pieces 140, 141, . . . , 146, arranged in the order shown in FIG. 2.

The secret holding program 100 receives, from an invoker program, 32-bit input values in1, in2 and in3, and parameters used when performing processing of the function provided by the program.

The secret holding program 100 performs processing using 32-bit first, second and third selection parameter-use variables and a 32-bit selection identifier-use variable. The first, second and third selection parameter-use variables hold values of a plurality of selection parameters (three here) used in processing of the selection processing instruction group 120. The selection identifier-use variable holds a selection identifier. The selection parameters are parameters used to determine a selection target from among the selection-target data pieces 140, 141, . . . , 146. The selection identifier is an identifier that uniquely identifies a selection-target data piece.

In the present example it is assumed that the input values in1, in2 and in3 received from an invoker program have values “1”, “2” and “3”, respectively. The secret holding program 100 provided by the present embodiment executes selection-target data (including a selection-target main instruction group) can be executed in the correct order if the values received from the invoker program are used. Given that a malicious analyzer does not know the values received from the invoker program, it is difficult for the analyzer to find out the execution order of the selection-target data pieces.

1.2.1 Preprocessing Instruction Group 110

The preprocessing instruction group 110 is a program instruction group for calculating the initial values of the selection parameter group used in the selection processing instruction group 120. In the present embodiment, the selection parameter group consists of the first, second and third selection parameter-use variables.

The preprocessing instruction group 110 is the program instruction group that is executed first when the secret holding program 100 is run.

The preprocessing instruction group 110 consists of a first preprocessing program instruction group and a second preprocessing program instruction group executed in the stated order. The first preprocessing program instruction group receives the 32-bit input values in1, in2 and in3 from the invoker program, and stores the received values in the selection parameter-use variables as initial values of the selection parameter group. The second preprocessing program instruction group branches to the selection processing instruction group 120.

More specifically, the first preprocessing program group stores the values in1, in2 and in3 in the first, second and third selection parameter-use variables, respectively. When executed in general use, the first preprocessing program instruction group performs processing to receive the values “1”, “2” and “3” as input values in1, in2 and in3, respectively, and to store the values “1”, “2” and “3” in the first, second and third selection parameter-use variables, respectively.

The second preprocessing program instruction group is a program instruction that, for instance, when a label “label_120:” is inserted at the head of the selection processing instruction group 120 in a program written in C language, is expressed by the program instruction “go to label_120;”.

Note that it is unnecessary to provide the program instruction “goto label_120;” when the selection processing instruction group 120 is arranged directly after the preprocessing instruction group 110. In this case the preprocessing instruction group 110 will consist solely of the first preprocessing program instruction group.

1.2.2 Selection Processing Instruction Group 120

The selection processing instruction group 120 is a program instruction group for selecting one of the selection-target data pieces 140 to 146 based on the selection parameter group, and setting the selected selection-target data piece as the selection identifier.

The selection processing instruction group 120 consists of a first selection processing program instruction group and a second selection processing program instruction group executed in the stated order. The first selection processing program instruction group is for calculating the selection identifier using the selection parameter group. The second selection processing program instruction group is for branching to the transition processing instruction group 130. Note that the selection identifier is a value used by a transition processing instruction group described later.

The following is a more detailed description of the first selection processing program instruction group. The first selection processing program instruction group is a collection of program instructions for calculating

p1×(first selection parameter-use variable)+p2(second selection parameter-use variable)+p3(third selection parameter-use variable) mod NN,

and storing the calculated value in the selection identifier-use variable. NN is the number of pieces of selection-target data, and p1, p2 and p3 are prime numbers that are coprime with NN and have respectively different values when NN is a divisor. Note that NN may be a prime, and p1, p2 and p3 may be respectively different primes less than NN. Note that the operator “×” expresses multiplication. In the present embodiment, p1, p2, p3 and NN have respective values of “2”, “3”, “5” and “7”, and the first selection processing program instruction group is a program instruction group for calculating

2×(first selection parameter-use variable)+3×(second selection parameter-use variable)+5×(third selection parameter-use variable) MOD 7. Expression 1

Note that the program instruction group that branches to the transition processing instruction group 130 is the same as the second preprocessing program instruction group described as part of the preprocessing instruction group 110, with the exception that the branch destination is the transition processing instruction group 130.

1.2.3. Transition Processing Instruction Group 130

The transition processing instruction group 130 is a program instruction group for performing processing to branch to one of the selection-target data pieces 140 to 146 based on a selection identifier calculated with the selection processing instruction group 120.

In more detail, the possible values of the selection identifier-use variable are 0, 1, . . . , 6, and the branch destinations corresponding to the values of the identifier-use variable are the selection-target data pieces 140, 141, . . . , 146, respectively.

For instance, if the program in which the secret holding program 100 is written is a C language program, and labels “label_140;”, “label_141;”, . . . , “label_146;” are written at the respective heads of the selection-target data pieces 140, 141, . . . , 146, the transition processing instruction group 130 will be a program instruction as follows:

switch (selection identifier-use variable) {
case 0: goto label_140;
case 1: goto label_141;
...
case 6: goto label_146;
}.

1.2.4 Section-Target Data Pieces 140 to 146

The selection-target data pieces 140 to 146 are program instruction groups executed when branching from the transition processing instruction group 130.

The selection target data-pieces 140 to 146 consist, respectively, of selection-target main instruction groups 150 to 156, updating processing instruction groups 160 to 166, and branch instruction groups 170 to 176, arranged in the order shown in FIG. 2. Each instruction group consists of one or more program instructions.

A description of the structural content of the selection-target data piece 140 is given here. Note that the selection-target data pieces 141 to 146 have the same structural content as the selection-target data piece 140, and therefore a description thereof is omitted.

(1) Selection-Target Main Instruction Group 150

The selection-target instruction main group 150 is either a program instruction group that performs part of processing for a function provided by the program (such as a watermark detection function), or an instruction group that is unrelated to a function provided and is not executed in general use (hereinafter, executing in general use is referred to as “general use execution”).

In the present embodiment, the processing of the function provided by the secret holding program is performed by executing the selection-target main instruction groups 152, 154 and 156 in the stated order in general use execution. In other words, the selection-target main instruction groups 152, 154 and 156 are program instruction groups that include part of the processing of the function provided by the obfuscation-target program, and are the same as the instruction groups A, B and C, respectively.

Furthermore, the selection-target main instruction groups 150, 151, 153 and 155 are program instruction groups in which processing unrelated to a function provided is included. Hereinafter, the instruction groups that are part of the function that the secret storing program provides, namely the selection-target main processing instruction groups 152, 154 and 156, are referred to as function provision instruction groups 1 to 3, respectively. Furthermore, the instruction groups included in the selection-target main instruction groups 150, 151, 153 and 155 that are not executed in general use execution are referred to as dummy function provision instruction groups.

In the present embodiment, when executing in general use without performing any special operations to forcedly change a program counter or selection parameters using a debugger or the like (hereinafter, referred to as general use execution), initial values “1”, “2” and “3” are stored in the selection parameter-use variables 1 to 3, respectively, in the preprocessing instruction group 100, and the selection-target main instruction groups 152, 154 and 156 are executed in order to override processing which is described below. Put more accurately, processing of an update processing instruction group the like is performed part way through.

(2) Update Processing Instruction Group 160

The update processing instruction group 160 is a program instruction group for updating the values of the selection parameter group.

The update processing instruction group 160 has a pre-assigned constant value used for updating the values of the selection parameter group. When a legitimate selection parameter group is received, the update processing instruction group 160 generates a new selection parameter group that enables the selection processing instruction group 120 to select a legitimate selection target as the next processing, with use of the received selection parameter group and the constant value.

The following describes one example of the method used to generate the new selection parameter group.

The update processing instruction group 160 stores the value of the second selection parameter-use variable in the third selection parameter-use variable, stores the value of the first selection parameter-use variable in the second selection parameter-use variable, and assigns the constant value to the first selection parameter-use variable 1, to generate a new selection parameter.

The constant value is a value that allows a selection-target data piece that is not the one selected up to that point to be expressed by the selection identifier obtained by assigning values “(constant value)”, “x” and “y” of the first to third selection parameter-use variables to expression 1 of the selection processing instruction group 120. This is because if the constant is a value according to which the selected selection-target data piece is the one that was selected up to that point, the result will be that the same selection-target data piece continuously performs an infinite loop.

The following describes a specific example of the constant value of each of the update processing instruction groups 160 to 166.

As described above, the secret holding program 100 performs processing of the provided function by the selection-target main instruction groups 152, 154 and 156 being executed in order.

After the selection-target main instruction group 152 has been executed, the update processing instruction group 162 stores the value “2” of the second selection parameter-use variable in the third selection parameter-use variable, and stores the value “1” of the first selection parameter-use variable in the second selection parameter-use variable. By the constant value A of the update processing instruction group 162 being set to “6”, the selection processing instruction group 120 is able to select the selection-target data piece 144 as the next legitimate processing.

Next, the after the selection-target main instruction group 154 is executed, the update processing instruction group 164 stores the value “1” of the second selection parameter-use variable in the third selection parameter-use variable, and then stores the value “6” of the first selection parameter-use variable in the second selection parameter-use variable. The constant value B of the update processing instruction group 164 is set to “2” here, thereby enabling the selection processing instruction group 120 to select the selection-target data piece 146 as the next legitimate processing.

Next, the after the selection-target main instruction group 156 is executed, the update processing instruction group 166 stores the value “6” of the second selection parameter-use variable in the third selection parameter-use variable, and then stores the value “2” of the first selection parameter-use variable in the second selection parameter-use variable. The constant value B of the update processing instruction group 164 being set to “0” here, thereby enabling the selection processing instruction group 120 to select, as the next legitimate processing, a selection-target data piece other than the selection-target data pieces 142, 144 and 146 that have already been executed.

A value from 0 to 6 that has not yet been used is selected for the updating processing instruction groups 160, 161, 163 and 165 in the selection target data pieces 140, 141, 143 and 145 that are not executed in operations in general use, in a manner that no value is used twice. Here, respective values set for the update processing instruction groups 160, 161, 163 and 165 are “1”, “3”, “4” and “5”.

(3) Branch Instruction Group 170

The branch instruction group 170 is a program instruction group such as a program instruction group for branching to the selection processing instruction group 120, or a program instruction group of processing for returning control to a program invoker.

1.2.5. Specific Example of the Secret Holding Program 100

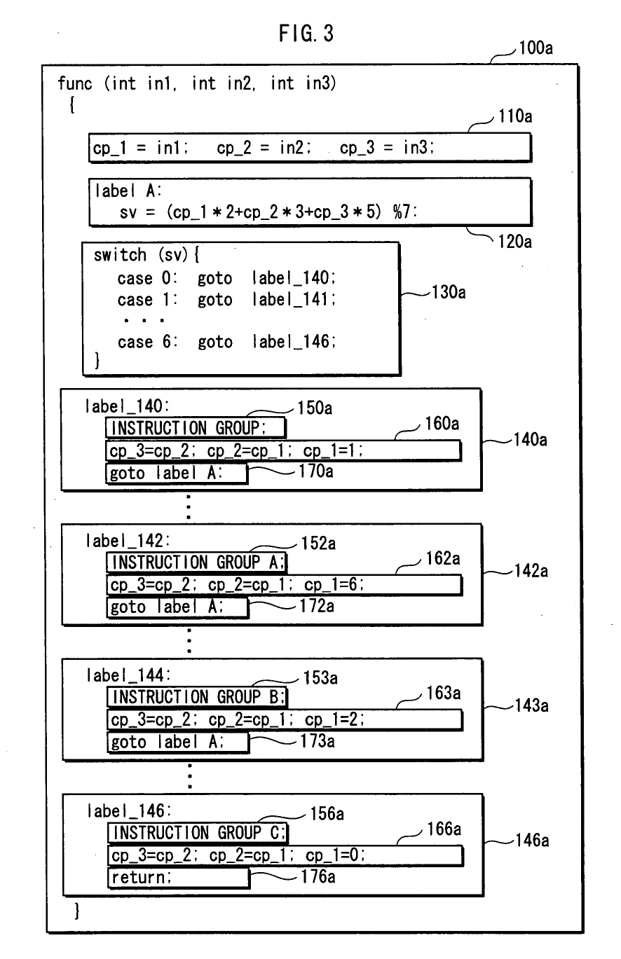

A secret holding program 100a written in C language is shown in FIG. 3 as a specific example of the secret holding program 100. Note that the operator “×” expresses multiplication.

A program instruction group 110a corresponds to the preprocessing instruction group 110, the program instruction group 120a corresponds to the selection processing instruction group 120, and a program instruction group 130a corresponds to the transition processing instruction group 130. Furthermore, program instruction groups 140a, 142a, 143a and 146a correspond to the selection target data pieces 140, 142, 143 and 146, respectively.

Program instruction groups 150a, 152a, 153a and 156a correspond to the selection-target main instruction groups 150, 152, 153 and 156, respectively. Program instruction groups 160a, 162a, 163a and 166a correspond to the update processing instruction groups 160, 162, 163 and 166, respectively. Furthermore, program instruction groups 170a, 172a, 173a and 176a correspond to the branch instruction groups 170, 172, 173 and 176. Note that specific examples corresponding to the selection-target data pieces 141, 144 and 145 are omitted from the drawing for convenience.

1.3 Execution of the Secret Holding Program 100

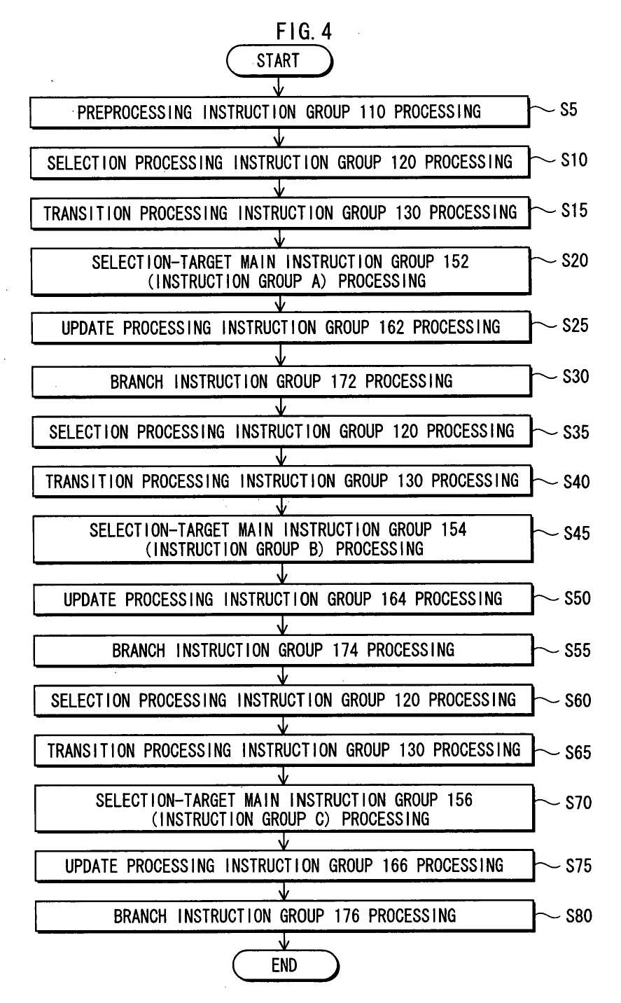

The flowchart shown in FIG. 4 is used to describe processing when the secret holding program 100 is executed in general use.

The secret holding program 100 performs processing of the preprocessing instruction group 110 (step S5). Specifically, the preprocessing instruction group 110 receives values “1”, “2” and “3” as input values in1, in2 and in3, respectively, performs processing for storing each of the values “1”, “2” and “3” in the respective one of the first to third selection parameter-use variables, and branches to the selection processing instruction group 120.

Next, the secret holding program 100 performs processing of the selection processing instruction group 120 using the received input values “1”, “2” and “3” (step S10). Specifically, the selection processing instruction group 120 calculates a value “2” according to Expression 1 “2×(first selection parameter-use variable (=1))+3×(second selection parameter-use variable (=2))+5×(third selection parameter-use variable (=3)) MOD 7”, stores the calculated value “2” in the selection identifier-use variable, and branches to the transition processing instruction group 130.

The secret holding program 100 performs the processing of the transition processing instruction group 130 using the selection identifier-use variable (=2) (step S15). Specifically, based on the selection identifier “2” calculated by the selection processing instruction group 120, the transition processing instruction group 130 branches to the selection-target data piece 142.

In accordance with the branch instruction in the transition processing instruction group 130, the secret holding program 100 performs processing of the selection target main instruction group 152 of the selection-target data piece 142 (step S20). Specifically, the selection-target main instruction group 152 executes the instruction group A in the obfuscating-target program.

Next, the secret holding program 100 performs processing of the update processing instruction group 162 (step S25). Specifically, the update processing instruction group 162 is a program instruction group that performs processing for storing the value of the second selection parameter-use variable in the third selection parameter-use variable, storing the value of the first selection parameter-use variable in the second selection parameter-use variable, and assigning the constant value A (=“6”) to the first selection parameter-use variable. Here, since the respective initial values of the first to third selection parameter-use variables are “1”, “2” and “3”, the update processing instruction group 162 assigns respective values “constant value A (=6)”, “1” and “2” to the first to third selection parameter-use variables.

Next, the secret holding program 100 performs processing of the branch instruction group 172 (step S30). Specifically, the branch instruction group 172 branches to the selection processing instruction group 120.

Next, the secret holding program 100 performs processing of the selection processing instruction group 120 using the updated selection parameter group (values “6”, “1” and “2”, step S35). Specifically, the selection processing instruction group 120 calculates a value “4” according to Expression 1 “2×(first selection parameter-use variable (=6))+3×(second selection parameter-use variable (=1))+5×(third selection parameter-use variable (=2)) MOD 7”, stores the calculated value “4” in the selection identifier-use variable, and branches to the transition processing instruction group 130.

The secret holding program 100 performs the processing of the transition processing instruction group 130 using the selection identifier-use variable (=4, step S40). Specifically, based on the selection identifier “4” calculated by the selection processing instruction group 120, the transition processing instruction group 130 branches to the selection-target data piece 144.

In accordance with the branch instruction in the transition processing instruction group 130, the secret holding program 100 performs processing of the selection target main instruction group 154 of the selection-target data piece 144 (step S45). Specifically, the selection-target main instruction group 154 executes the instruction group B in the obfuscating-target program.

Next, the secret holding program 100 performs processing of the update processing instruction group 164 (step S50). Specifically, the update processing instruction group 164 is a program instruction group that performs processing for storing the value of the second selection parameter-use variable in the third selection parameter-use variable, storing the value of the first selection parameter-use variable in the second selection parameter-use variable, and assigning the constant value B (=“2”) to the first selection parameter-use variable. Here, since the respective initial values of the first to third selection parameter-use variables are “6”, “1” and “2”, the update processing instruction group 162 assigns respective values “constant value B (=2)”, “6” and “1” to the first to third selection parameter-use variables.

Next, the secret holding program 100 performs processing of the branch instruction group 174 (step S55). Specifically, the branch instruction group 174 branches to the selection processing instruction group 120.

Next, the secret holding program 100 performs processing of the selection processing instruction group 120 using the updated selection parameter group (values “2”, “6” and “1”, step S60). Specifically, the selection processing instruction group 120 calculates a value “6” according to Expression 1 “2×(first selection parameter-use variable (=2))+3×(second selection parameter-use variable (=6))+5×(third selection parameter-use variable (=1)) MOD 7”, stores the calculated value “6” in the selection identifier-use variable, and branches to the transition processing instruction group 130.

The secret holding program 100 performs the processing of the transition processing instruction group 130 using the selection identifier-use variable (=6, step S65). Specifically, based on the selection identifier “6” calculated by the selection processing instruction group 120, the transition processing instruction group 130 branches to the selection-target data piece 146.

In accordance with the branch instruction in the transition processing instruction group 130, the secret holding program 100 performs processing of the selection target main instruction group 156 of the selection-target data piece 146 (step S70). Specifically, the selection-target main instruction group 156 executes the instruction group C in the obfuscating-target program.

Next, the secret holding program 100 performs processing of the update processing instruction group 166 (step S75). Specifically, the update processing instruction group 166 is a program instruction group that performs processing for storing the value of the second selection parameter-use variable in the third selection parameter-use variable, storing the value of the first selection parameter-use variable in the second selection parameter-use variable, and assigning the constant value C (=“0”) to the first selection parameter-use variable. Here, since the respective initial values of the first to third selection parameter-use variables are “2”, “6” and “1”, the update processing instruction group 164 assigns respective values “constant value C (=0)”, “2” and “6” to the first to third selection parameter-use variable.

Next, the secret holding program 100 performs processing of the branch instruction group 176 (step S80). Specifically, the branch instruction group 176 performs processing for returning control to the invoker program. Note that it is unnecessary to branch to the selection processing instruction group 120 because the selection-target data piece 146 is the selection-target data piece that is executed last. The processing for returning control to the invoker program may correspond, for example, to a return statement in a C language program.

Note that although the secret holding program 100 is described as the entity that performs the operations, in reality the operations are realized by the program-execution apparatus 20 executing the secret holding program 100. In other words, the program execution apparatus 20 may be substituted for the secret holding program 100 as the entity that performs the operations.

1.4 Program Obfuscation Apparatus 10

A description is now given of the program obfuscation apparatus 10 that generates the secret holding program 100 from an obfuscation-target program whose order of execution is to be concealed. The parts other than the function provision instruction groups and the dummy function provision instruction groups in the secret holding program 100 can also be used for any kind of obfuscation-target program. The following description focuses on generating the function provision instruction groups and generating the dummy function provision instruction groups.

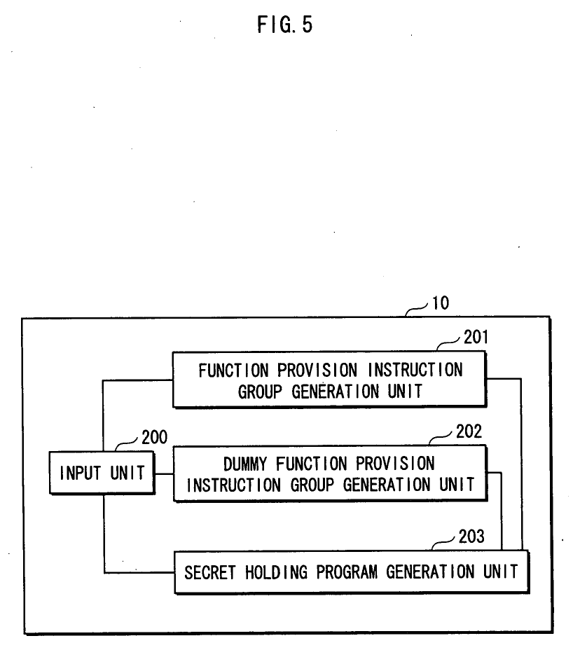

As shown in FIG. 5, the program obfuscation apparatus 10 is composed of an input unit 200, a function provision instruction group generation unit 201, a dummy function provision instruction group generation unit 202, and a secret holding program generation unit 203.

The program obfuscation apparatus 10 is, specifically, a computer system composed of a microprocessor, a RAM, a ROM, a hard disk unit, a display unit, a keyboard, a mouse, and the like. A computer program is stored in the RAM or the hard disk unit. Here, the computer program is a combination of instruction codes showing instructions for a computer for achieving predetermined functions. The program obfuscation apparatus 10 achieves its functions by the microprocessor operating in accordance with the computer program. In other words, the microprocessor reads the instruction in the computer program one instruction at a time, decodes the read instruction, and operates in accordance with the result of decoding.

1.4.1 Input Unit 200

The input unit 200 receives the obfuscation-target program and the three initial values (here, “1”, “2” and “3”) given to the secret holding program 100 when the secret holding program 100 is executed in general use.

1.4.2 Function Provision Instruction Group Generation Unit 201

The function provision group generation unit 201 divides the obfuscation-target program received by the input-unit 200 into a plurality of blocks, each consisting of at least one program instruction. Note that when an unconditional skip or a conditional skip is included in the obfuscation-target program, the function provision group generation unit 201 divides the obfuscation-target program such that the program instruction that performs the skip and the program instruction that is the skip-destination are included in the same block. Note that terminology relating to a complier is described in Non-Patent Documents 2 and 3.

In the present embodiment, three function provision instruction groups are generated by dividing the obfuscation-target program into three blocks in a manner that the number of instructions is as even as possible between blocks. The three generated function provision instruction groups are function provision instruction groups 1 to 3 in the order in which the original program instruction groups are included at the start of the obfuscation-target program.

1.4.3 Dummy Function Provision Instruction Group Generation Unit 202

The dummy function provision instruction group generation unit 202 generates a plurality of dummy function provision instruction groups, each of which consists of a random combination of one or more program instructions written in the programming language in which the obfuscation-target program is written.

Note that dummy function provision instruction groups may be generated at random or manually using only program instructions in the obfuscation-target program. This makes it more difficult to differentiate between dummy function provision instruction groups and instructions originally included in the obfuscation-target program, and hence more difficult to perform malicious analysis. Furthermore, in a programming language that performs compiling processing, such as C language or Java™ language, the dummy function provision instruction group generation unit 202 generates dummy function provision instruction groups using variables used in the obfuscation-target program so that the program compiles. Furthermore, if variables that are not used in the obfuscation-target program are incorporated in the dummy function provision instruction groups, the dummy function provision instruction group generation unit 202 adds such variable declarations to the obfuscated program. Note that since terminology and how variable declarations are made relating to C language are specifications of a commonly known programming language (C language), and therefore a description thereof is omitted here. Furthermore, since terminology and how variable declarations are made relating to Java™ are specifications of a commonly known programming language (Java™), and therefore a description thereof is omitted here. In the present example, the dummy function provision instruction group generation unit 202 generates four dummy function provision instruction groups.

1.4.4 Secret Holding Program Generation Unit 203

The secret holding program generation unit 203 generates the secret holding program 100 by generating the preprocessing instruction group 110, the selection processing instruction group 120, the transition processing instruction group 130, and the selection-target data pieces 140, 141, . . . , 146, using a plurality of function provision instruction groups and dummy function provision instruction groups.

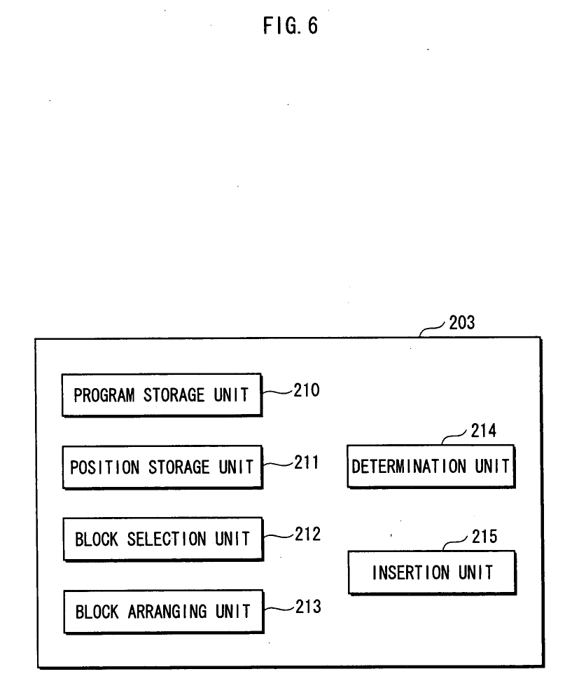

As shown in FIG. 6, the secret holding program generation unit 203 has a program storage unit 210, a position storage unit 211, a block selection unit 212, a block arranging unit 213, a determination unit 214, and an insertion unit 215.

The program storage unit 210 has areas for storing generated instruction groups and selection-target data pieces.

The position storage unit 211 has areas for storing information showing the position in which each selection-target main instruction group is arranged. For instance, the value “2” stored in the position storage unit 211 means that one function provision instruction group or one dummy function provision instruction group has already been inserted into the selection-target data piece 142.

The block selection unit 212 selects, from the obfuscation-target program, the next block (function provision instruction group) to be arranged.

The block arranging unit 213 calculates, using Expression 1, a position in which to arrange the selected block, and arranges the selected block in the calculated arrangement position in an intermediate program.

The determination unit 214 determines an assignment value to assign to the variable, such that a different arrangement position to that stored in the position storage unit 211 is calculated.

The insertion unit 215 generates a program instruction group for assigning the determined assignment value to the variable (update processing instruction group), and insets the generated program instruction group directly after the arranged block.

(1) Generating of the Preprocessing Instruction Group 110

The secret holding program generation unit 203 generates the preprocessing instruction group 110 consisting of a first preprocessing program instruction group that receives 32-bit input values in1, in2 and in3 from the invoker program and stores the received values in a selection parameter-use variable as initial values of the parameter group, and a second preprocessing program instruction group that branches to the selection processing instruction group 120, the first preprocessing instruction group and the second preprocessing instruction group being executed in the stated order. The secret holding program generation unit 203 stores the generated preprocessing instruction group 110 in the program storage unit 210.

(2) Generating of the Selection Processing Instruction Group 120

The secret holding program generation unit 203 generates the selection processing instruction group 120 consisting of a first selection processing program instruction group that calculates a selection identifier using the selection parameter group, and a second selection processing program instruction group that branches to the transition processing instruction group 130, the first selection processing program and the second selection processing program being executed in the stated order.

Here, the secret holding program generation unit 203 generates, as the first selection processing program instruction group, a program instruction group that calculates Expression 1 “2×(first selection parameter-use variable)+3×(second selection parameter-use variable)+5×(third selection parameter-use variable) MOD 7”. The secret holding program generation unit 203 stores the generated selection processing instruction group 120 in the program storage unit 210.

(3) Generating of Transition Processing Instruction Group 130

The secret holding program generation unit 203 generates the transition processing instruction group 130 that performs processing to branch to any of the selection-target data pieces 140 to 146 based on the selection identifier calculated by the selection processing instruction group 120.

Specifically, the secret holding program generation unit 203 acquires the number of function provision instruction groups generated by the function provision instruction group generation unit 201 (3 in the present example) and the number of dummy function provision instruction groups generated by the dummy function provision instruction group generation unit 202 (4 in the present example), and calculates a total value of the acquired numbers. The secret holding program generation unit 203 generates an equal number of label names to the calculated total value (7 in the present example). The secret holding program generation unit 203 generates the transition processing instruction group 130 by putting each of the possible values obtained from Expression 1 in the selection processing instruction group 120 in association with a different one of the generated label names as a branch destination. The secret holding program generation unit 203 stores the generated transition processing instruction group 130 in the program storage unit 210.

(4) Generating of Selection-Target Data Pieces 140, 141, . . . , 146

The secret holding program generation unit 203 generates an equal number of selection-target data pieces to the total value of the function provision instruction groups and the dummy function provision instruction groups, using the three initial values, Expression 1, and the generated function provision instruction groups and dummy function provision instruction groups.

The following describes generating of the selection-target data pieces with use of a specific example.

The secret holding program generation unit 203 generates selection-target data pieces containing only the generated label names. In the present example, the secret holding program generation unit 203 generates seven selection-target data pieces 140 to 146. The secret holding program generation unit 203 stores the generated selection-target data pieces containing only the label names in the program storage unit 210.

The secret program generation unit 203 acquires a function provision instruction group 1 from the function provision instruction group generation unit 201, and using the three initial values received from the input unit 200 and Expression 1, determines a selection-target data piece to insert into the acquired function provision instruction group 1. Here, since the value “2” is calculated from the three initial values (“1”, “2” and “3”) and Expression 1, the secret holding program generation unit 203 inserts the function provision instruction group 1 into the selection-target data piece 142 stored in the program storage unit 210, and stores “2” in the position storage unit 211.

The secret holding program generation unit 203 generates the update processing instruction group 162 to insert into the selection-target data piece 142. Here, the secret holding program generation unit 203 stores the value “2” of the second selection parameter-use variable in the third selection parameter-use variable, and stores the value “1” of the first selection parameter-use variable in the second selection parameter-use variable. The secret holding program generation unit 203 acquires the value “6” as the constant value A, by referring to the one or more values stored in the position storage unit 211, such that a value obtained by assigning the values “(constant value A)”, “1” and “2” of the first to third selection parameter-use variables to Expression 1 is not a value that shows one or more already-selected selection-target data pieces. Note that the method used to acquire the value is described below. The secret holding program generation unit 203 generates an update processing instruction group 162 that includes the acquired constant value A (=“6”) and updates the values of the selection parameter group. The secret holding program generation unit 203 inserts the generated update processing instruction group into the selection-target data piece 142 stored in the program storage unit 210.

The secret holding program generation unit 203 generates the branch instruction group 172 to be inserted into the selection-target data piece 142, and inserts the generated branch instruction group 172 into the selection-target data piece 142. In the present example, the secret holding program generation unit 203 generates the branch instruction group 172 that branches to the selection processing instruction group 120, and inserts the generated branch instruction group 172 into the selection-target data piece 142 stored in the program storage unit 210. This is how the selection-target data piece 142 that is part of the secret holding program is generated.

The secret holding program generation unit 203 acquires a function provision instruction group 2 from the function provision instruction group generation unit 201, and using the selection parameter group (“constant value A (=6)”, “1”, “2”), determines a selection-target data piece into which the acquired function provision instruction group 2 is to be inserted. In the present example, since the value “4” is calculated from the three initial values (“6”, “1” and “2”) and Expression 1, the secret holding program generation unit 203 inserts the function provision instruction group 2 into the selection-target data piece 144 stored in the program storage unit 210. The secret holding program generation unit 203 stores “4” in the position storage unit 211. This results in the values “2” and “4” being stored in the position storage unit 211.

The secret holding program generation unit 203 generates the update processing instruction group 164 to insert into the selection-target data piece 144. In the present example, the secret holding program generation unit 203 stores the value “1” of the second selection parameter-use variable in the third selection parameter-use variable, and stores the value “6” of the first selection parameter-use variable in the second selection parameter-use variable. The secret holding program generation unit 203 acquires the value “2” as the constant value B by referring to the one or more values stored in the position storage unit 211, such that a value obtained by assigning the values “(constant value B)”, “6” and “1” of the first to third selection parameter-use variables to Expression 1 is not a value that shows one or more already-selected selection-target data pieces. The secret holding program generation unit 203 generates an update processing instruction group 162 that includes the acquired constant value B (=“2”) and updates the values of the selection parameter group. The secret holding-program generation unit 203 inserts the generated update processing instruction group 162 into the selection-target data piece 144 stored in the program storage unit 210.

The secret holding program generation unit 203 generates the branch instruction group 174 to be inserted into the selection-target data piece 144. In the present example, the secret holding program generation unit 203 generates the branch instruction group 174 that branches to the selection processing instruction group 120, and inserts the generated branch instruction group 174 into the selection-target data piece 144 stored in the program storage unit 210. This is how the selection-target data piece 144 that is part of the secret holding program is generated.

The secret holding program generation unit 203 acquires a function provision instruction group 3 from the function provision instruction group generation unit 201, and using the selection parameter group (“constant value B (=2)”, “6”, “1”), determines a selection-target data piece into which the acquired function provision instruction group 3 is to be inserted. In the present example, since the value “6” is calculated from the three initial values (“2”, “6” and “1”) and Expression 1, the secret holding program generation unit 203 inserts the function provision instruction group 3 into the selection-target data piece 146 stored in the program storage unit 210. The secret holding program generation unit 203 stores “6” in the position storage unit 211. This results in the values “2”, “4” and “6” being stored in the position storage unit 211. The secret holding program generation unit 203 generates the update processing instruction group 166 to insert into the selection-target data piece 146. In the present example, the secret holding program generation unit 203 stores the value “6” of the second selection parameter-use variable in the third selection parameter-use variable, and stores the value “2” of the first selection parameter-use variable in the second selection parameter-use variable. The secret holding program generation unit 203 acquires the value “0” as the constant value C, by referring to the one or more values stored in the position storage unit 211, such that a value obtained by assigning the values “(constant value C)”, “2” and “6” of the first to third selection parameter-use variables to Expression 1 is not a value that shows one or more already-selected selection-target data pieces. The secret holding program generation unit 203 generates an update processing instruction group 162 that includes the acquired constant value C (=“0”) and updates the values of the selection parameter group. The secret holding program generation unit 203 inserts the generated update processing instruction group 166 into the selection-target data piece 146 stored in the program storage unit 210.

The secret holding program generation unit 203 generates the branch instruction group 176 to be inserted into the selection-target data piece 146. In the present example, the secret holding program generation unit 203 generates the branch instruction group 176 that performs processing for returning control to the invoker program, and the secret holding program generation unit 203 inserts the generated branch instruction group 176 into the selection-target data piece 146 stored in the program storage unit 210. This is how the selection-target data piece 146 that is part of the secret holding program is generated. Note that if the last function provision instruction group 3 (the selection-target main instruction group 156) itself ends in a return statement, there is no need to add a further return statement.

Next, the secret holding program generation unit 203 acquires the selection-target data piece 140 into which a function provision instruction group or a dummy function provision instruction group has not been inserted, and inserts therein a dummy function provision instruction group that has not yet been inserted in a selection-target data piece. The secret holding program generation unit 203 generates the update processing instruction group 160 that includes a value from among the value “0” to “6” that are used as constant value (here, “1”) and that performs updating of the values of the selection parameter group, and the secret holding generation unit 203 inserts the generated update processing instruction group 160 into the selection-target data piece 140.

The secret holding program generation unit 203 generates the branch instruction group 170 to insert into the selection-target data pieces 140. Here, the secret holding program generation unit 203 generates the branch instruction group 170 that branches to the selection processing instruction group 120, and inserts the generated branch instruction group 170 into the selection-target data piece 140. This is how the selection-target data piece 140 that composes the secret holding program is generated.

The selection-target data pieces 141, 143 and 145 are generated in the same way as the selection-target data piece 140, and therefore a description thereof is omitted here.

A description is now given of the method used to acquire a constant value when inserting a function provision instruction group. Note that the number of selection target data pieces is assumed to be “m” pieces.

The secret holding program generation unit 203 selects a random integer “n” from among integers “0” to “m−1”, and calculates a value by assigning “n”, “value of first selection-use variable” and “value of second selection-use variable” in Expression 1 as the respective values of the first to third selection parameter-use variables. When the calculated value does not already exist in the position storage unit 211, the secret holding program generation unit 203 sets the selected variable as the constant value. When the calculated value already exists in the position storage unit 211, the secret holding program generation unit 203 again selects one integer “n” at random from among the integers “0” to “m−1”, and repeats the described operations until a value that does not already exist in the position storage unit 211 is calculated by Expression 1.

When insertion of all function provision instruction groups has ended, the secret storage program generation unit 203 allocates unused integers among the integers “0” to “m−1” to each of dummy function provision groups.

Note that the integer “n” is not limited to being selected from among integers from “0” to “m−1”, and may be any integer that is 0 or greater. In such a case, the method of calculating the constant value shown above is also used to determine where a dummy function provision instruction group is inserted.

(5) Generating of Secret Holding Program 100

The secret holding program generation unit 203 generates the secret holding program 100 by arranging, in the order shown in FIG. 2, the preprocessing instruction group 110, the selection processing instruction group 120, the transition processing instruction group 130 and the selection-target data pieces 140, 141, . . . , 146 stored in the program storage unit 210.

1.4.5 Operations of the Program Obfuscation Apparatus 10

(1) Outline of Operations

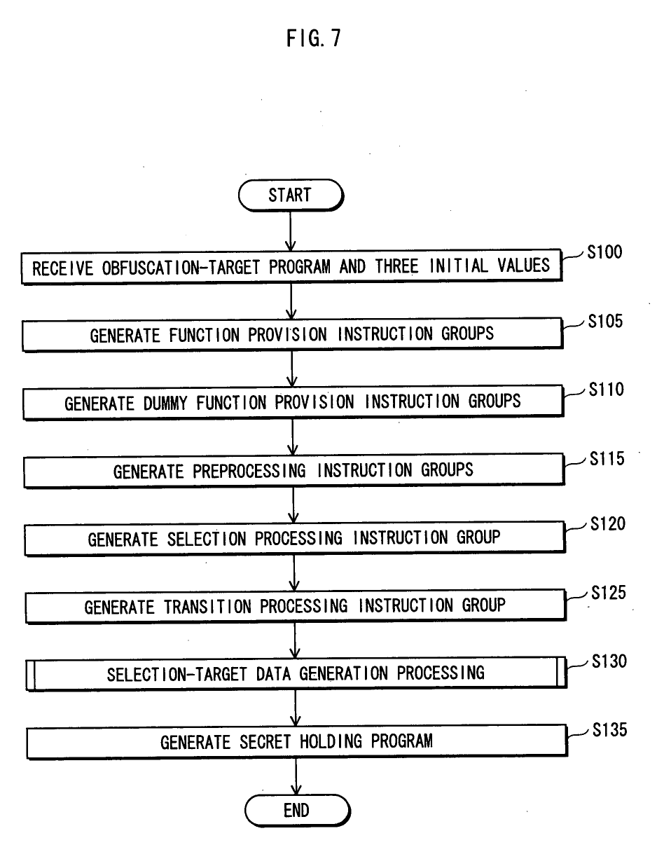

The following outlines operations of the program obfuscation apparatus 10 with use of the flowchart shown in FIG. 7.

The input unit 200 of the program obfuscation apparatus 10 receives an obfuscation-target program, and three initial values (“1”, “2” and “3” here) to be given to the secret holding program 100 when executed in general use (step S100).

The function provision instruction group generation unit 201 divides the obfuscation-target program into a plurality of blocks, each of which consists of one or more program instructions, to generate a plurality of function provision instruction groups (step S105).

The dummy function provision instruction group generation unit 202 generates a plurality of dummy function provision instruction groups, each of which is a random combination of one or more program instructions written in the programming language in which the obfuscation-target program is written (step S110).

The secret holding program generation unit 203 generates a preprocessing group consisting of a first preprocessing program instruction group that receives 32-bit input values in1, in2 and in3 from the invoker program and stores the received values in the selection parameter-use variables as initial values of the selection parameter group, and a second preprocessing instruction group for branching to a selection processing instruction group, the first preprocessing program instruction group and the second preprocessing program instruction group being performed in the stated order (step S115).

The secret holding program generation unit 203 generates a selection processing instruction group consisting of a first selection processing program instruction group for calculating a selection identifier using the selection parameter group, and a second selection processing program instruction group for branching to a transition processing instruction group, the first selection processing program instruction group and the second selection processing program instruction group being performed in the stated order (step S120). Here, the program instruction group that the secret holding program generation unit 203 generates as the first selection processing program instruction group is a program instruction group that calculates Expression 1 “2×(first selection parameter-use variable)+3×(second selection parameter-use variable)+5×(third selection parameter-use variable) MOD 7”.

The secret holding program generation unit 203 generates a transition processing instruction group for performing processing to branch to any of the plurality of selection-target data pieces based on the selection identifier calculated by the selection processing instruction group (step S125). Specifically, the secret holding program generation unit 203 acquires the number of function provision instruction groups (“m”) generated by the function provision instruction group generation unit 201 and the number of dummy function provision instruction groups (“n”) generated by the dummy function provision instruction group generation unit 202, and calculates a total value of the acquired numbers. The secret holding program generation unit 203 generates an equal number of label names as the calculated total number (7 in the present example). The secret holding program generation unit 203 generates a transition processing instruction group by putting each of the possible values obtained from Expression 1 in the selection processing instruction group 120 in association with a different one of the generated label names as a branch destination.

Using the three initial values, Expression 1, the generated plurality of function provision instruction groups and the plurality of dummy function instruction groups, the secret holding program generation unit 203 generates an equal number of selection-target data pieces as the total number of the function provision instruction groups and the function provision instruction groups (step S130).

The secret holding program generation unit 203 generates the secret holding program by arranging the generated preprocessing instruction group, selection processing instruction group, transition processing instruction group and selection-target data pieces in the stated order (step S135).

(2) Selection-Target Data Pieces Generation Processing

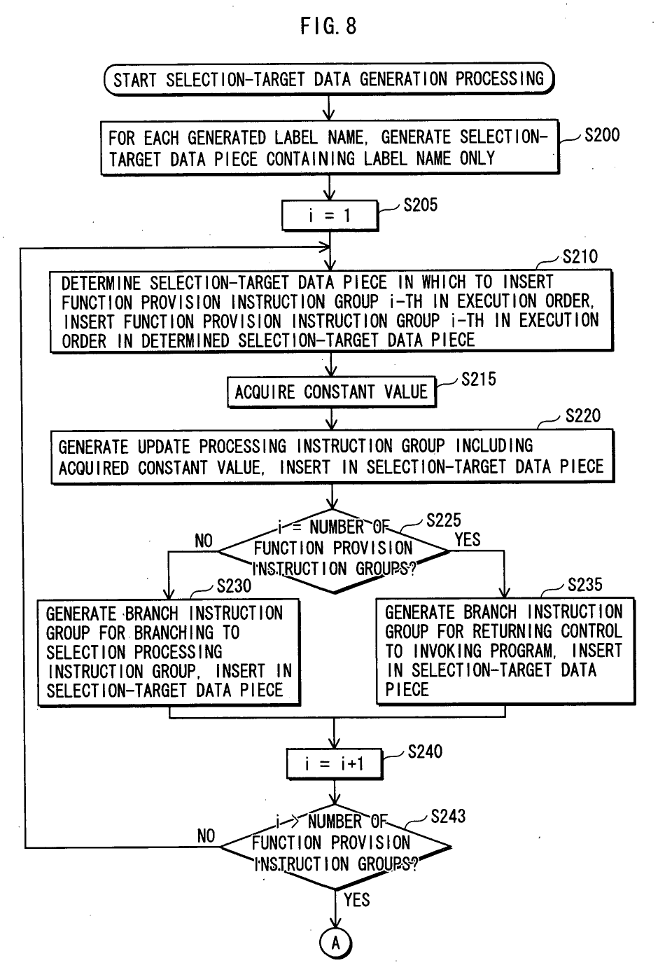

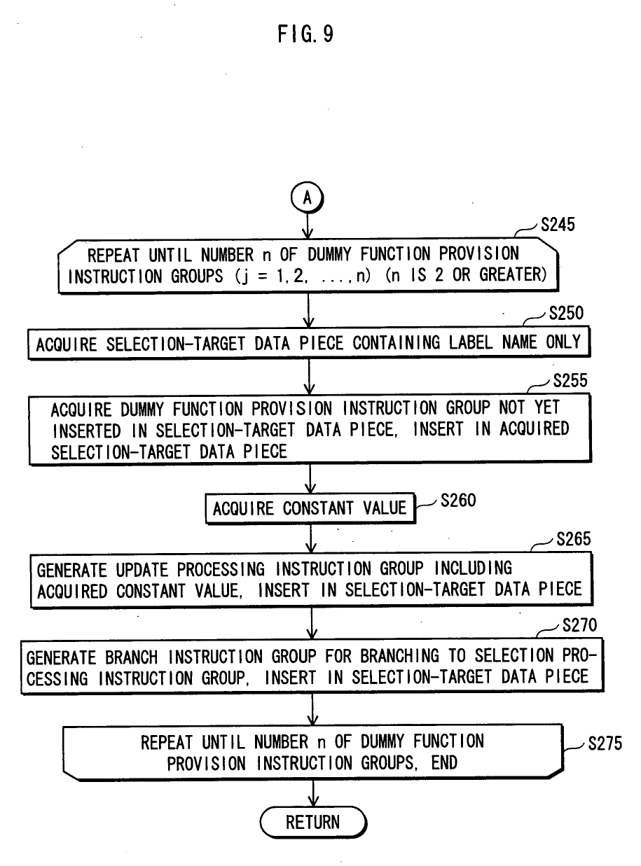

Referring to the flowcharts in FIG. 8 and FIG. 9, a description is given of operations for processing for generating selection-target data pieces shown in step S130 of FIG. 7.

The secret holding program generation unit 203 generates selection-target data pieces containing only the generated label names (step S200).

The secret holding program generation unit 203 sets the counter i to 1 (step S205). The counter i expresses which number in the Execution order the function provision instruction group is currently being focused on should be executed.

The secret holding program generation unit 203 acquires the function provision instruction group that is the i-th in the execution order, from the function provision instruction group generation unit 201. With use of the selection parameter group and Expression 1, the secret holding program, generation unit 203 determines which selection-target data piece to insert the acquired i-th function provision instruction group into. Note that when i is 1, the secret holding program generation unit 203 determines a selection-target data piece using Expression 1 and the selection parameter group consisting of the three initial values. When i is 2 or greater, the secret holding program generation unit 203 determines a selection-target data piece using an updated selection parameter group and Expression 1. The secret holding program generation unit 203 inserts the function provision instruction group that is i-th in the execution order into the determined selection-target data piece (step S210). The secret holding program generation unit 203 stores the value of the second selection parameter-use variable in the third selection parameter-use variable, and stores the value of the first selection parameter-use variable in the second selection parameter-use variable. The secret holding program generation unit 203 acquires a constant value according to which the value obtained by assigning the values “constant value”, “1” and “2” of the first to third selection parameter-use variables does not show a selection-target data piece that has already been selected (step S215).

The secret holding program generation unit 203 generates, an update processing instruction group that includes the acquired constant value and that performs updating of the values selection parameter group, and inserts the generated update processing instruction group into the selection-target data piece (step S220).

The secret holding program generation unit 203 judges whether or not the value of the counter i matches the number m of function provision instruction groups (step S225).

When the two are judged not to match (“NO” at step S225), the secret holding program generation unit 203 generates a branch instruction group for branching to the selection processing instruction group, and inserts the generated branch instruction group into the selection-target data piece (step S230).

When the two are judged to match (“YES” at step S225), the secret holding program generation unit 203 generates a branch instruction group for performing processing to return control to the invoker program, and inserts the generated branch instruction group into the selection-target data piece (step S235).

The secret holding program generation unit 203 adds a value “1” to the counter i (step S240).

The secret holding program generation unit 203 judges whether or not the counter i is greater than the number of function provision instruction groups (step S243).

When the counter i is judged not to be greater than the number of function provision instruction groups (“NO” at step S243), the secret holding program generation unit 203 returns to step S210, and repeats the processing.

When the counter i is judged to be greater than the number of function provision instruction groups (“YES” at step S243), the secret holding program generation unit 203 repeats step S245 to step S275 for each of the number n of the dummy function provision instruction groups.

The secret holding program generation unit 203 acquires a selection-target data piece that has been inserted in neither a function provision instruction group nor a dummy function provision instruction group, in other words, a selection-target data piece that consists only of a label name (step S250).

The secret holding program generation unit 203 acquires a dummy function provision instruction group that has not been inserted in a selection-target data piece, and inserts the acquired dummy function provision instruction group into the selection-target data piece acquired at step S250 (step S255).

The secret holding program generation unit 203 acquires a value that has not been used as a constant value (step S260), generates an update processing instruction group that includes the acquired constant value and performs updating of the values of the selection parameter group, and the secret holding program generation unit 203 inserts the generated updating processing instruction group into the selection-target data piece (step S265).

The secret holding program generation unit 203 generates a branch instruction group for branching to a selection processing instruction group, and inserts the generated branch instruction group into the selection-target data group (step S270).

After repeating step S250 to step S270 for each of the number n of dummy function providing instruction groups, the secret holding program generation unit 203 ends the processing (step S275).

1.5 Modifications

The present invention has been described based on, but is by no means limited to, the first embodiment. Cases such as the following are included in the present invention.

(1) The expression used to calculate the selection identifier is not limited to being Expression 1 in the first embodiment. Any other expression that uses selection-use parameter variables may be used to calculate the selection identifier.

The expression may be one that uses selection identifier-use variables whose initial values are set in advance, or one that uses a counter-use variable provided in a selection processing instruction group for counting how many times the selection processing instruction group has been invoked.

Furthermore, the counter-use variable may perform processing to increase the value of the counter other that with the selection processing instruction group.

(2) In the first embodiment, it is not necessary to incorporate the update processing instruction group 166 in the selection-target data 146 that includes the function provision instruction group 3, which is the last of the function provision instruction groups.

(3) Although the number of function provision instruction groups is three in the first embodiment, the number is not limited to being three. Any number of function provision instruction groups may be used.

(4) Although the number of selection parameters is three in the first embodiment, the number is not limited to being three. Any plural number of selection parameters may be used.

In this case Expression 1 will be “p1×(first selection parameter-use variable)+p2×(second selection parameter-use variable)+ . . . +pn×(n-th selection parameter-use variable) MOD NN”, where n is an integer no less than 2, and where p1, p2, pn are coprimes, and NN in the number of selection-target data pieces. Furthermore, when updating the selection parameters, the value stored in the (i−1)-th parameter is shifted into the i-th parameter. Here, the n-th parameter, the (n−1)-th parameter, . . . , the second parameter are shifted successively in the stated order. Furthermore, a constant value of an executed selection-target main instruction group is stored in the first parameter. Here, i is an integer that is no less than 2 and no greater than n.

Furthermore, the initial values of the input values are not limited to being “1”, “2” and “3”.

Furthermore, although values such as the input values are described as being 32-bit values, these values may be shorter than 32 bits or longer than 32 bits.

(5) In the first embodiment, instead of the selection-target data pieces 140 to 146 having branch instruction groups 170 to 175 therein, each selection-target data piece may have a selection processing instruction group and a transition processing instruction group therein.

(6) In the first embodiment, instead of the initial values of the selection information parameters being given to the secret holding program, the initial values may be determined in preprocessing or the like by a program other than the secret holding program or using a function of a device that executes a program.

(7) In the case of the secret holding program holding secret information, the value of the secret information may instead be processing for calculating the value of the secret information using the selection parameter-use variables and the selection identifier-use variable.

(8) In the program obfuscation apparatus 10 in the first embodiment, the number of selection-target data pieces and the number of selection parameters are not limited to being fixed values, and may have other values.

Furthermore, these values may be input into the program obfuscation apparatus.

(9) Although a description was given of a simple method for dividing the blocks in the first embodiment, the method used is not limited to the described method. Instead, control structure analysis may be performed in accordance with how blocks are divided, and function provision instruction groups may be generated in accordance with how blocks are divided. Note that since control structure analysis is commonly known, a description thereof is omitted.

(10) In the first embodiment, it is after determining the initial values and the constant that the program obfuscation apparatus 10 determines selection-target data pieces into which a function provision instruction groups are to be inserted. However, the program obfuscation apparatus 10 is not limited to doing so, and may determine the initial values and the constant value after determining the arrangement the function provision instruction group.

(11) In the first embodiment, the program obfuscation apparatus 10 generates the secret holding program by determining the arrangement of the preprocessing instruction group, the selection processing instruction group, the transition processing instruction group and the selection-target data pieces after a selection-target main instruction group, an update processing instruction group and a branch instruction group have been inserted in selection-target data pieces containing only label names. However, the program obfuscation apparatus 10 is not limited to generating the secret holding program in this manner.

The program obfuscation apparatus 10 may first determine the arrangement of the preprocessing instruction group, a selection processing instruction group, a transition processing instruction group, and the selection-target data pieces containing only label names, and then insert a selection-target main instruction group, an update processing instruction group, and a branch instruction group in each selection-target data piece.

(12) The described embodiment and the modification examples may be combined.

1.6 Conclusion

The secret holding program 100 shown in the first embodiment has an order of execution that is difficult to analyze due to the selection-target main instruction groups 152, 154 and 156 being arranged apart from each other in a manner that is unrelated to the actual order of execution.

The order of execution is also difficult to analyze due to the fact that branch instructions that branch directly to other selection-target main instruction groups are not included in the selection-target main instruction groups 152, 154 and 156.

The order of execution is also difficult to analyze due to the fact that the selection processing instruction group that performs processing to determine which selection-target data piece is to be branched to next potentially branches to any of the selection-target main instruction groups in accordance with the value of the selection parameters. The order of execution is also difficult to analyze due to the selection-target data pieces 140, 141, 143 and 145 that are not actually executed in general use existing among the selection-target data pieces 140 to 146.

In addition, in the present embodiment, the order of execution of the selection-target data pieces 140 to 146 is determined using a plurality of selection parameters. Therefore, even if a malicious analyzer happened to find out part of the execution order, it would be difficult to find out the rest of the execution order. In more detail, taking the case of secret holding program being an algorithm that detects a watermark, it is possible that a malicious analyzer will exist who is knowledgeable about general watermark processing, and knows what kind of processing is used to incorporate a general watermark detection algorithm. Such an analyzer may be able to discover which of the numerous selection-target data pieces are likely to be executed. If the selection processing instruction group is processing for determining an order of execution based on one selection parameter, the malicious analyzer will be able to discover the value of the single parameter. The parameter can be discovered by making a reverse calculation to find the selection identifier used by the transformation processing instruction in order to branch to a selection-target data piece that is likely to be executed, and then making a reverse calculation to find the selection parameter that was used by the selection processing instruction group to procure the selection identifier. It will be possible to discover the order of execution by tracking subsequent changes in the selection parameter value and processing of the selection processing instruction group. However, if a plurality of selection parameters are used as in the present technique, the selection parameters will not be able to be discovered by way of a reverse calculation using the selection identifier even if one selection-target data piece that is likely to be executed happens to be found.

It is also possible that a malicious analyzer will happen to discover selection-target data pieces executed in succession. In this case, the illegal analyzer will discover more input/output sets with respect to Expression 1 of the selection processing instruction group. Increasing the number of selection parameter-use variables used in Expression 1 makes analysis more difficult.

In the present embodiment, the selection-target data pieces also include processing for updating the selection parameters. Accordingly, even if an illegal analyzer discovered the secret holding program and input values given to the secret holding program, the analyzer will not be able to discover the order that the selection-targets are actually executed in unless he/she analyzes the manner in which the value of the selection parameters changes in order.

Furthermore, conventionally, in a case that the order of execution is determined using a switch statement, a value showing the next block to execute may be directly written at the end of the block (the value used in the switch statement). In the present embodiment, the next selection-target data piece to be executed is determined by executing a selection processing instruction group using a selection parameter group consisting of three values. In the present embodiment, the next selection-target data piece to be executed is determined by executing the selection processing instruction group using the selection parameter group consisting of three values. At this time, first the function provision instruction group to be executed first is determined based on three correct initial values. Next, the function provision instruction group to be executed second is determined based on the selection parameter group updated by the update processing instruction group (the selection parameter group updated once). The function provision instruction group to be executed n-th is determined by executing the selection processing instruction group using successively the selection parameter group consisting of the three initial values, the updated selection parameter group updated once, . . . , the selection parameter group updated (n−1) times. Here, n is an integer no less than 1. In more detail, a correctly updated selection parameter group is generated by executing the update processing instruction group in the correct order, and the function provision instruction group is determined by executing the selection processing instruction group using the generated selection parameter group. In the present embodiment, the value used in the switch statement can be acquired by successively updating the selection parameter group. In other words, in the present embodiment, the value used in the switch statement is concealed in the program, and is acquired by successively updating the selection parameter group. A technique of acquiring concealed information from a number of other pieces of information is called obfuscation by divided secret. The update processing instruction group in the present embodiment corresponds to a divided secret.

### 2. Second Embodiment

Referring to the drawings, the following describes a secret holding program 300 and a program obfuscation apparatus 30 as a second embodiment of the present invention.

2.1 Outline of Secret Holding System 2

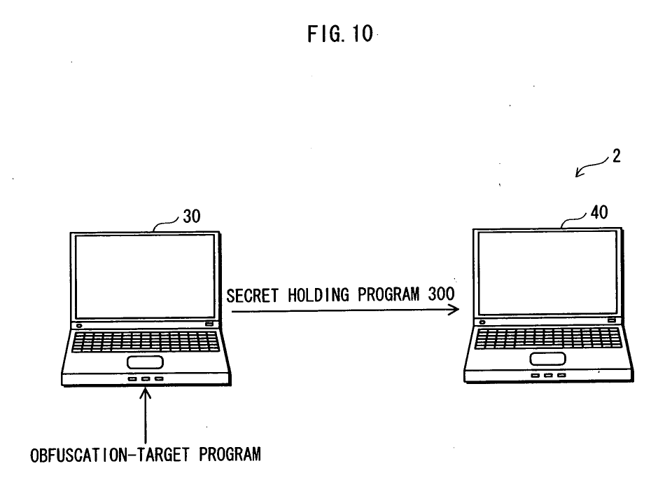

As shown in FIG. 10, a secret holding system 2 is composed of the program obfuscation apparatus 30 and a program execution apparatus 40.

The program obfuscation apparatus 30 generates a secret holding program 300 from an obfuscation-target program whose execution order is to be kept secret, and distributes the generated secret holding program 300 to the program execution apparatus 40.

The program execution apparatus 40 executes the secret holding program 300 distributed by the program obfuscation apparatus 40.

Here, the obfuscation target program is composed of three instructions groups, namely an instruction group A, an instruction group B and an instruction group C. The obfuscation target program operates correctly if the instruction groups A, B and C are executed in the stated order.

2.2 Structure of the Secret Holding Program 300

Here, a description is given of the structure of the secret holding program 300 generated by the program obfuscation apparatus 30 and executed in the program execution apparatus 40.

The secret holding program 300 is a program that performs processing using two or more pieces of secret information. The secret information is information that is to be kept from being analyzed by a malicious analyzer. The secret holding program 300 is, for instance, a program that performs encryption processing using sub keys, each of which is a piece of secret information. There is a desire to keep the secret information in this program confidential. The present example is based on that assumption that each of the instruction groups A, B and C includes a piece of secret information.

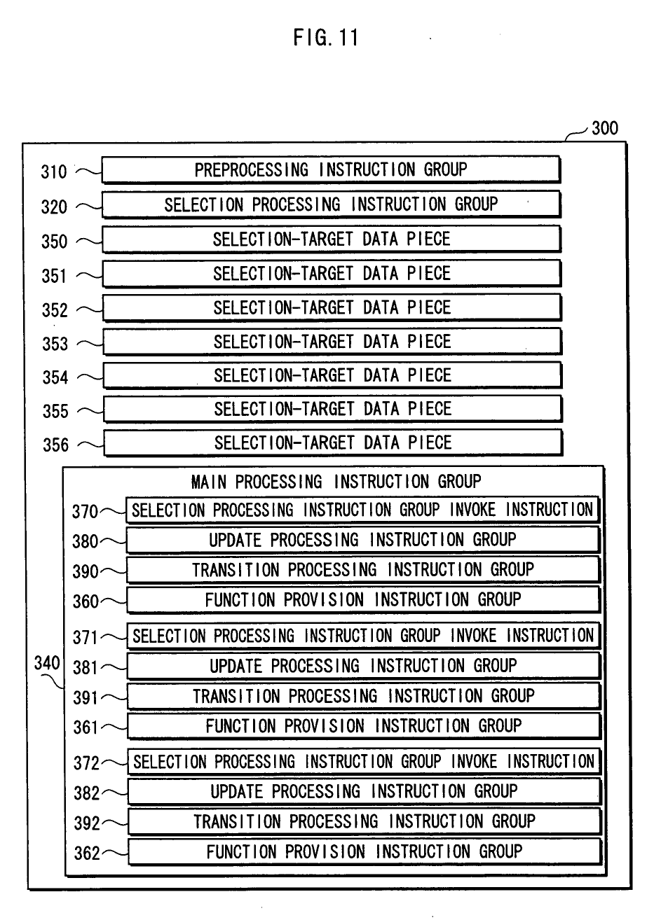

The secret holding program 300 is composed of a preprocessing instruction group 310, a selection processing instruction group 320, a main processing instruction group 340, and selection target data pieces 350 to 356, arranged in the order shown in FIG. 11.

The secret holding program 300 is a program instruction group that receives, from an invoker program, 32-bit input values in1, in2 and in3 that are used as initial values of the selection parameter group, and parameters used in processing that uses the secret information, and performs processing using the secret information. The processing with the secret holding program uses 32-bit first to third selection parameter-use variables, a 32-bit selection identifier-use variable, and a 32-bit secret information-use variable. The first to third selection parameter-use variables hold values of a plurality of selection parameters (three here) used in processing of the selection processing instruction group 320. The selection identifier-use variable holds a selection identifier. The secret information-use variable is a variable that stores secret information calculated by the transition processing instruction groups 390 to 392. The selection parameters are parameters used to determine a selection target from among the selection-target data pieces 140, 141, . . . , 146. The selection identifier is an identifier that uniquely identifies a selection-target data piece.

The present example is based on the assumption that the input values in1, in2 and in3 received from an invoker program have values “1”, “2” and “3”, respectively.

The secret holding program 300 is a program instruction group that performs processing using two or more pieces of secret information. In the present embodiment, it is assumed that the first to third secret information pieces are included in the instruction groups A, B, C, respectively, and that the values of the secret information pieces are “100”, “200” and “300”, respectively.

2.2.1 Preprocessing Instruction Group 310

The preprocessing instruction group 310 is a program instruction group for calculating the initial values of the selection parameter group used in the selection processing instruction group 320, which is described later. The selection parameter group consists of the first, second and third selection parameter-use variables.

The processing of the preprocessing instruction group 310 is substantially the same as that of the preprocessing instruction group 110 shown in the first embodiment, with the difference being that whereas the preprocessing instruction group 110 has a program instruction group for branching to selection processing instruction group 120 at the end thereof, the preprocessing instruction group 310 has a program instruction group for branching to the main processing instruction group 340 at the end thereof.

2.2.2 Selection Processing Instruction Group 320

The selection processing instruction group 320 is a program instruction group for selecting one of the selection-target data pieces 340 to 346 based on the selection parameter group, and setting the selected selection-target data piece as the selection identifier.

The processing of the selection processing instruction group 320 is substantially equivalent processing to the selection processing instruction group 120, with the difference being that the selection processing instruction group 320 is a subroutine.

More specifically, whereas the selection processing instruction group 120 has a program instruction at the end thereof for branching to a transition processing instruction group, the selection processing instruction group 320 is a program function, and a branch to the program that invoked this function is made at the end of the selection processing instruction group 320.

Note that the selection identifier is calculated using Expression 1 in the same way as the selection processing instruction group 120.

2.2.3 Selection-Target Data Pieces 350 to 356

The selection-target data pieces 350 to 356 are data read by an update processing instruction group.

More specifically, if the selection-target data pieces 350 to 356 are, for instance, array data. In the case of C language, the selection-target data pieces 350 to 356 are an array such as the following.
variable_{—}140[7]={1, 2, 3, 4, 5, 6, 7};

This array is used in transition processing instruction groups 390 to 392 described later. The kind of the program instruction groups that the transition processing instruction groups 390 to 392 become depends on this array and the initial values of the selection parameters in the preprocessing instruction group 310.

2.2.4 Main Processing Instruction Group 340

The main processing instruction group 340 is a program instruction group that performs processing using secret information.

The main processing instruction group 340 is a program group consisting of function provision instruction groups 360 to 362, selection processing instruction group invoke instructions 370 to 372, update processing instruction groups 380 to 382, and the transition processing instruction groups 390 to 392. The instruction groups are positioned as shown in FIG. 11.

(1) Function Provision Instruction Group 360 to 362

The function provision instruction group 360 is a program instruction group for performing processing using secret information. The program instructions that use values of secret information are written as processing that uses the secret information-use variable. In other words, the secret information is converted into a secret information-use variable in advance. If the value of the secret information-use variable is the value “100” of the first secret information, the function provision instruction group 360 performs the originally-intended processing.

The function provision instruction group 361 is also the same kind of program instruction group, and performs the originally-intended processing if the value stored in the secret information-use variable is the value “200” of the secret information 2.

The function provision instruction group 362 is also the same kind of program instruction group, and performs the originally-intended processing if the value stored in the secret information-use variable is the value “300” of the secret information 3.

Note that the secret information in each function provision instruction group is converted into a secret information-use variable in advance.

(2) Selection Processing Instruction Group Invoke Instructions 370 to 372

Each of the selection processing instruction group invoke instructions 370 to 372 is a program instruction group for invoking the selection processing instruction group 320.

(3) Update Processing Instruction Groups 380 to 382

The update processing instruction group 380 is a program group that performs processing to read the value of a selection-target data piece corresponding to the selection identifier, and performs processing to update the values of the selection parameter group using the read value.

More specifically, the update processing instruction group 380 first reads the value stored in the one of selection-target data pieces 350, 351, . . . , 356 that corresponds to the one of one of 0, 1, . . . , 6 that is the value of the selection identifier-use variable.

Next, the update processing instruction group 380 updates the selection parameter group based on the read value. Here, the update processing instruction group 380 stores the value of the second selection parameter in the third selection parameter, stores the value of the first selection parameter in the second selection parameter, and stores the read value in the first selection parameter.

For instance, when the update processing is written as a C language program, the update processing instruction group 380 is a program instruction group expressed as

“(third selection parameter variable)=(second selection parameter variable);

(second selection parameter variable)=(first selection parameter variable);

(first selection parameter variable)=variable_140[(selection identifier-use variable)];”.

Note that the update processing instruction groups 381 and 382 have the same structure as the update processing instruction group 380, and therefore a description thereof is omitted here.

(4) Transition Processing Instruction Group 390 to 392

The transition processing instruction groups 390 to 392 are processing for determining the value of the secret information-use variable based on the value of the selection parameter variable.

More specifically, each of the transition processing instruction groups 390 to 392 is a program instruction group that calculates a value to store in the selection parameter variable (secret information), and stores the calculated value in the secret information-use variable.

The following describes the operations of the transition processing instruction group 390 to 392 in detail.

(4-1) Transition Processing Instruction Group 390

The transition processing instruction group 390 performs processing for performing calculation using the first to third selection parameter-use variables, calculating the value of the first secret information, and storing the calculated value in the secret information-use variable.

For instance, the transition processing instruction group 390 performs processing for setting P4, P5 and P6 as primes that are coprime with each other, calculating “P4×(first selection parameter-use variable)+P5×(second selection parameter-use variable)+P6×(third selection parameter-use variable)+(constant 1)”, and storing the calculated value in the secret information-use variable. Note that the operator “×” expresses multiplication. Furthermore, in the present example P4, P5 and P6 have respective values of “2”, “3” and “5”, and the processing is for calculating Expression 2 “2×(first selection parameter-use variable)+3×(second selection parameter-use variable)+5×(third selection parameter-use variable)+(constant 1)”, and storing the calculated value in the secret information-use variable.

The following describes constant 1.

In the secret holding program 300, the preprocessing instruction group 310, the selection processing instruction group invoke instruction 370, the selection processing instruction group 320, and the update processing instruction group 380 are executed in the stated order before the transition processing instruction group 390 is executed. Note that the preprocessing instruction group 310, the selection processing instruction group invoke instruction 370, the selection processing instruction group 320 and the update processing instruction group 380 are executed with the input values in1, in2 and in3 received from the invoker program having respective values “1”, “2” and “3”. Alternatively, the input values received from the invoker program may be other arbitrary values.

According to Expression 1 “2×(first selection parameter-use variable (=1))+3×(second selection parameter-use variable (=2))+5×(third selection parameter-use variable (=3)) MOD 7”, the selection processing instruction group 320 calculates a selection identifier value “2”. The value acquired by the update processing instruction group 380 from the selection-target data pieces 350 to 356 is “3”, and the respective values of the first to third selection parameter variables are after updating are “3”, “1” and “2”.

The constant 1 is set in advance such that the value of the secret information-use variable obtained by assigning the values of the first to third selection parameter variables obtained as described is the value “100” of the first secret information. In the present example, the constant is 81.

(4-2) Transition Processing Instruction Group 391

Similarly, the transition processing instruction group 392 is an instruction group consisting of “2×(first selection parameter-use variable)+3×(second selection parameter-use variable)+5×(third selection parameter-use variable)+(constant 2).

The following describes constant 2.

In the secret holding program 300, the preprocessing instruction group 310, the selection processing instruction group invoke instruction 370, the selection processing instruction group 320, the update processing instruction group 380, the transition processing instruction group 390, the function provision instruction group 360, the selection processing instruction group invoke instruction 371, the selection processing instruction group 320, and the update processing instruction group 381 are executed in the stated order before the transition processing instruction group 391 is executed.

Here, the values of the first to third selection parameter variables acquired by the update processing instruction group 381 are “6”, “3” and “1”. Using the described method to calculate the constant 2, the constant 2 will have the value “174”.

(4-3) Transition Processing Instruction Group 392

Similarly, the transition processing instruction group 392 is an instruction group consisting of “2×(first selection parameter-use variable)+3×(second selection parameter-use variable)+5×(third selection parameter-use variable)+(constant 3).

In the secret holding program 300, the preprocessing instruction group 310, the selection processing instruction group invoke instruction 370, the selection processing instruction group 320, the update processing instruction group 380, the transition processing instruction group 390, the function provision instruction group 360, the selection processing instruction group invoke instruction 371, the selection processing instruction group 320, the update processing instruction group 381, the transition processing instruction group 391, the function provision instruction group 361, the selection processing instruction group invoke instruction 372, the selection processing instruction group 320 and the update instruction processing instruction group 382 are executed in the stated order before the transition processing instruction group 392 is executed.

Here, the values of the first to third selection parameter variable value acquired by the update processing instruction group 382 are “6”, “6” and “3”. Using the described method to calculate the constant 3, the constant 3 will have the value “255”.

2.3 Execution of the Secret Holding Program 300

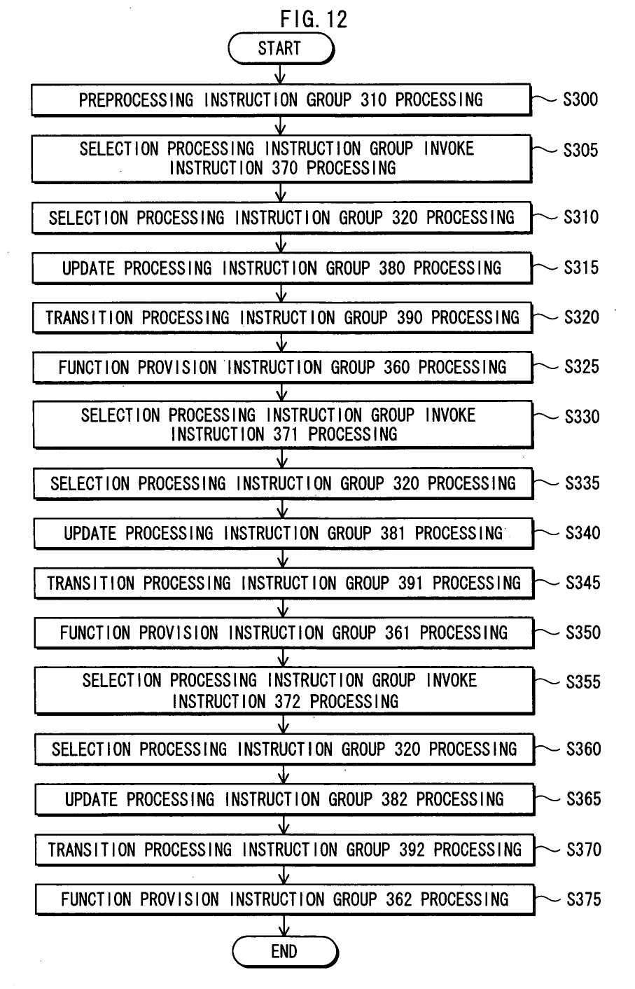

The flowchart shown in FIG. 12 is used to describe processing when the secret holding program 300 is executed in general use. The secret holding program 300 performs processing of the preprocessing instruction group 310 (step S300). Specifically, the preprocessing instruction group 310 receives values “1”, “2” and “3” as input values in1, in2 and in3, respectively, performs processing for storing each of the values “1”, “2” and “3” in the respective one of the first to third selection parameter-use variables, and branches to the selection processing instruction group invoke instruction 370.

Next, the secret holding program 300 performs processing of the selection processing instruction group 370 (step S305). Specifically, the selection processing instruction group 370 invokes the selection processing instruction group 320.

Next, the secret holding program 300 performs processing of the selection processing instruction group 320 using the received input values “1”, “2” and “3” (step S310). Specifically, the selection processing instruction group 320 calculates a value “2” according to Expression 1 “2×(first selection parameter-use variable (=1))+3×(second selection parameter-use variable (=2))+5×(third selection parameter-use variable (=3)) MOD 7”, and stores the calculated value “2” in the selection identifier-use variable.

The secret holding program 300 performs processing of the updating processing instruction group 380 (step S315). More specifically, in accordance with the value “2” of the selection identifier-use variable, the update processing instruction group 380 reads the value “3” of selection-target data piece 352. The update processing instruction group 380 stores the value “2” of the second selection parameter in the third selection parameter, stores the value “1” of the first selection parameter in the second selection parameter, and stores the read value “3” in the first selection parameter.

The secret holding program 300 performs processing of the transition processing instruction group 390 using the selection parameter group (first to third selection parameters) generated by the update processing instruction group 380 (step S320). More specifically, the transition processing instruction group 390 calculates a value to store in the secret information-use variable, using Expression 2 “2×(first selection parameter-use variable)+3×(second selection parameter-use variable)+5×(third selection parameter-use variable)+(constant 1)”, and stores the calculated value in the secret information variable. Here, “100” is stored in the secret information variable.

The secret holding program 300 performs processing of the function provision instruction group 360 based on the value stored in the secret information variable (step S325). Specifically, the function provision instruction group 360 executes the instruction group A in the obfuscation-target program.

Next, the secret holding program 300 performs processing of the selection processing instruction group invoke instruction 371 (step S330). More specifically, the selection processing instruction group invoke instruction 371 invokes the selection processing instruction group 320.

Next, the secret holding program 300 performs processing of the selection processing instruction group 320 using the received input values “3”, “1” and “2” of the first to third selection parameters (step S335). Specifically, the selection processing instruction group 320 calculates a value “5” according to Expression 1 “2×(first selection parameter-use variable (=3))+3×(second selection parameter-use variable (=1))+5×(third selection parameter-use variable (=2)). MOD 7”, and stores the calculated value “5” in the selection identifier-use variable.

The secret holding program 300 performs processing of the update processing instruction group 381 (step S340). More specifically, according to the value “5” of the selection identifier-use variable, the update processing instruction group 381 reads the value “6” of the selection-target data piece 355. The update processing instruction group 381 stores the value “1” of the second selection parameter in the third selection parameter, stores the value “3” of the first selection parameter in the second selection parameter, and stores the read value “6” in the first selection parameter.

The secret holding program 300 performs processing of the transition processing instruction group 391 using the selection parameter group (first to third selection parameters) generated by the update processing instruction group 381 (step S345). More specifically, the transition processing instruction group 391 calculates a value to store in the secret information-use variable, using Expression 2 “2×(first selection parameter-use variable)+3×(second selection parameter-use variable)+5×(third selection parameter-use variable)+(constant 2)”, and storing the calculated value in the secret information-use variable. Here, “200” is stored in the secret information variable.

The secret holding program 300 performs processing of the function provision instruction group 361 based on the value stored in the secret information variable (step S350). More specifically, the function provision instruction group 361 executes the instruction group B in the obfuscation-target program.

Next, the secret holding program 300 performs processing of the selection processing instruction group invoke instruction 372 (step S355). More specifically, the selection processing instruction group invoke instruction 372 invokes the selection processing instruction group 320.

Next, the secret holding program 300 performs processing of the selection processing instruction group 320 using the values “6”, “1” and “3” of the first to third selection parameters (step S360). More specifically, the selection processing instruction group 320 calculates a value “5” according to Expression 1 “2×(first selection parameter-use variable (=6))+3×(second selection parameter-use variable (=3))+5×(third selection parameter-use variable (=1)) MOD 7”, and stores the calculated value “5” in the selection identifier-use variable.

The secret holding program 300 performs processing of the update processing instruction unit 382 (step S365). More specifically, in accordance with the value “5” of the selection identifier-use variable, the update processing instruction group 382 reads the value “6” of the selection-target data piece 355. The update processing instruction group 382 stores the value “3” of the second selection parameter in the third selection parameter, stores the value “6” of the first selection parameter in the second selection parameter, and stores the read value “6” in the first selection-parameter.

The secret holding program 300 performs processing of the transformation processing instruction group 392 using the selection parameter group (first to third selection parameters) generated by the update processing instruction group 382 (step S370). More specifically, the transition processing instruction group 392 calculates a value to store in the secret information-use variable, using Expression 2 “2×(first selection parameter-use variable)+3×(second selection parameter-use variable)+5×(third selection parameter-use variable)+(constant 3)”, and storing the calculated value in the secret information-use variable. Here, “300” is stored in the secret information variable.

The secret holding program 300 performs processing of the function provision instruction group 362 based on the value stored in the secret information variable (step S375). More specifically, the function provision instruction group 362 executes the instruction group C in the obfuscation-target program.

2.4 Program Obfuscation Apparatus 30

A description is now given of the program obfuscation apparatus 30 that generates the secret holding program 300 from an obfuscation-target program whose order of execution is to be concealed. The parts other than the function provision instruction groups and the dummy function provision instruction groups can be used commonly for any kind, of obfuscation-target program. The following description focuses on generating of the function provision instruction groups and the transition processing instruction groups.

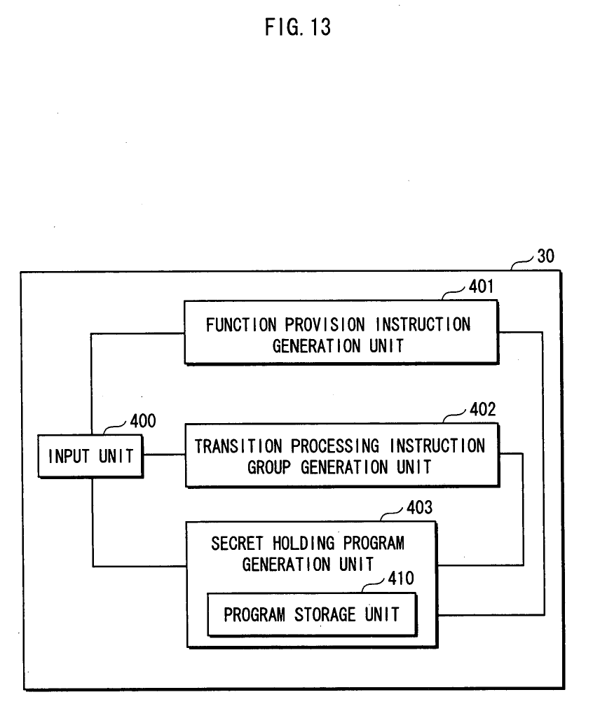

As shown in FIG. 13, the program obfuscation apparatus 30 is composed of an input unit 400, a function provision instruction group generation unit 401, a transition processing instruction group generation unit 402, and a secret holding program generation unit 403.

The program obfuscation apparatus 30 is, specifically, a computer system composed of a microprocessor, a RAM, a ROM, a hard disk unit, a display unit, a keyboard, a mouse, and the like. A computer program is stored in the RAM or the hard disk unit. Here, the computer program is a combination of instruction codes showing instructions to a computer for achieving predetermined functions. The program obfuscation apparatus 30 achieves its functions by the microprocessor operating in accordance with the computer program. In other words, the microprocessor reads the instruction in the computer program one instruction at a time, decodes the read instruction, and operates in accordance with the result of decoding.

2.4.1 Input Unit 400

The input unit 400 receives the obfuscation-target program, the three initial values (here, “1”, “2” and “3”) given to the secret holding program 300 when the secret holding program 300 is executed in general use, and position information showing the position of the secret information (here, three position information pieces showing positions where secret information “100”, “200” and “300” appear).

2.4.2 Function Provision Instruction Group Generation Unit 401

The function provision instruction group generation unit 401 divides the obfuscation-target program received by the input unit 400 into a plurality of blocks, each consisting of at least one program instruction. Note that when an unconditional skip or a conditional skip is included in the obfuscation-target program, the function provision group generation unit 401 divides the obfuscation-target program such that the program instruction that performs the skip and the program instruction that is the skip-destination are included in the same block. Furthermore, the blocks are structured such that each program instruction that performs processing using the values of secret information is included in a different block.

In the present embodiment, three function provision instruction groups are generated by dividing the obfuscation-target program into three blocks in a manner that the number of instructions in each part is as even as possible. The three generated function provision instruction groups are function provision instruction groups 1 to 3 in the order in which the original program instruction groups are included at the start of the obfuscation-target program.

2.4.3 Transition Processing Instruction Group Generation Unit 402

The transition processing instruction group generation unit 402 generates an equal number of transition processing instruction groups as function provision instruction groups generated by the function provision instruction group generation unit 401. Each transition processing instruction group includes Expression 2 in which the constant has not yet been determined.

In the present example, the transition processing instruction group generation unit 402 generates three transition processing instruction groups including Expression 2 in which the constant has not yet been determined.

2.4.4 Secret Holding Program Generation Unit 403

The secret holding program generation unit 403 generates the secret holding program 300 by generating the preprocessing instruction group 310, the selection processing instruction group 320, the selection processing instruction group invoke instructions 370 to 372, the update processing instruction groups 380 to 382, and the selection-target data pieces 350 and 351, using a plurality of function provision instruction groups and the transition processing instruction groups equal in number to the function provision instruction groups.

As shown in FIG. 13, the secret holding program generation unit 403 has a program storage unit 410.

The program storage unit 410 has areas for storing generated instruction groups and selection-target data pieces.

The secret holding program generation unit 403 acquires the function provision instruction groups generated by the function provision instruction group generation unit 401, and stores the acquired function provision instruction groups in the program storage unit 410.

The secret holding program generation unit 403 acquires transition processing instruction groups generated by the transition processing instruction group generation unit 402 and equal in number to the function provision instruction groups, and stores the acquired transition processing instruction groups in the program storage unit 410.

(1) Generating of the Preprocessing Instruction Group 310

The secret holding program generation unit 403 generates the preprocessing instruction group 310 consisting of a first preprocessing program instruction group that receives 32-bit input values in1, in2 and in3 from the invoker program and stores the received values in selection parameter-use variables as initial values of the parameter group, and a second preprocessing program instruction group that branches to a selection processing instruction group invoke instruction, the first preprocessing program instruction group and the second preprocessing program instruction group being executed in the stated order.

The secret holding program generation unit 403 stores the generated preprocessing instruction group 310 in the program storage unit 410.

(2) Generating of the Selection Processing Instruction Group 320

The secret holding program generation unit 403 generates the selection processing instruction group 320 that selects one of the selection data pieces 350 to 356, based on the selection parameter group, and sets the selection identifier.

Note that the processing of the selection processing instruction 320 is substantially the same processing as that of the selection processing instruction group 120, with the exception that the selection processing instruction group 320 is a subroutine. More specifically, whereas the selection processing instruction group 120 has a program instruction for branching to a transition processing instruction group at the end of the processing of the selection processing instruction group 120, the selection processing instruction group 320 is a program function, and a branch to the program that invoked this function is made at the end of the selection processing instruction group 320. In the present example, the selection identifier is calculated using Expression 1.

The secret holding program generation unit 403 stores the generated selection processing instruction group 320 in the program storage unit 410.

(3) Generating of Selection Processing Instruction Group Invoke Instructions 370 to 372

The secret holding program generation unit 403 generates the selection processing instruction group invoke instructions 370 to 372 for calling the selection processing instruction group 320.

The secret holding program generation unit 403 stores the generated selection processing instruction group invoke instructions 370 to 372 in the program storage unit 410.

(4) Generating of Update Processing Instruction Group 380 to 382

The secret holding program generation unit 403 generates update processing instruction groups 380 to 382 for performing processing for reading the value of the selection-target data piece corresponding to the selection identifier, and processing for updating the values of the selection parameters using the read value.

The secret holding program generation unit 403 stores the generated update processing instruction groups 380 to 382 in the program storage unit 410.

(5) Generating of the Selection-Target Data Pieces 350 to 351

The secret holding program generation unit 403 generates the selection-target data pieces 350 to 356 that are data read by the update processing instruction groups 380 to 382. The secret holding program generation unit 403 stores the generated selection-target data pieces 350 to 356 in the program storage unit 410.

More specifically, the selection-target data pieces 350 to 356 are, for instance, array data. In the case of C language, the selection-target data pieces 350 to 356 are an array such as the following.
variable_{—}140[7]={1, 2, 3, 4, 5, 6, 7};

The selection-target data pieces in the present invention are able to be processed as data according to the described operations of the secret holding program generation unit 403.

(6) Generating of the Secret Holding Program 300

The secret holding program generation unit 403 generates the secret holding program 300a in which the constants in the transition processing instruction groups 390 to 392 are as yet undetermined. The secret holding program generation unit 403 generates the secret holding program 300a by arranging, in the order shown in FIG. 11, the preprocessing instruction group 310, the selection processing instruction group 320, the function provision instruction groups 360 to 362, the selection processing instruction group invoke instructions 370 to 372, the update processing instruction group 380 to 382, the transition processing instruction groups 390 to 392, and the selection-target data pieces 350 to 356 stored in the program storage unit 410.

The secret holding program generation unit 403 executes the generated secret holding program 300a as far as the processing of the update processing instruction group 380, using the initial values (“1”, “2” and “3”) received by the input unit 400. The secret holding program generation unit 403 then, when executing the transition processing group 390, determines the constant 1 using the secret information “100” received by the input unit 400, and assigns the determined constant 1 to Expression 2 included in the transition processing instruction group 390.

The secret holding program generation unit 403 then executes the secret holding program 300a as far as the processing of the update processing instruction group 381. The secret holding program generation unit 403 then, when executing the transition processing group 391, determines the constant 2 using the secret information “200” received by the input unit 400, and assigns the determined constant 2 to Expression 2 included in the transition processing instruction group 391.

The secret holding program generation unit 403 then executes the secret holding program 300a as far as the processing of the update processing instruction group 382. The secret holding program generation unit 403 then, when executing the transition processing group 392, determines the constant 3 using the secret information “300” received by the input unit 400, and assigns the determined constant 3 to Expression 2 included in the transition processing instruction group 392.

As a result of the described operations, the secret holding program generation unit 403 generates the secret holding program 300 in which the constant in each of the transition processing instruction groups 390 to 392 has been determined.

By arranging the selection processing instruction group invoke instructions 370 to 372, the update processing instruction groups 380 to 382, and the transition processing instruction groups 390 to 392, determining the constants, and assigning each constant to Expression 2 in the corresponding transition processing instruction group, the secret holding program generation unit 403 inserts the instruction groups in appropriate locations.

The secret holding program generation unit 403 converts the secret information into a secret information-use variable based on the position information received by the input unit 400. Accordingly, the generated secret holding program can be made into processing that uses secret variables that are generated in advance by converting secret information that is to be kept confidential.

2.4.5 Operations of the Program Obfuscation Apparatus 30

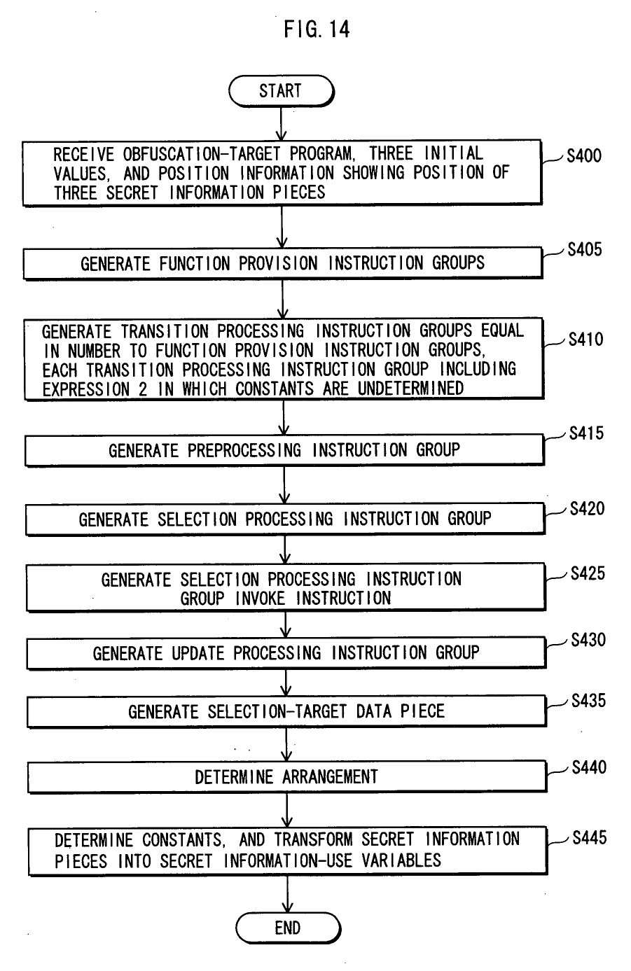

The following describes operations of the program obfuscation apparatus 30 with use of the flowchart shown in FIG. 14.

The input unit 400 of the program obfuscation apparatus 30 receives an obfuscation target program, three initial values (“1”, “2” and “3” here) to be given to the secret holding program 100 when executed in general use, and position information showing the positions of secret information (here, three pieces of information showing the positions of the three secret information pieces “100”, “200”, and “300”, respectively)(step S400).

The function provision instruction group generation unit 401 divides the obfuscation-target program into a plurality of blocks, each of which consists of one or more program instructions, to generate a plurality of function provision instruction groups (here, function provision instruction groups 360 to 362) (step S405).

The transition processing instruction group generation 402 generates an equal number of transition processing instruction groups as the function provision instruction groups generated at step S405, each transition processing instruction group including Expression 2 in which the constant has not yet been determined (step S410). In the present example, the transition processing instruction groups 390 to 392 that include Expression 2 in which the constant has not been determined are generated.

The secret holding program generation unit 403 generates the preprocessing instruction groups 310 (step S415).

The secret holding program generation unit 403 generates a selection processing instruction group 320 (step S420).

The secret holding program generation unit 403 generates the selection processing instruction group invoke instructions 370 to 372 equal in number to the generated function provision instruction group (step S425).

The secret holding program generation unit 403 generates the update processing instruction groups 380 to 382 equal in number to the generated function provision instruction groups (step S430).

The secret holding program generation unit 403 generates the selection data pieces 350 to 356 (step S435).

The secret holding program generation unit 403 determines the arrangement of the generated preprocessing instruction group 310, selection processing instruction group 320, function provision instruction groups 360 to 362, selection processing instruction group invoke instructions 370 to 372, update processing instruction groups 380 to 382, transition processing instruction groups 390 to 392, and selection-target data pieces 350 to 356, and generates the secret holding program 300a (step S440).

The secret holding program generation unit 403 determines the as yet undetermined constants with use of the three initial values and secret information pieces received at step S400 and the secret holding program 300a, and converts the secret information pieces into secret information-use variables, to generate the secret holding program 300 (step S445).

2.5 Modifications

The present invention has been described based on, but is by no means limited to, the second embodiment. Cases such as the following are included in the present invention.

(1) The expression used to calculate the secret information is not limited to being Expression 2 in the second embodiment. Any other expression that uses selection-use parameter variables may be used to calculate the secret information.

(2) Although in the second embodiment the expression used to calculate the selection identifier is Expression 1 as in the first embodiment, any other expression that uses selection-use parameter variables may be used to calculate the selection identifier.

The expression may be one that uses selection identifier-use variables set in advance, or one that uses a counter-use variable provided in a selection processing instruction group for counting how many times the selection processing instruction group has been invoked.

Furthermore, the counter-use variable may perform processing to increase the value of the counter other that with the selection processing instruction group.

(3) Although the number of function provision instruction groups is three in the second embodiment, the number is not limited to being three. Any number of function provision instruction groups may be used.

(4) Although the number of selection parameters is three in the second embodiment, the number is not limited to being three. Any plural number of selection parameters may be used.

In this case Expression 2 will be “p1×(first selection parameter-use variable)+p2×(second selection parameter-use variable)+ . . . +pn×(n-th selection parameter-use variable)+constant value”, where n is an integer no less than 2, and p1, p2, pn are coprimes. Furthermore, when updating the selection parameters, the value stored in the (I−1)-th parameter is shifted into the i-th parameter. Here, the n-th parameter, the (n−1)-th parameter, the second parameter are shifted successively in the stated order. Furthermore, a value read from the selection-target data piece corresponding to the selection identifier is stored in the first parameter. Here, i is an integer that is no less than 2 and no greater than n.

Furthermore, the initial values of the input values are not limited to being “1”, “2” and “3”. Furthermore, although values such as the input values are described as being 32-bit values, these values may be shorter than 32 bits or longer than 32 bits.

(5) In the second embodiment, instead of the initial values of the selection information parameters being given to the secret holding program, the initial values may be determined in preprocessing or the like by a program other than the secret holding program or using a function of a device that executes a program.

(6) In the case of the secret holding program holding secret information, the value of the secret information may instead be processing for calculating the value of the secret information using the selection parameter-use variables and the selection identifier-use variable.

(7) In the program obfuscation apparatus 30 in the second embodiment, the number of selection-target data pieces and the number of selection parameters are not limited to being fixed values, and may have other values.

Furthermore, these values may be input into the program obfuscation apparatus.

(8) Although a description was given of a simple method for dividing the blocks in the second embodiment, the method used is not limited to the described method. Instead, control structure analysis may be performed in accordance with how blocks are divided, and function provision instruction groups may be generated in accordance with how blocks are divided. Note that since control structure analysis is commonly known, a description thereof is omitted.

(9) In the second embodiment, the program obfuscation apparatus 30 converts the secret information into a secret information-use variable after determining the constants in Expression 2, but is not limited to doing so. The program obfuscation apparatus 30 may convert the secret information into a secret information-use variable at the time of generating function provision instruction groups. In other words, the program obfuscation apparatus 30 may convert the secret information into a secret information-use variable before determining the constants in Expression 2. In this case, the program obfuscation apparatus 30 stores each piece of secret information temporarily, and uses the temporarily stored information to determine the constants in Expression 2.

(10) The described embodiment and the modification examples may be combined.

2.6 Conclusion

In the second embodiment, the order of execution of the selection-target data pieces is determined according to the initial values of the selection parameters, and therefore it is difficult for a malicious analyzer who looks only at the program, and therefore does not know the initial values of the selection parameters, to analyze the order of execution of the selection-target data pieces.

Furthermore, in the second embodiment, the update processing instruction includes processing for updating the selection parameters. Accordingly, even if an illegal analyzer discovered the secret holding program and input values given to the secret holding program, the analyzer will not be able to discover the order that the selection-targets are actually executed in unless he/she analyzes the manner in which the value of the selection parameters changes in order.

### 3. Third Embodiment

Referring to the drawings, the following describes as secret holding program 500, a program obfuscation apparatus 50 and a secret processing apparatus 60 as a third embodiment of the present invention.

With the obfuscation techniques of Non-Patent Document 2 and the first embodiment, each block is only executed once when the correct procedure is used. If this fact is known to a malicious analyzer, the analyzer may be able to analyze the program efficiently.

Take an example of, in the first embodiment, amalicious analyzer who does not know the combination of correct initial values of the program and supposes the combination of initial values to be “0”, “0” and “0”. In this case, the secret holding program 100 first executes Expression 1 and acquires a selection identifier “0”, then branches to the selection-target data piece 143. Next, as a result of executing the update processing instruction group 163, the values of the selection parameters become “1”, “0” and “0”, respectively. The secret holding program 100 further executes Expression 1 using the updated values “1”, “0” and “0”, thereby acquiring the selection identifier “2”, and branches to the selection-target data piece 142. As a result of executing the update processing instruction group 162, the values of the selection parameters become “6”, “1” and “0”, respectively. The secret holding program 100 further executes Expression 1 using the updated values “6”, “1” and “0”, thereby acquiring the selection identifier “1”, and the selection parameters are updated to “3”, “6” and “1”. The secret holding program 100 executes Expression 1 using the values “3”, “6” and “1”, thereby acquiring the selection identifier “1”. This means that the selection-target data piece 141 is executed twice.

If the malicious analyzer knows that no one block is executed twice, the analyzer will find out at this point that the execution procedure that supposes the combination of initial values “0”, “0” and “0” which causes the selection-target data piece 141 to be executed twice is wrong. The malicious analyzer will know that the supposition was wrong without continuing the analysis and creating a watermark removal program, and will therefore be able to analyze more effectively. In other words, less time will be required for an exhaustive attack.

In view of such a situation, the present embodiment provides a secret holding system 3 in which the same block will never be executed twice, regardless of the combination of initial values.

3.1 Overview of the Secret Holding System 3

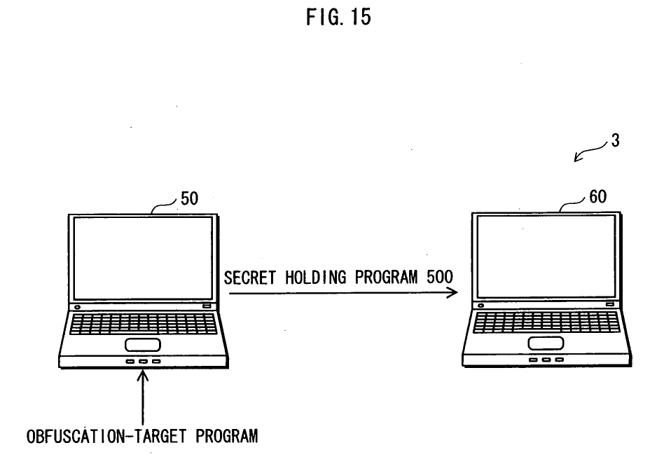

As shown in FIG. 15, the secret holding system 3 is composed of the program obfuscation apparatus 50 and the secret processing apparatus 60.

The program obfuscation apparatus 50 generates a secret holding program 500 from an obfuscation-target program whose execution order is to be kept secret, and distributes the generated secret holding program 500 to the secret processing apparatus 60.

The secret processing apparatus 60 executes the secret holding program 500 distributed by the program obfuscation apparatus 50.

3.2 Structure of the Secret Holding Program 500

A description is given of the structure of the secret holding program 500. The secret holding program 500 is a program that has been obfuscated so as to prevent the execution order of the program instruction groups included in the program being found out by a malicious analyzer.

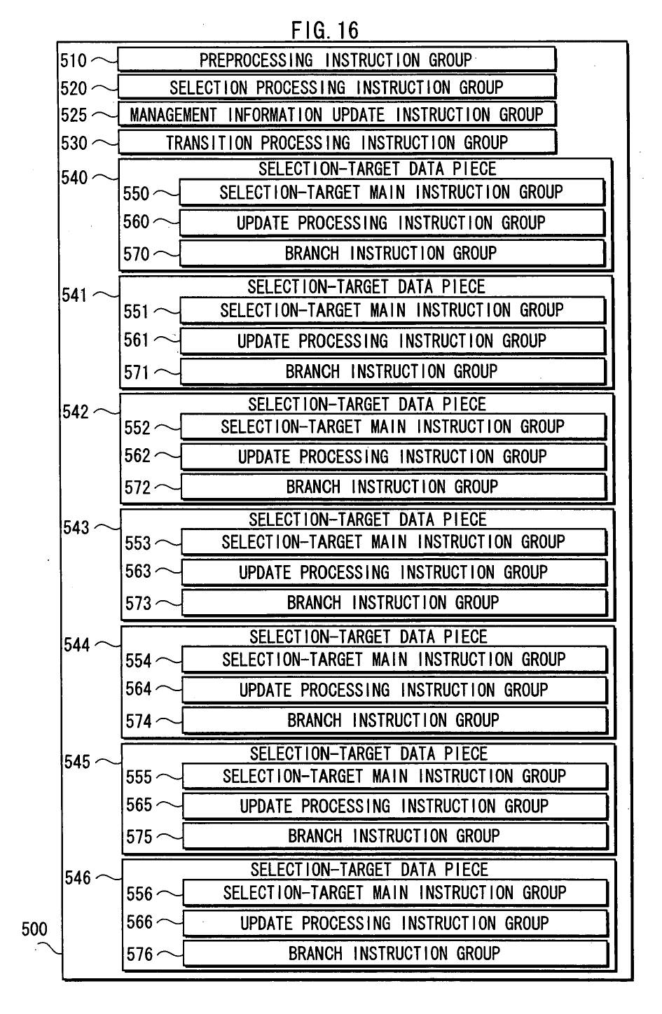

As shown in FIG. 16, the secret holding program 500 is composed of a preprocessing instruction group 510, a selection processing instruction group 520, a management information updating instruction group 525, a transition processing instruction group 530, and selection-target data pieces 540, 541, . . . , 546, arranged in the order shown in FIG. 16.

The selection target data-pieces 540 to 546 consist, respectively, of selection-target main instruction groups 550 to 556, updating processing instruction group 560 to 566, and branch instruction groups 570 to 576, arranged in the order shown in FIG. 16. Each instruction group consists of one or more program instructions. Each of the selection-target instruction main groups 550 to 556 is either a program instruction group that performs part of processing for a function provided by the program (such as a watermark detection function), or an instruction group that is unrelated to a function provided and is not executed in general use. Here, executing in general use ref ers to executing the secret holding program 500 without performing any special operations to forcedly change a program counter or selection parameters using a debugger or the like.

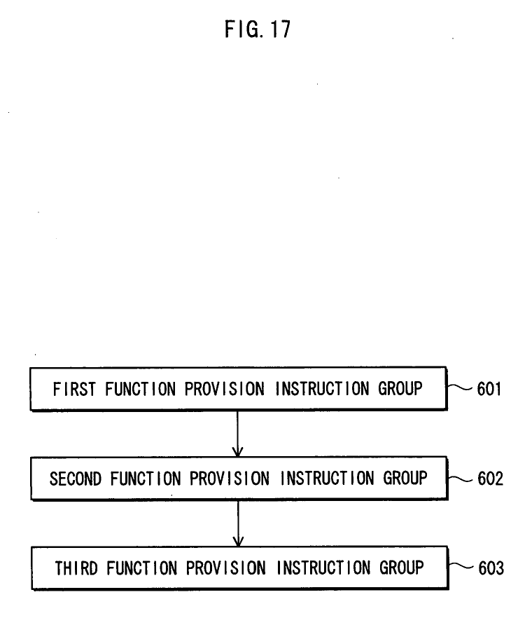

The obfuscation-target program is, for instance, a program that executes a control flow program shown in FIG. 17. Here, each of a first function provision instruction group 601, a second function provision instruction group 602 and a third function provision instruction group 603 in FIG. 17 is a collection of program instructions, and is an instruction group that outputs an appropriate result when executed in the flow shown in FIG. 17. However, given that the program would be easily analyzed if these function provision instruction groups were executed in this order, the secret holding program 500 is subjected to obfuscation so that it is difficult to discover the execution order. More specifically, the secret holding program 500 is obfuscated so that each of the first function provision instruction group 601, the second function provision instruction group 602 and the third function provision instruction group 603 is included in one of the selection-target data pieces 540 to 546.

The present explanation is continued based on the assumption that the first function provision instruction group 601, the second function provision instruction group 602 and the third function provision instruction group 603 are included in the selection-target data pieces 545, 546 and 543, respectively, and that the selection-target data pieces 545, 546 and 543 are selected and executed in the stated order. Furthermore, the selection-target data pieces 540, 541, 542 and 544 that have not had any of the first to third function provision instruction groups allocated thereto are selection-target data pieces that are not executed in general use. These target-selection data pieces may be executed when a malicious analyzer who does not know the correct execution order performs analysis by an exhaustive attack, and are included so as to make the first to third function provision instruction groups difficult to obtain. Hereinafter, these instruction groups are referred to as dummy function provision instruction groups.

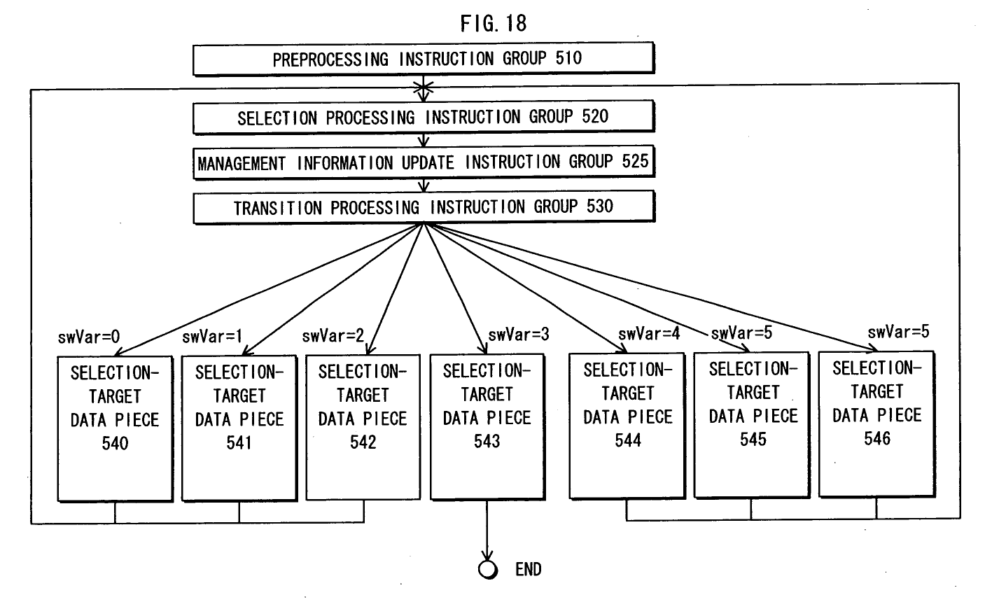

Here, an example of the control flow of the secret holding program 500 is shown in FIG. 18. As shown in this control flow, the secret holding program 500 first executes the preprocessing instruction group 510, the selection processing instruction group 520, the management information update instruction group 525 and the transition processing instruction group 530 in the stated order, and then based on the transition processing instruction group 530, one of the selection-target data pieces 540 to 546 is executed. The secret holding program 500 repeats this processing until the selection-target data piece 543 is executed. The secret holding program 500 is structured such that the order in which the selection-target data pieces are executed will not be known even if it is known how the transition processing instruction group 130 branches.

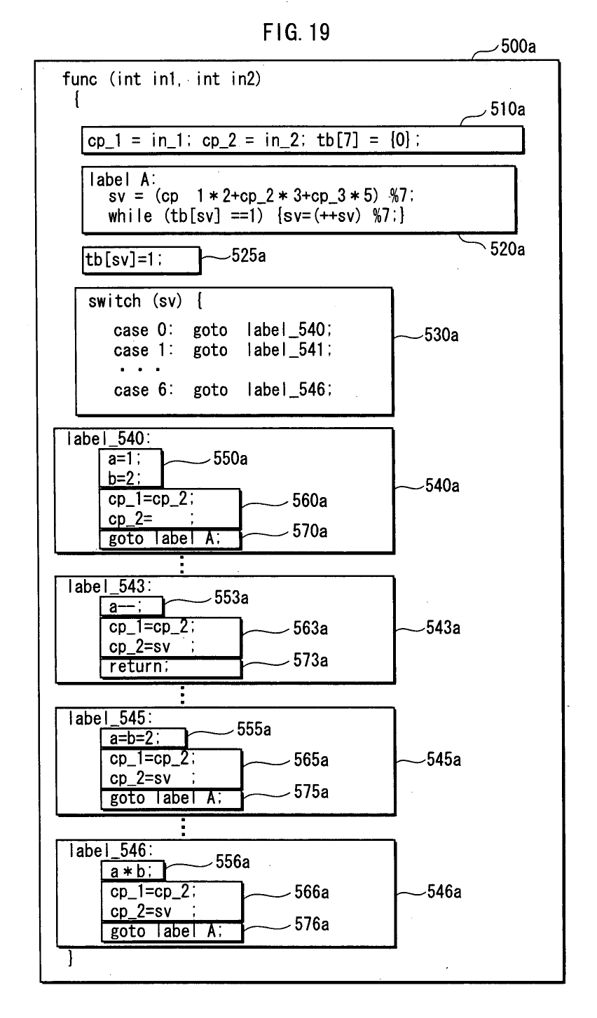

A secret holding program 500a written in C language is shown in FIG. 19 as a specific example of the secret holding program 500.

The program instruction group 510a corresponds to the preprocessing instruction group 510, the program instruction group 520a corresponds to the selection processing instruction group 520, the program instruction group 525a corresponds to the management information update instruction group 525, and the program instruction group 530a corresponds to the transition processing instruction group 530. The program instruction groups 540a, 543a, 545a and 546a correspond to the selection-target data pieces 540, 543, 545 and 546, respectively.

The program instruction group 550a, 553a, 555a and 556a correspond to the selection-target main instruction group 550, 553, 555 and 556, respectively. The program instruction groups 560a, 563a, 565a and 566a correspond to the update processing instruction groups 560, 563, 565 and 566, respectively. The program instruction groups 570a, 573a, 575a and 576a correspond to the branch instruction groups 570, 573, 574 and 576, respectively. Note that a specific example of the selection-target data pieces 541, 542 and 544 are omitted from the drawings for convenience.

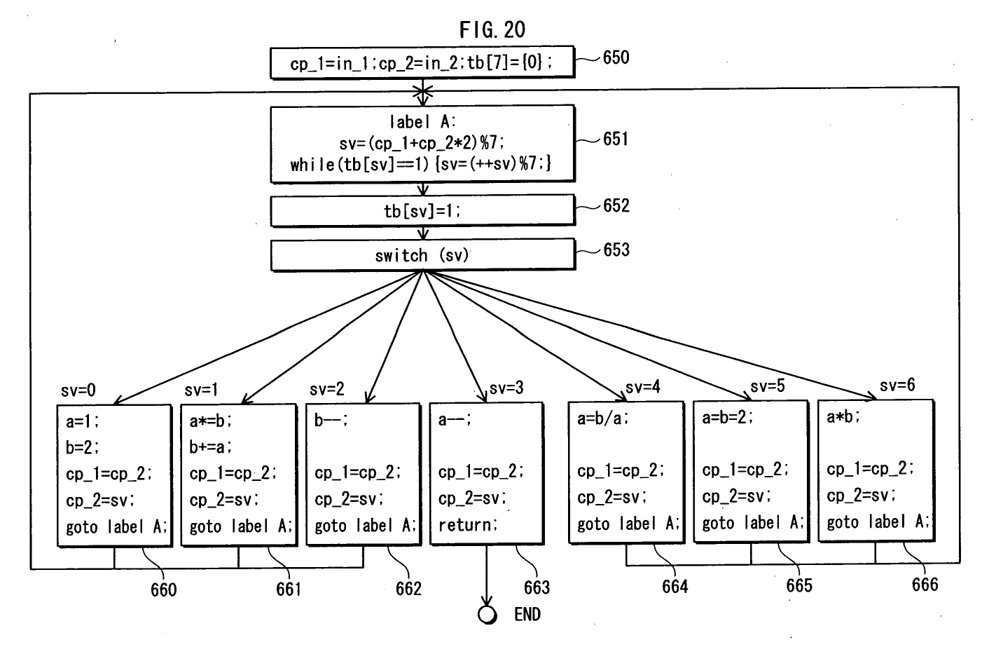

Furthermore, FIG. 20 shows a specific example of the flow of the program shown in FIG. 19.

The secret holding program 500 is a program instruction group that receives, from an invoker program, input values in_i and in_2, and parameters used when executing the function performed by the program, and performs preprocessing of the function provided by the program. Here, the input values in_1 and in_2 are the initial values of selection parameters CP_1 and CP_2 used in processing of the selection processing instruction group 520. Since the number of selection-target data pieces is seven in the present embodiment, in_1 and in_2 are non-negative integers less than 7 in the present explanation.

Furthermore, it is assumed that the secret holding program 500 uses “cp_1” and “cp_2” as variables showing selection parameters CP_1 and CP_2, and “sv” as a variable showing the selection identifier swVar. Note that the selection parameters are used when selecting a selection-target from among the selection-target data pieces 540, 541, . . . , 546. The selection identifier is an identifier that uniquely identifies a selection-target data piece, and is information specifying the selection-target data piece to be executed next.

The following describes the correlation between the blocks in FIG. 18 and the blocks in FIG. 20.

The preprocessing instruction group 510 in FIG. 18 corresponds to “cp_1=1; cp_2=2; tb[7]=0;” written in a block 650 in FIG. 20. The selection processing instruction group 520 corresponds to “label A:sv=(cp_1+cp_2*2)%7; while (tb[sv]==1) {sv=(++sv)%7;}” written in a block 651. Furthermore, the management information update instruction group 525 corresponds to “tb[sv]=1;” written in a block 652, the transition processing instruction group 530 corresponds to “switch (sv)” written in a block 653, and the selection-target data pieces 540 to 546 correspond to selection-target data pieces 660 to 666.

Furthermore, the update processing instruction groups 560 to 566 shown in FIG. 16 correspond to “cp_1=cp2; cp2_sv;” in each of the selection-target data pieces 660 to 666. Furthermore, the first to third function provision groups correspond to “a=b=2;”, “a*b;” and “a−−;”, respectively, and are included in selection-target data pieces 665, 666 and 663. Therefore, the dummy function provision instruction groups are “a=1, a=2;”, “a*=b; b+=a;”, “b−−;” and “a=b/a” in the selection-target data pieces 660, 661, 662 and 664.

Furthermore, the branch instruction groups 570 to 572 and 574 to 586 correspond to “goto label A;”, and the branch instruction group 573 corresponds to “return;”.

The following describes the specific operations of each of the instruction groups.

3.2.1 Preprocessing Instruction Group 510

The preprocessing instruction group 510 is a program instruction group for calculating the initial values of the selection parameter group used in the selection processing instruction group 520.

The preprocessing instruction group 510 is the program instruction group that is executed first when the secret holding program 500 is run.

The preprocessing instruction group 510 is, specifically, a program instruction group that consists of an instruction group and an initialization instruction. The instruction group is for receiving the input values in_1 and in_2 from the invoker program and storing the received values in the selection parameters CP_1 and CP_2 as initial values of the selection parameter group. The initialization instruction is for initializing management information pieces equal in number to the selection-target data pieces. Each of the management information pieces corresponds to a different one of the selection-target data pieces, and is for managing whether or not the corresponding selection-target data piece has been executed.

Here, the preprocessing instruction group 510 performs processing to store the values of in_1 and in_2 in the selection parameters CP_1 and CP_2, respectively. In the present example, when executed in general use, the values “1” and “2” are input as the input values in_1 and in_2.

As the initialization of the management information, the preprocessing instruction group 510 initializes management information held by the secret processing apparatus 60. Here, the management information is an array of six elements, and the preprocessing instruction group 510 initializes the management information by assigning “0” to all of the value of each of these elements. Note that “0” denotes “unexecuted”.

Here, the preprocessing instruction group 510 corresponds to “cp_1=in_1; cp_2=in_2; tb[7]=0;” written block 650 in FIG. 20.

3.2.2. Selection Processing Instruction Group 520

The selection processing instruction group 520 is a program instruction group for calculating a selection identifier using the selection parameter group.

The following describes processing for the selection processing instruction group 520 to calculate the selection identifier. Note that in the following description, the symbol NN denotes the number of pieces of selection-target data.

First, the selection processing instruction group 520 calculates a provisional selection identifier according to an Expression 3

“p1×(selection parameter CP_{—}1)+p2×(selection parameter CP_{—}2) mod NN”,

using the value NN, and p1 and p1 that are coprime integers with the value NN. Note that the operator “×” expresses multiplication. Furthermore, p1 and NN being coprime shows that the greatest common denominator of p1 and NN is “1”. In the present example, p1, p2 and NN are “1”, “2” and “7”, respectively.

Next, the selection processing instruction group 520 stores the result of Expression 3 in a selection identifier-use variable sv as a provisional selection identifier swVar. The selection processing instruction 520 then judges whether or not the selection-target data piece shown by sv has already been executed.

When it is judged that the selection-target data piece shown by sv has not yet been executed, the selection processing instruction group 520 sets the current value of sv as the selection identifier, without changing the value of sv.

When it is judged that the selection-target data piece shown by sv has already been executed, the selection processing instruction group 520 searches for a closest unexecuted selection-target data piece subsequent to the calculated value. Here, if all the selection-target data pieces subsequent to the calculated value have already been executed, the selection processing instruction group 520 searches the selection-target data pieces in order from the first selection-target data piece.

The selection processing instruction group 520 stores the number of the selection-target data-piece found according to the search in the selection identifier-use variable sv. By performing this kind of processing, an unexecuted selection-target data piece is always selected even if the selection-target data piece corresponding to the calculated value has already been executed, and a different selection-target data piece is always executed regardless of whether the program is executed in general use or not.

Here, the selection processing instruction group 520 corresponds to “sv=cp_1+cp_{—2*}2)%7; while (tb[sv]==1){sv=(++sv)%7;} written in the block 651 in FIG. 20.

3.2.3 Management Information Update Instruction Group 525

The management information update instruction group 525 is a program instruction group that updates the management information corresponding to the selection-target data piece selected by the selection processing instruction group 520, to a state showing “already executed”. Specifically, the management information update processing instruction group 525 corresponds to “tb[sv]=1;” written in the block 652 in FIG. 20.

As one example, if the value of selection identifier-use variable sv is “5” as a result of the operations of the selection processing instruction group 520, the management information update instruction group 525 updates the value of the management information tb[5] corresponding to the selection-target data piece 545 from “0” which shows “unexecuted” to “1” which shows “already executed”.

3.2.4 Transition Processing Instruction Group 530

The transition processing instruction group 530 is a program instruction group for performing processing to branch to one of the selection-target data pieces 540 to 546 based on a selection identifier calculated with the selection processing instruction group 520. More specifically, the possible values of the selection identifier-use variable sv are 0, 1, . . . , 6, and the branch destinations corresponding to the values of the identifier-use variable are the selection-target data pieces 540, 541 . . . , 546, respectively.

For instance, if the program in which the secret holding program 500 is written is a C language-program, and labels “label_140;”, “label_141;”, . . . , “label_146;” are written at the respective heads of the selection-target data pieces 540, 541, . . . , 546, the transition processing instruction group 530 will be a program instruction as follows.

switch (sv) {
case 0: goto label_140;
case 1: goto label_141;
...
case 6: goto label_146;
}

3.2.5 Selection-Target Data Pieces 540 to 546

The selection-target data pieces 540 to 546 are program instruction groups executed when branching from the transition processing instruction group 530.

The selection target data-pieces 540 to 546 consist, respectively, of selection-target main instruction groups 550 to 556, updating processing instruction groups 560 to 566, and branch instruction groups 570 to 576.

The selection-target main instruction groups 550 to 556 are program instruction groups showing processing to be performs in the respective selection-target data pieces. As one specific example, this corresponds to “a=1; b=2;” written in the selection-target data piece 660.

The update processing instruction group 560 to 566 is a program instruction group for updating the values of the selection parameter group. As one example, the value stored in the selection parameter variable cp_2 is assigned to the selection parameter variable cp_1, and the value of the selection identifier-use variable sv is assigned to the selection parameter variable cp_2. As one specific example, this corresponds to “cp_1=cp2; cp_2=sv;” included in each of the selection-target data pieces 660 to 666 in FIG. 20.

The branch instruction groups 570 to 576 are either a program instruction group for branching to selection processing instruction group 520 which is outside each of the selection-target data pieces 540 to 546, or a program instruction group for returning control to the invoker program.

Here, the branch instruction group 573 of the selection-target data piece 543 that includes the third function provision instruction group that is to be executed last is a program instruction group for returning control to the program invoker, and the branch instruction groups included in the other selection-target data pieces are program instruction groups for branching to the selection processing instruction group 120. More specifically, these correspond to “goto label A;” or “return;” in the selection-target data pieces 660 to 666 in FIG. 20.

3.3 Secret Processing Apparatus 60

A description is given of the secret processing apparatus 60 that executes the secret holding program 500.

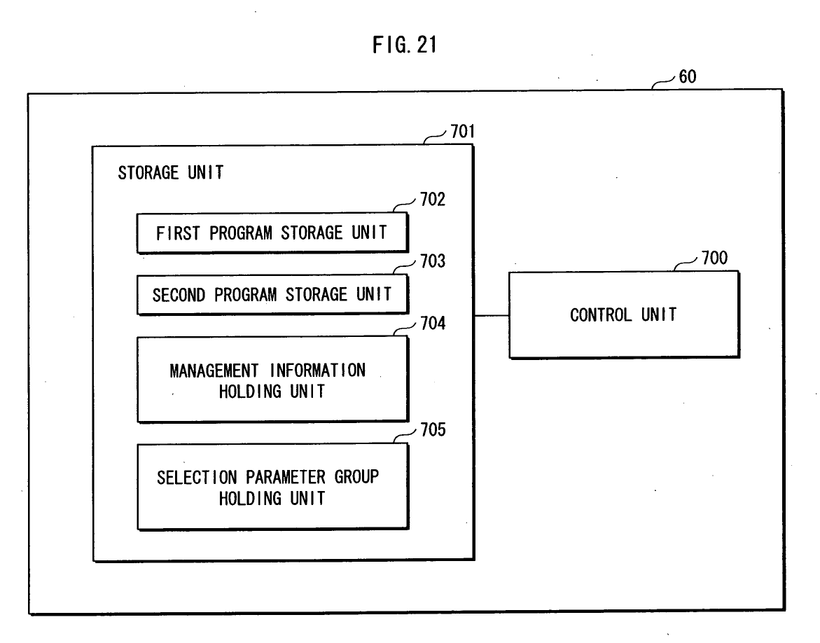

As shown in FIG. 21, the secret processing apparatus 60 is composed of a control unit 700 and a storage unit 701.

The secret processing apparatus 60 is, specifically, a computer system composed of a microprocessor, a ROM, a RAM, a hard disk unit, a display unit, a keyboard, a mouse, and the like. A computer program is stored in the RAM or the hard disk unit. Here, the computer program is a combination of instruction codes showing instructions for a computer for achieving predetermined functions. The secret processing apparatus 60 achieves its functions by the microprocessor operating in accordance with the computer program. In other words, the microprocessor reads the instruction in the computer program one instruction at a time, decodes the read instruction, and operates in accordance with the result of decoding.

3.3.1 Storage Unit 701

As shown in FIG. 21, the storage unit 701 is composed of a first program storage unit 702, a second program storage unit 703, a management information holding unit 704, and selection parameter group holding unit 705.

(1) First Program Storage Unit 702

The first program storage unit 702 stores selection-target data pieces included in a secret holding program. Here, each of the selection-target data pieces is information showing a procedure of processing that uses secret information, and more specifically is a collection of program instructions and the like. A selection-target data piece is selected is accordance with an instruction from the control unit 700, and the procedure shown by the selected selection-target data piece is executed by the secret processing apparatus 60. Furthermore, each selection-target data piece either is part of a correct procedure that uses secret information or includes calculations that use dummy secret information that is not executed in general use.

Note that while a total of seven selection-target data pieces, namely selection-target data pieces 540, 541, . . . , 546, are stored in the first program storage unit 702 in the present embodiment, this number is by no means limited to seven.

(2) Second Program Storage Unit 703′

The second program storage unit 703 stores program instructions other than the selection-target data pieces included in the secret holding program.

More specifically, the second program storage unit 703 stores a preprocessing instruction group 510, a selection processing instruction group 520, management information update instruction group 525 and a transition processing instruction group 530, all of these being part of the secret holding program 500.

(3) Management Information Holding Unit 704

The management information holding unit 704 holds management information pieces for managing, for each selection-target data piece, information showing whether the selection-target data piece has been executed or is yet to be executed.

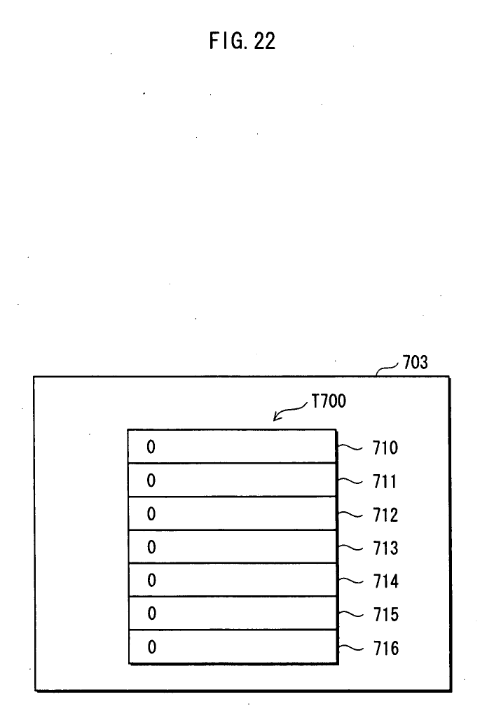

As shown in FIG. 22, the management information holding unit 704 has a management information table T700.

The management information table T700 has areas that are equal in number to the selection-target data pieces, and each stores a management information piece corresponding to a different one of the selection-target data pieces.

Management information pieces 710 to 716 in the management information table T700 correspond to the selection-target data pieces 540 to 546, respectively in this order.

The initial value stored in each of the management information pieces 710 to 716 is “0”, which shows that the corresponding selection-target data piece has not yet been executed.

When a selection-target data piece has been selected by the control unit 700, the corresponding management information piece is updated by the control unit 700 from the value “0” to a value “1”, which shows that the corresponding selection-target data piece has been executed.

(4) Selection Parameter Group Holding Unit 705

The selection parameter group holding unit 705 holds a selection parameter group consisting of selection parameters CP_1 and CP_2.

3.3.2 Control Unit 700

The control unit 700 controls the overall operations of the secret processing apparatus 60, and executes processing that uses secret information (secret holding program) such that the secret information is difficult to analyze.

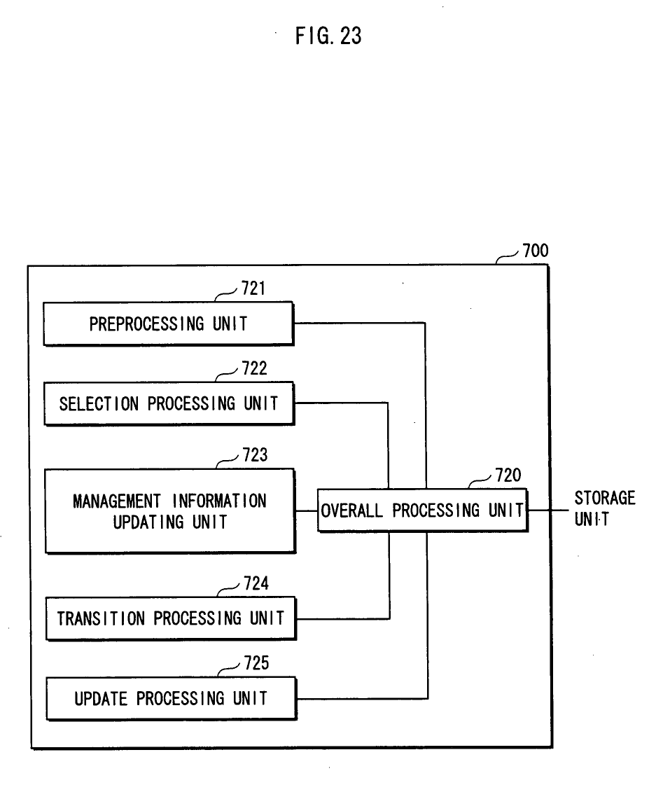

As shown in FIG. 23, the control unit 700 has an overall processing unit 720, a preprocessing unit 721, a selection processing unit 722, a management information updating unit 723, a transition processing unit 724, and an update processing unit 725. Note that it is not necessary for the control unit 700 to have these compositional elements as individual structures. The control unit 700 may carry out the function of each of these compositional elements when necessary.

(1) Preprocessing Unit 721

The preprocessing unit 721 operates first when the secret holding program is run.

The preprocessing unit 721 reads the one or more program instructions included in the preprocessing instruction group from the second program instruction unit 703 via the overall processing unit 720, and successively executes the read program instructions based on the structure of the secret holding program.

More specifically, the preprocessing unit 721 first acquires, as the initial values of the selection parameters CP_1 and CP_2, input values in_1 and in_2 from the invoker program, and stores the acquired selection parameters CP_1 and CP_2 in the selection parameter group holding unit 705 via the overall processing unit 720. Next, the preprocessing unit 720 initializes the management information holding unit 704. In other words, the preprocessing unit 721 sets the value of each of the management information pieces in the management information table T700 to “0”.

(2) Selection Processing Unit 722

The selection processing unit 722 sets the selection identifier swVar using the selection parameter.

The selection processing unit 722 reads the one or more program instructions included in the selection processing instruction group, from the second program storage unit 703 via the overall processing unit 720, and successively executes the read program instructions based on the structure of the secret holding program.

More specifically, the selection processing unit 722 calculates a provisional selection identifier using the selection parameters CP_1 and CP_2 stored in the selection parameter group holding unit 705, and Expression 3 included in the selection processing instruction group. Using the management information table T700, the selection processing unit 722 judges whether or not the selection-target data piece corresponding to the calculated provisional selection identifier has already been executed.

When it is judged that the selection-target data piece has been executed, the selection processing unit 722 acquires an identifier showing the unexecuted selection-target data piece, and sets the acquired value as the selection identifier swVar.

When it is judged that the selection-target data piece has not yet been executed, the selection processing unit 722 sets the calculated provisional selection identifier as the selection identifier swVar.

By performing this kind of processing, the selection processing unit 722 always acquires a value corresponding to an unexecuted selection-target data piece as the selection identifier swVar. In other words, a same selection-target data piece is never executed twice, regardless of what initial value the selection parameter takes. This makes analysis of the program difficult for a malicious analyzer.

(3) Management Information Updating Unit 723

The management information updating unit 723 updates the management information corresponding to the selection-target data piece selected by the selection processing unit 722.

The management information updating unit 723 reads the one or more program instructions included in the management information instruction group, from the second program storage unit 703 via the overall processing unit 720, and successively executes the read program instructions based on the structure of the secret holding program.

More specifically, of the management information pieces in the management information table T700, the management information updating unit 723 updates the value of the management information piece corresponding to the selection identifier swVar acquired by the selection processing unit 722 to “0” to “1”.

For instance, in FIG. 22, when the selection processing unit 722 has set the value of the selection identifier swVar to “5”, the management information updating unit 723 updates the value of the management information piece 715 corresponding to the selection-target data piece 545 to “1”.

(4) Transition Processing Unit 724

The transition processing unit 724 determines one of the selection-target data pieces as a branch destination based on the selection identifiers wVar selected by the selection processing unit 722, and executes the selection-target main instruction group included in the determined selection target data piece.

The transition processing unit 724 reads the one or more program instructions included in the transition processing instruction group, from the second program storage unit 703 via the overall processing unit 720, and successively executes the read program instructions based on the structure of the secret holding program.

More specifically, the transition processing unit 724 determines one of the selection-target processing data pieces as a branch destination, based on the selection identifier swVar selected by the selection processing unit 722.

The transition processing unit 724 reads the selection-target main instruction group included in the determined selection-target data piece, via the overall processing unit 720, and executes the read selection-target main instruction group.

(5) Update Processing Unit 725

The update processing unit 725 performs processing to update the value of the selection parameters after the selection-target main instruction group included in the selected selection-target data piece has been executed.

The update processing unit 725 reads the update processing instruction group included in the selected selection-target data piece, from the first program storage unit 702 via the overall processing unit 720, and executes the read update processing instruction group.

More specifically, the update processing unit 725 updates the selection parameters CP_1 and CP_2 using the selection parameters CP_1 and CP_2 stored in the selection parameter group holding unit 705. Since the method used to update the selection parameters CP_1 and CP_2 is described above, a description thereof is omitted here.

(6) Overall Processing Unit 720

The overall processing unit 720 controls operations of each compositional unit in the control unit 700.

When execution of the secret holding program commences, the overall processing unit 720 controls such that the preprocessing unit 721, the selection processing unit 722, the management information updating unit 723, the transition processing unit 724 and the update processing unit 725 operate in order.

Based on the branch instruction group included in the selection-target data piece, the overall processing unit 720 controls so as to end the secret holding program, or controls so as to operate in order of the selection processing unit 722, the management information updating unit 723, the transition processing unit 724, and the update processing unit 725.

More specifically, the overall processing unit 720 reads the branch instruction included in the selected selection-target data piece from the first programs to rage unit 702 via the overall processing unit 720.

When the read branch instruction group is a program instruction group showing branching to the selection processing instruction group, the overall processing unit 720 controls so as to operate in order of the selection processing unit 722, the management information updating unit 723, the transition processing unit 724, and the update processing unit 725.

When the read branch instruction group is a program instruction group for processing to return control to the program invoker, the overall processing unit 720 ends the secret holding program and returns control to the invoker.

3.3.3 Operations of the Secret Processing Apparatus 60

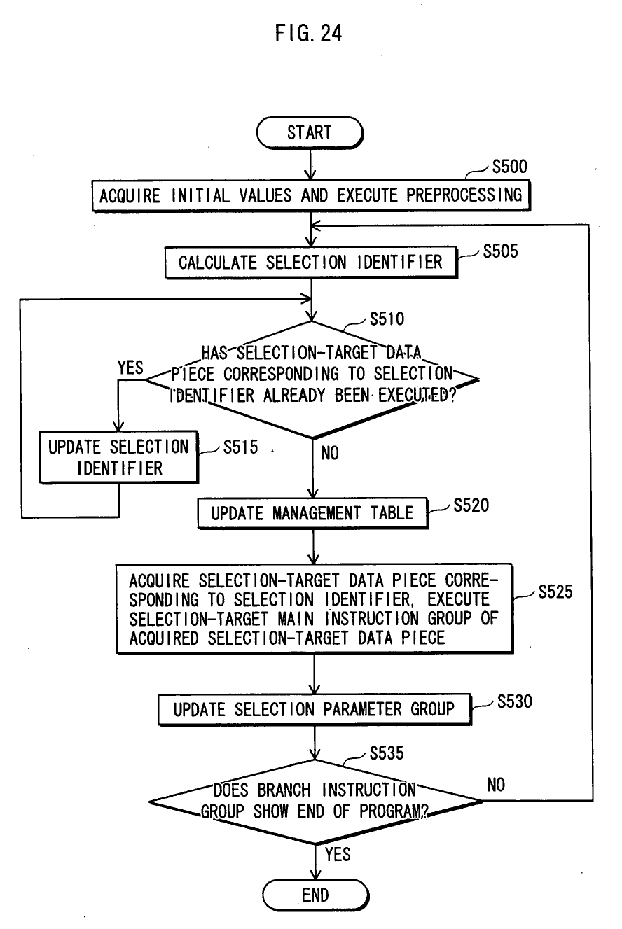

The flowchart shown in FIG. 24 is used to describe operations of the secret processing apparatus 60.

The preprocessing unit 721 of the secret processing apparatus 60 acquires input values in_1 and in_2 as initial values of the selection parameters CP_1 and CP_2 from an invoker program or from an external apparatus, stores the acquired selection parameters CP_1 and CP_2 in the selection parameter group holding unit 705 via the overall processing unit 720, and initializes the management information table T700 in the management information holding unit 704 (step S500).

If necessary, the preprocessing unit 721 reserves areas to be used for the first program storage unit 702, the second program storage unit 703, the management information holding unit 704 and the selection parameter group holding unit 705 in the memory area 701, and initializes the value stored in each area.

The selection processing unit 722 calculates a provisional selection identifier with use of the selection parameters CP_1 and CP_2 stored in the selection parameter group holding unit 705 and Expression 3 included in the selection processing instruction group (step S505).

Using the management information table T700, the selection processing unit 722 judges whether or not the selection-target data piece corresponding to the calculated provisional selection identifier has already been executed (step S510).

When it is judged that the selection-target data piece has already been executed (“YES” at step S510), the selection processing unit 722 updates the provisional selection identifier (step S515). Here, a specific example of steps S510 and S515 is “while (tb[sv]==1){sv=(++sv)%7” in block 651 in FIG. 20. In this example, as long as the value of tb[sv] is “1” (showing that the selection-target data piece has already been executed), the selection processing unit 722 searches for a selection identifier corresponding to an unexecuted selection-target data piece by successively incrementing sv.

When it is judged that the selection-target data piece has not yet been executed (“NO” at step S510), the selection processing unit 722 sets the calculated provisional selection identifier as the selection identifier swVar. The management information updating unit 723 updates the value of the management information piece that, among the management information pieces in the management table T700, corresponds to the selection identifier swVar, from “0” to “1” (step S520).

Based on the selection identifier swVar, the transition processing unit 724 acquires the one of selection-target data pieces that is the branch destination, and executes the selection-target main instruction group included in the acquired selection-target data piece (step S525).

Using the selection parameters CP_1 and CP_2 stored in the selection parameter group holding unit 705, and the selection identifier, the update processing unit 725 updates the selection parameters CP_1 and CP_2 (step S530).

The overall processing unit 720 judges whether or not the branch instruction group included in the selected selection-target data piece shows ending of the program (step S535).

When it is judged that the branch instruction group shows ending of the program (“YES” at step S535), the overall processing unit 720 ends the secret holding program, and returns control to the invoker of the secret holding program.

When it is judged that the branch instruction group does not showing ending of the program (“NO” at step S535), in other words, when it is judged that the branch instruction group shows branching to the selection processing instruction group, the overall processing unit 720 returns to step S505.

More specifically, at step S535, the judgment result is “NO” when the branch instruction group included in the selected selection-target data piece is an instruction group that branches to a selection processing instruction group (e.g., a goto statement). The judgment result is “YES” when the branch instruction group is an instruction group showing ending of the program (e.g., a return statement).

3.4 Program Obfuscation Apparatus 50

A description is now given of the program obfuscation apparatus 50 that generates the secret holding program 500 from an obfuscation target program whose order of execution is to be concealed.

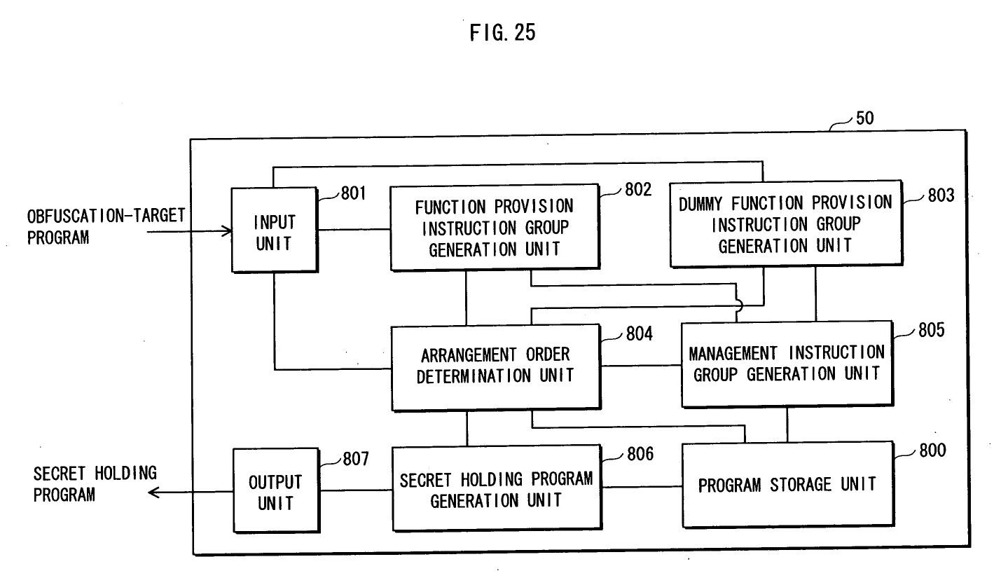

As shown in FIG. 25, the program obfuscation apparatus 50 is composed of a program storage unit 800, an input unit 801, a function provision instruction group generation unit 802, a dummy function provision instruction group generation unit 803, an arrangement order determination unit 804, a management instruction group generation unit 805, a secret holding program generation unit 806, and an output unit 807.

The program obfuscation apparatus 50 is, specifically, a computer system composed of a microprocessor, a ROM, a RAM, a hard disk unit, a display unit, a keyboard, a mouse, and the like. A computer program is stored in the RAM or the hard disk unit. Here, the computer program is a combination of instruction codes showing instructions for a computer for achieving predetermined functions. The program obfuscation apparatus 50 achieves its functions by the microprocessor operating in accordance with the computer program. In other words, the microprocessor reads the instruction in the computer program one instruction at a time, decodes the read instruction, and operates in accordance with the result of decoding.

3.4.1 Program Storage Unit 800

The program storage unit 800 has areas for storing instruction groups generated by the program obfuscation apparatus 50, and selection-target data pieces.

3.4.2 Input Unit 801

The input unit 801 receives the obfuscation-target program, and two initial values to be given to a generated secret holding program.

3.4.3 Function Provision Instruction Group Generation Unit 802

The function provision group generation unit 802 divides the obfuscation-target program received by the input unit 801 into a plurality of blocks, each consisting of at least one program instruction. Each block resulting from the dividing is a function provision instruction group. As a result, the function provision instruction group generation unit 802 generates a plurality of function provision groups from the obfuscation-target program received by the input unit 801.

When a conditional skip is included in the obfuscation-target program, the function provision group generation unit 802 divides the obfuscation-target program such that the program instruction that performs the conditional skip and the program instructions that are the skip-destinations are included in the same block. By dividing the obfuscation-target program in this way, the function provision instruction group generation unit 802 can ensure that branch destinations from one block are always in the one block.

Furthermore, when there is a program instruction for performing an unconditional skip in the input program, the function provision instruction group generation unit 802 divides the obfuscation-target program such that the program instruction that performs the unconditional skip and the program instruction that is the skip-destination are included in the same block. By dividing the obfuscation-target program in this way, the function provision instruction group generation unit 802 can ensure that the branch origin of a block is always a single block.

Here, an instruction for performing a conditional skip is an instruction that skips a program instruction under a predetermined condition. More specifically, in the case of “if (a==0) goto labelA;”, for instance, a skip is made to labelA when the condition that a variable “a” is zero is fulfilled. Furthermore, an instruction for performing an unconditional skip is an instruction that always skips a program instruction. A specific example is “goto labelA;”. In this case, a skip to labelA is always performed regardless of other factors such as the value of a variable.

In the present embodiment, the function provision instruction group generation unit 802 divides the obfuscation-target program into three function provision instruction groups. The control flow graph shown in FIG. 17 also applies in this case. In other words, since the function provision instruction group generation unit 802 divides the obfuscation-target program such that the branch origin and the branch destination of a skip instruction are included in the same block as described above, the control flow graph of a generated block will not include a branch. In the present example, the blocks being executed in order from the block that is the start point of the control flow, and within each block, the program instruction groups in the block are executed in order of the first, second and third function provision instruction groups so that the program does not fail to compile.

3.4.4 Dummy Function Provision Instruction Group Generation Unit 803

The dummy function provision instruction group generation unit 803 generates a plurality of dummy function provision instruction groups based on the obfuscation-target program received by the input unit 801.

The dummy function provision instruction group generation unit 803 generates the dummy function provision instruction groups so as to consist of a random combination of one or more program instructions written in the programming language in which the obfuscation-target program is written.

Note that dummy function provision instruction groups may be generated at random or manually using only program instructions in the obfuscation-target program. This makes it more difficult to differentiate between dummy function provision instruction groups and instructions originally included in the obfuscation-target program, and hence more difficult to analyze the obfuscation-target program. Furthermore, in a programming language that performs compiling processing, such as C language or Java™ language, the dummy function provision instruction group generation unit 803 generates dummy function provision instruction groups using variables used in the obfuscation-target program so that the program compiles. Furthermore, if variables that are not used in the obfuscation-target program are incorporated in the dummy function provision instruction groups, the dummy function provision-instruction group generation unit 803 adds such variable declarations to the obfuscated program.

The present explanation is continued based on the assumption that the dummy function provision instruction group generation unit 803 generates four dummy function provision instruction groups.

3.4.5 Management Instruction Group Generation Unit 805

The management instruction group generation unit 805 generates a program instruction group of program instructions of the secret holding program 500 that do not exist in the obfuscation-target program. In other words, in the example of the secret holding program 500 in FIG. 16, it is the selection-target main instruction groups 150 to 156 obtained by dividing the obfuscation-target program procedure that change depending on the obfuscation-target program, and therefore the management instruction group generation unit 805 generates other instruction groups.

More specifically, the management instruction group generation unit 805 generates a first branch instruction group and a second branch instruction group. The first branch instruction group consists of the preprocessing instruction group 510, the selection processing instruction group 520, the management information update instruction group 525, the transition processing instruction group 530, one update processing instruction group, and a program instruction group showing that the branch destination is a selection processing instruction group. The second branch instruction group consists of a program instruction group for processing to return control to an invoker program.

At this time, the management instruction group generation unit 805 acquires the number of function provision instruction groups generated by the function provision instruction group generation unit 802 (3 in the present example) and the number of dummy function provision instruction groups generated by the dummy function provision instruction group generation unit 803 (4 in the present example), and calculates a total value of the acquired numbers. The management instruction group generation unit 805 generates an equal number of label names to the calculated total value (7 in the present example).

The management instruction group generation unit 802 generates the transition processing instruction group 530 by putting each of the possible values obtained from Expression 3 in the selection processing instruction group 520 in association with a different one of the generated label names, as a branch destination.

The management instruction group generation unit 805 generates selection-target data pieces containing only the respective generated label. In the present example, the management instruction group generation unit 805 generates the seven selection-target data pieces 540 to 546.

Here, the management instruction group generation unit 805 stores the generated preprocessing instruction group 510, selection processing instruction group 520, management information update instruction group 525, transition processing instruction group 530, update processing instruction group, first branch instruction group and second branch instruction group to the program storage unit 800.

The management instruction group generation unit 805 also stores the generated selection-target data pieces containing only the label names to the program storage unit 800.

3.4.6 Arrangement Order Determination Unit 804

The arrangement order determination unit 804 determines what order the generated function provision instruction groups (three function provision instruction groups here) and dummy function provision instruction groups (four dummy function provision instruction groups here) are to be allocated to the selection-target main instruction groups 550 to 556. More specifically, the arrangement order determination unit 804 determines which the selection-target main instruction groups 550 to 556 to arrange the first to third function provision instruction groups in, and determines which of the remaining four selection-target main instruction groups to arrange the dummy function provision instruction groups in.

The arrangement order determination unit 804 stores Expression 3 in advance. In the present example, p1, p2 and NN in Expression 3 have values “1”, “2” and “7”, respectively.

Note that here it is assumed that selection-target main instruction groups 550 to 556, each consisting of a label name only, have been generated by the management instruction group generation unit 805 as described later.

Using, the initial values of the two selection parameters received by the input unit 801 and the pre-stored Expression 3, the arrangement order determination unit 804 determines selection-target main instruction groups in which the function provision instruction groups and the dummy function provision instruction groups are to be arranged, by checking what order the selection identifier will actually be calculated in.

Note that it is assumed here that the selection parameters CP_1 (=1) and CP_2 (=2) are received here by the input unit 801 as the two initial values. The following describes an example of how the arrangement is determined.

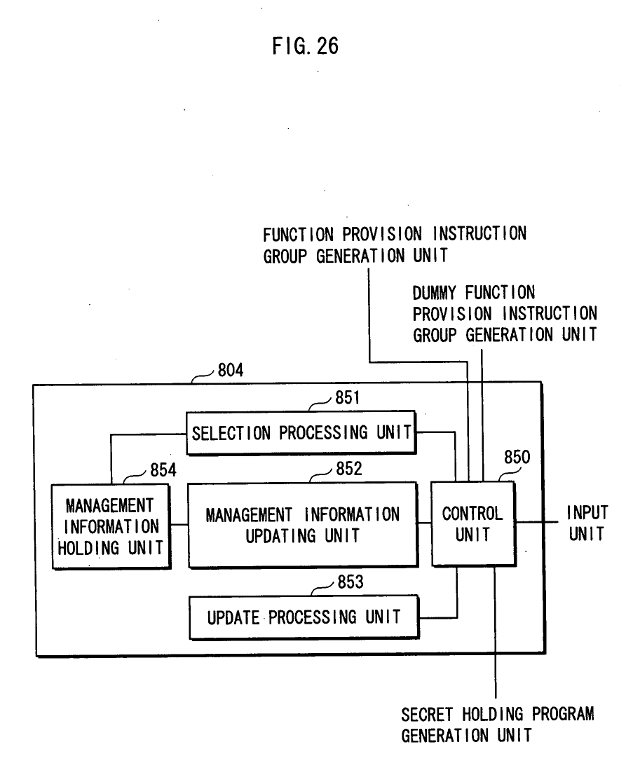

As shown in FIG. 26, the arrangement order determination unit 804 is composed of a control unit 850, a selection processing unit 851, a management information updating unit 852, an update processing unit 853 and a management information holding unit 854. The following describes the compositional elements of the arrangement order determination unit 804 in detail.

(1) Management Information Holding Unit 854

The management information holding unit 854 has a management information table T800. The management information table T800 has the same data structure as the management information table T700 in the management information holding unit 704 and therefore a description thereof is omitted here.

Note that in the present embodiment, a value “1” in the management information table T800 shows that a function provision instruction group is arranged in the corresponding selection-target data piece, and a value “0” shows that a function provision instruction group is not arranged in the corresponding selection-target data piece.

Furthermore, the initial value of each management information piece in the management information table T800 is “0”.

This enables the position in which the function provision instruction groups are arranged (the selection-target data piece in which each function provision instruction group is arranged) to be stored.

(2) Control Unit 850

The control unit 850 has a parameter storage area for storing the selection parameter group.

The control unit 850 stores the initial values CP_1 and CP_2 (here, “1” and “2”, respectively) of the selection parameters received by the input unit 801, in the parameter storage area.

The control unit 850 controls operations of the selection processing unit 851, the management information updating unit 852, and the update processing unit 853.

The control unit 850 puts in correspondence each of the possible values of Expression 3 in the selection processing unit 851 described later, in other words each of the possible values of selection identifier according to Expression 3, with the respective selection-target data pieces stored in the program storage unit 800.

The control unit 850 acquires the i-th generated function provision instruction group from the function provision instruction group generation unit 802. Based on the selection identifier acquired by the selection processing unit 851, the control unit 850 inserts the acquired i-th function provision instruction group in the corresponding selection-target data piece stored in the program storage unit 8b0. Here, i is an integer that is no less than 1 and no greater than m. The control unit 850 also temporarily stores the correspondence between i-th function provision instruction group and the selection-target data piece in which the i-th function provision instruction group is inserted.

The control unit 850 acquires one of the dummy function provision instruction-groups that has not been inserted into a selection-target data piece, from the dummy function provision instruction group generation unit 803. The control unit 850 inserts the acquired dummy function provision instruction group into a selection-target data piece that has not had an i-th function provision instruction group or a dummy function provision instruction group inserted therein. The control unit 850 performs these operations with respect to all dummy function provision instruction groups.

As a result of these operations, the control unit 850 inserts an i-th function provision instruction group or a dummy function provision instruction group into each selection-target data piece.

The operations by the control unit 850 for acquiring an i-th function provision instruction group enable acquisition of a function provision instruction group that is an arrangement-target.

(3) Selection Processing Unit 851

The selection processing unit 851 stores Expression 3 in advance.

The selection processing unit 851 acquires the selection parameters CP_1 and CP_2 stored in the parameter storage area.

The selection processing unit 851 calculates a provisional selection identifier using the acquired CP_1 and CP_2 and the pre-stored Expression 3. Using the management information table T800, the selection processing unit 851 judges whether or not the selection-target data piece corresponding to the calculated provisional selection identifier has already been arranged.

When it is judged that the selection-target data piece has already been arranged, the selection processing unit 851 acquires an identifier showing a selection-target data piece that has not yet been arranged, and sets the acquired value as the selection identifier swVar.

When it is judged that the selection-target data piece has not yet been arranged, the selection-processing unit 851 sets the calculated provisional selection identifier as the selection identifier swVar.

The operations by the selection processing unit 851, and the operations by the control unit 850 for inserting the i-th function provision instruction group into a selection-target data piece based on the selection identifier acquired by the selection processing unit 851 enable function provision instruction groups to be arranged in appropriate locations.

(4) Management Information Updating Unit 852

The management information updating unit 852 updates, from “0” to “1”, the value of the one of the management information pieces in the management information table T800 that corresponds to the selection identifier swVar obtained by the selection processing unit 851.

(5) Update Processing Unit 853

The update processing unit 853 updates the selection parameters CP_1 and CP_2 using the selection parameter group stored in the parameter storage area and the selection identifier acquired by the selection processing unit 851. Note that since the method used to update the selection parameters has been described above, a description thereof is omitted here.

The update processing unit 853 writes the updated selection parameter group to the parameter storage area in the control unit 850.

3.4.7 Secret Holding Program Generation Unit 806

The secret holding program generation unit 806 inserts an update processing instruction group stored in the program instruction unit 800 into each of the selection-target data pieces so as to be positioned after the selection-target main instruction group, thereby generating the update processing instruction groups 560 to 566 with respect to each of the selection-target data pieces. As a result of the operations by the management instruction group generation unit 805 for generating the update processing instruction group, and the above-described operations by the secret holding program generation unit 806, the update processing instruction groups 560 to 566 are inserted in appropriate locations.

The secret holding program generation unit 806 inserts the second branch instruction group generated by the management instruction group generation unit 805 into the selection-target data piece into which the m-th function provision instruction group (in other words, the function provision instruction group executed last in general use) has been inserted. The second branch instruction group is inserted so as to be positioned next after the updating processing instruction group. At this time, if a program instruction for processing to return control to the invoker program is included at the end of the m-th function provision instruction group, the secret holding program generation unit 806 either removes the program instruction or does not insert the second branch instruction group.

The secret holding program generation unit 806 inserts the first branch instruction group generated by the management instruction group generation unit 805 into other selection-target data pieces so as to be positioned after the update processing instruction group. As a result of the described operations, the secret holding program generation unit 806 generates the selection-target data pieces 540 to 546.

The secret holding program generation unit 806 arranges the instruction groups stored in the program storage unit 800, thereby generating the secret holding program 500. More specifically, the management instruction group generation unit 805 arranges the generated instruction groups in the order shown in FIG. 16.

3.4.8 Output Unit 807

The output unit 807 outputs the generated secret holding program to the secret processing apparatus 60.

3.4.9 Operations of Program Obfuscation Apparatus 50

(1) Outline of Operations

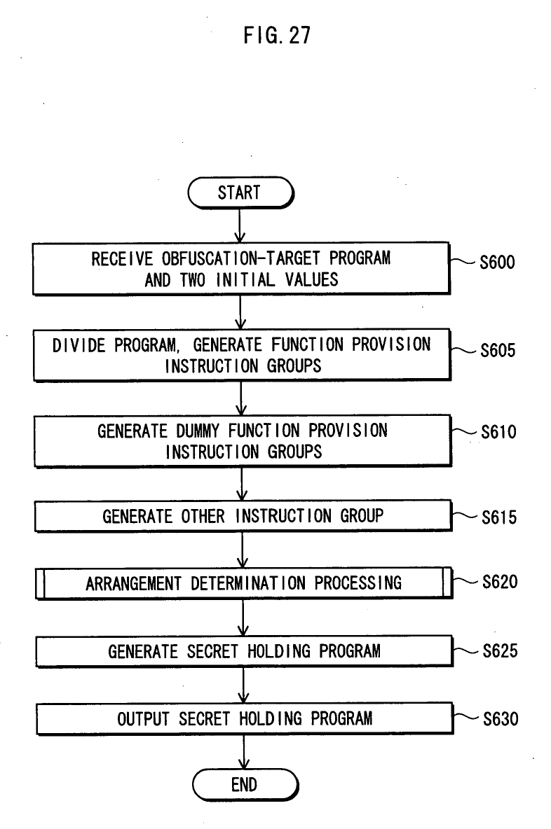

The following outlines operations of the program obfuscation apparatus 50 with use of the flowchart shown in FIG. 27.

The input unit 801 receives an obfuscation-target program and two initial values to be given to the generated secret holding program (step S600).

The function provision instruction group generation unit 802 divides the obfuscation-target program into a plurality of blocks, each of which consists of one or more program instructions (step S605).

The dummy function provision instruction group generation unit 803 generates a plurality of dummy function provision instruction groups based on the obfuscation-target program received by the input unit 801 (step S610).

The management instruction group generation unit 805 generates a first branch instruction group consisting of the preprocessing instruction group 510, the selection processing instruction group 520, the management information update instruction group 525, the transition processing instruction group 530, one update processing instruction group, and a program instruction group that shows that a branch destination is a selection processing instruction group; the second branch instruction group consisting of a program instruction group for processing to return control to a program invoker; and a plurality of selection-target data pieces, each containing only a label name (step S615). Note that the number of selection-target data pieces is equal to the total number of function provision instruction groups and dummy function provision instruction groups.

Using the selection parameter group and the pre-stored Expression 3, the arrangement order determination unit 804 determines where to arrange the function provision groups and the dummy function provision groups (steps S620).

Using the update processing instruction group generated by the management instruction group generation unit 805, the secret holding program generation unit 806 generates the update processing instruction groups 560 to 566 with respect to the selection-target. Data pieces. The secret holding program generation unit 806 generates the selection-target data pieces 540 to 546 with use of the first and second branch instruction groups. The secret holding program generation unit 806 arranges the generated instructions, thereby generating the secret holding program 500 (step S625).

The output unit 807 outputs the generated secret holding program to the secret processing apparatus 60 (step S630).

(2) Arrangement Determination Processing

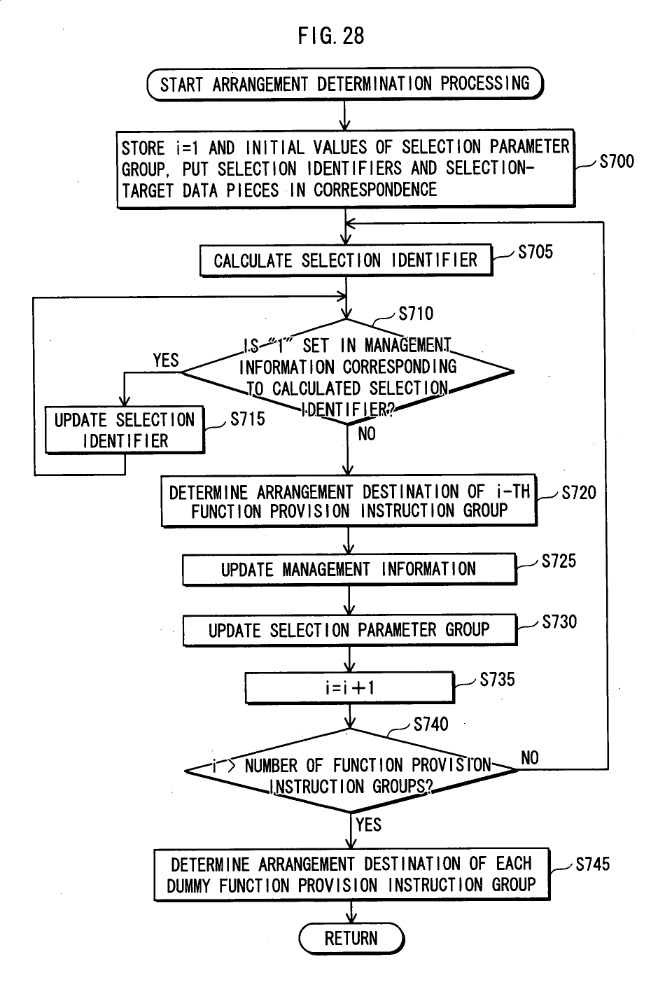

Referring to the flowchart shown in FIG. 28, the following outlines operations for arrangement determination processing shown at step S620 of FIG. 27.

The control unit 850 sets the count i to “1”, and stores the initial values of the selection parameter group in the parameter storage area. The control unit 850 puts each value of the selection identifier in correspondence with a selection-target data piece stored in the program storage unit 800 (step S700). The counter i expresses which number in the execution order the function provision instruction group is currently being focused on should be executed. In other words, here the control unit 850 determines the order of arrangement in order starting from the first function-provision group.

The selection processing unit 851 acquires the selection parameters CP_1 and CP_2 stored in the parameter storage area. Using the acquired CP_1 and CP_2 and the pre-stored Expression 3, the selection processing unit 851 calculates a provisional selection identifier (step S705). As one example, when the respective values of the selection parameters CP_1 and CP_2 are “1” and “2”, the value of Expression 3 will be “1×1+2×2 MOD 7=5”.

Using the management information table T800, the selection processing unit 851 judges whether or not the value of the management information piece corresponding to the calculated provisional selection identifier is “1” (step S710).

When it is judged that the value of the management information piece is “1” (“YES” at step S710), the selection processing unit 851 updates the provisional selection identifier (step S715), and returns to step S710. More specifically, when the calculated provisional selection identifier is “5” and the value of the management information piece corresponding to the value “5” is “1”, the selection processing unit 851 sets the provisional selection identifier to “6”, which is the closest value subsequent to “5”.

When it is judged that the value of the management information piece is not “1” (“NO” at step S710), the selection processing unit 851 sets the calculated provisional selection identifier as the selection identifier swVar, and, based on the selection identifier swVar acquired by the selection processing unit 851, the control unit 850 inserts the i-th function provision instruction group in the corresponding selection-target data piece (step S720). As one example, when cont=1 and the value of the selection identifier is “5”, the first function provision instruction group is arranged in the selection-target data piece 545.

The management information updating unit 852 updates, from “0” to “1”, the value of the one of the management information pieces in the management information table T800 that corresponds to the selection identifier swVar obtained by the selection processing unit 851 (step S725). As one example, when the value of the selection identifier is “5”, the management information updating unit 852 changes the management information piece corresponding to the selection-target data piece 545 in the management information table T800 of the selection information holding unit 854 from showing “unarranged” to “already arranged”.

The update processing unit 853 updates the selection parameters CP_1 and CP_2 using the selection parameter group stored in the parameter storage area and the selection identifier acquired by the selection processing unit 851, and writes the updated selection parameters to the parameter storage area in the control unit 850 (step S730). As one example, when the respective values of the selection parameters are “1” and “2” and the value of the selection identifier is “5”, the update processing unit 853 updates the respective values of the selection parameters to “2” and “5”.

The control unit 850 adds “1” to the value of the counter i (step S735).

The control unit 850 judges whether or not the value of the counter i is greater than the number of function provision instruction groups (step S740).

When it is judged that the value of the counter i is not greater (“NO” at step S740), the control unit 850 returns to step S705, and controls operations of the selection processing unit 851.

When it is judged that the value of the counter i is greater (“YES” at step S740), the control unit 850 determines where to arrange the dummy function provision instruction groups, such that each is arranged in a selection-target data piece that does not yet have a function provision group inserted therein (step S745). As one example, when the selection-target data pieces 540, 541, 542 and 544 have not yet been executed, the control unit 850 determines that the dummy function provision instruction groups are to be arranged in the selection-target data pieces 540, 541, 542 and 544, and inserts the dummy function provision groups in the selection-target data pieces as determined.

3.5 Conclusion

With the selection processing unit 722 of the secret processing apparatus 60 and the selection processing instruction group 520 of the secret holding program 500 in the third embodiment, only a selection-target data pieces that has not yet been executed can be determined as the next selection-target data piece to be selected. Therefore, even if a malicious analyzer whose knows that the secret processing apparatus 60 and the secret holding program 500 do not execute the same selection-target data piece twice performs an exhaustive search changing the initial values of the selection parameter group, no selection-target data piece will be selected twice, regardless of the initial values. This makes it difficult to perform analysis efficiently.

The program obfuscation apparatus 50 converts an obfuscation-target program into a secret holding program that is executed in the secret processing apparatus 60. Accordingly, even if a malicious analyzer who knows that no same program instruction group is executed twice performs an exhaustive search with respect to the converted program by changing the initial values of the selection parameter group, the analyzer will be unable to figure out the wrong values efficiently based on whether or not a same program instruction is executed twice. This achieves the effect of being able to convert an input program into a program that prevents malicious analysis from being performed efficiently in a short amount of time.

3.6 First Modification

Instead of the arrangement order determination unit 804, the program obfuscation apparatus 50 may have an arrangement order determination unit 804a (not illustrated) described below.

Other compositional elements are the same as described, and therefore a description thereof is omitted.

Note that in the present first modification, the program obfuscation apparatus 50 receives only the obfuscation-target program by way of the input unit 801.

3.6.1 Arrangement Order Determination Unit 804a

The difference between the arrangement order determination unit 804 and the arrangement order determination unit 804a is that the former uses a method that determines where to arrange the function provision instruction groups after setting the initial values of the selection parameters, whereas the latter first determines where to arrange the first to the p-th (p being the number of selection parameters) function provision instruction groups, sets the initial values of the selection parameter-use variables, and then determines where to arrange the (p+1)-th function provision instruction group and subsequent function provision instruction groups.

The arrangement order determination unit 804a is composed of a control unit 850a, a selection processing unit 851a, a management information updating unit 852a, an update processing unit 853a, and a management information holding unit 854a. The following describes the compositional elements of the arrangement order determination unit 804a.

(1) Management Information Holding Unit 854a

The management information holding unit 854a is the same as the management information holding unit 854, and therefore a description thereof is omitted here. Note that the management information table T800 is referred in the following description when necessary.

(2) Control Unit 850a

The control unit 850a stores p selection parameters in advance (in the present example, p is 2).

The control unit 850a has a parameter storage area for storing a selection-parameter group.

The control unit 850a puts each of the possible values of Expression 3, which is held by the selection processing unit 851a described later, in other words the values of the selection parameters that may be obtained according to Expression 3, in correspondence with selection-target data pieces stored in the program storage unit 800.

The control unit 850a sets at random the positions at which to arrange the first to p-th function provision instruction groups. For instance, the control unit 850a uses a random number to determine which of the selection-target data pieces 540 to 546 arrange the first function provision instruction group in, and then uses a random number to determine which of the selection-target data pieces, other than that in which the first function provision instruction group has been arranged, to arrange the second function provision instruction group in. The control unit 850a similarly uses random numbers to determine which of the selection-target data pieces in which a function provision instruction group has not yet been arranged to arrange each function provision group K in (K=3, . . . , m) in.

The control unit 850a updates the value of the management information pieces corresponding to each of the selection-target data pieces in which one of the first to p-th function provision groups has been arranged, from “0” to “1”. The control unit 850a calculates p initial values using the updated management information table 800, information relating to where each of first to p-th function provision instruction groups are arranged, and an expression for calculating a selection identifier. The control unit 850a notifies the calculated p initial values to a user by displaying them on a display unit (not illustrated).

The control unit 850a stores the calculated p initial values in the parameter storage area.

The control unit 850a controls the operations of the selection processing unit 851a, the management information updating unit 852a and the update processing unit 853a.

The control unit 850a inserts the i-th function provision instruction group into the corresponding selection-target data piece based on the selection identifier acquired by the selection processing unit 851a. Here, i is an integer that is no less than (p+1) and no greater than m, and m is the number of the function provision instruction groups. The control unit 850a also temporarily stores the correspondence between the i-th function provision instruction group and the selection-target data piece in which the i-th function provision instruction group is inserted. Note that the selection processing unit 851a is described below.

The control unit 850a inserts one of one generated dummy function provision instruction groups in each of one or more selection-target data pieces in which a function provision group has not been inserted. Here, a dummy function provision instruction group that has been inserted in one selection-target data piece is not inserted in any other selection-target data piece.

Specific Example of how Initial Values are Calculated

The following gives a specific example of how the initial values are calculated. In the present example, the selection parameter count p=2, and selection-target data pieces 540 to 546 and Expression 3 are used. Furthermore, the first function provision instruction group is arranged in the selection-data target piece 545, and the second function provision instruction group is arranged in the selection-target data piece 546.

The control unit 850a first acquires the selection parameter values CP_1 and CP_2 at the point in time that the processing of the selection-target data pieces 545 ends. The following describes the acquisition of the selection parameter values CP_1 and CP_2. Since the update processing instruction group 165 of the selection-target data piece 545 is “cp_1=cp_2; cp_2=sv;”, the value of the selection parameter CP_2 is assigned to the selection parameter CP_1 (corresponding to the variable cp_1 in the program). Furthermore, the value of the selection identifier (corresponding to the variable sv in the program) is assigned to the selection parameter CP_2. Note that at this point the selection identifier is the identifier of the selection-target data 545 (in other words, “5”) in which the first function provision instruction group is arranged. The selection identifier is subsequently re-calculated using the selection parameters to which a values have been assigned as described above. Summarizing up to here, the value of the first selection parameter becomes the initial value of the selection parameter CP_2, and the value of the second selection parameter becomes the identifier of the selection-target data piece in which the first function provision instruction is arranged. In the present first modification, since the location in which the second function provision instruction group is arranged is the selection-target data piece 546, the provisional selection identifier information calculated according to Expression 3 is “5” or “6”. This is because if the value of Expression 3 is “6”, the unexecuted selection-target data piece 546 is selected, and if the value of Expression 3 is “5”, instead of the already-selected selection-target data piece 545 being selected, the unexecuted selection target-data piece 546, which is directly after the already-selected selection-target data piece 545, is selected.

Here, for the value of Expression 3 to be “5”, it is necessary that “1×(selection parameter CP_1)+2×5 MOD 7=5”, and when this Expression 3 is solved, the value of the selection parameter CP_1 will be “2”. Similarly, for the value of Expression 3 to be “6”, it is necessary that “1×(selection parameter CP_1)+2×5 MOD 7=6”, and when this Expression 3 is solved, the value of the selection parameter CP_1 will be “3”. Generally, when p1 and NN are coprimes, Y that fulfills “p1×Y MOD NN=A” with respect to every natural number A will exist. This means that the value of the selection parameter CP_1 can be determined.

Accordingly, the initial value of the selection parameter CP_2 will be either “2” or “3”. The control unit 850a selects either “2” or “3” as the initial value of the selection parameter CP_2.

The description is continued based on the assumption that the control unit 850a has selected “2” as the initial value of the selection parameter CP_2.

The control unit 850a next determines the initial value of the selection parameter CP_1.

Since the selection-target data piece 545 in which the first function provision instruction group is arranged will be selected, it is necessary for the provisional selection identifier calculated according to Expression 3 to be “5”. Note that at this point, since all of the selection-target data pieces are as yet unexecuted, the value of the Expression cannot be any other value than “5”, which directly indicates the selection-target data piece 545. Accordingly, it is necessary that “1×(selection parameter CP_1)+2×(selection parameter CP_2) MOD 7=5”. Furthermore, the initial value of the selection parameter CP_2 is “2” as calculated earlier, and when the management information update instruction group 125 is first executed, the value of the selection parameter CP_2 is the initial value. When this value is assigned to Expression 3, the result is “1×(first selection parameter CP_1)+2×2 MOD 7=5”. When this Expression 3 is solved, the selection parameter takes a value “1”. At this point, the value of the selection parameter CP_1 remains as the initial value, and therefore the initial value of the selection parameter CP_1 is “1”.

As a result of these described operations, the initial values “1” and “2” of the first and second selection parameters are calculated.

(3) Selection Processing Unit 851a

The selection processing unit 851a is the same as the selection processing unit 851, and therefore a description thereof is omitted here.

(4) Management Information Updating Unit 852a

The management information updating unit 852a is the same as the management information updating unit 852, and therefore a description thereof is omitted here.

(5) Update Processing Unit 853a

The update processing unit 853a is the same as the update processing unit 853, therefore a description thereof is omitted here.

3.6.2 Operations of Program Obfuscation Apparatus in First Modification

(1) Outline of Operations

The program obfuscation apparatus of the first modification generates a secret holding program according to the operations that additionally include initial value calculation processing between step S615 in FIG. 27 and the arrangement determination processing (step S620).

(2) Initial Value Calculation Processing

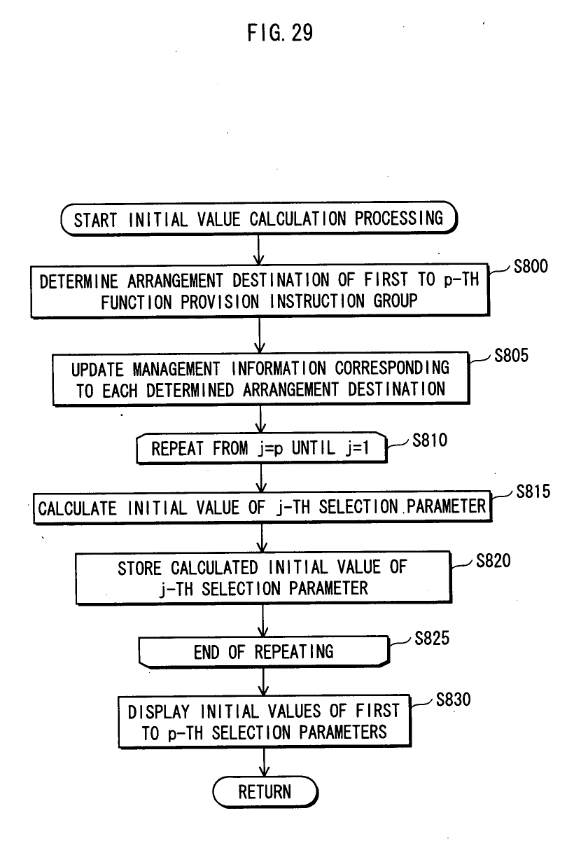

The flowchart shown in FIG. 29 is used to describe operations for initial value calculation processing.

The control unit 850a sets, at random, locations where the first to p-th function provision instruction groups are to be arranged (step S800).

The control unit 850a updates the value of the management information pieces corresponding to each of the selection-target data pieces in which one of the first to p-th function provision groups has been arranged, from “0” to “1” (step S805).

The control unit 850a repeats steps S815 to S825 from j=p through to j=1 (step S810).

The control unit 850a calculates the initial value of the j-th selection parameter (step S815), and stores the calculated initial value of the j-th selection parameter to the parameter storage area (step S820).

When the repeating has ended, the control unit 850a displays the calculated initial values of the first to p-th selection parameters (step S830).

3.6.2 Effects of First Modification

The program obfuscation apparatus of the first modification is able to convert an obfuscation-target program to a secret holding program such as shown in the first embodiment. Accordingly, even if a malicious analyzer who knows that no same program instruction group is executed more than once performs an exhaustive search with respect to the converted program by changing the initial values of the selection parameter group, the analyzer will be unable to figure out the wrong values efficiently based on whether or not a same program instruction is executed more than once. This achieves the effect of being able to convert an input program into a program that prevents malicious analysis from being performed efficiently in a short amount of time.

Note that the program obfuscation apparatus of the present first modification, after determining where to arrange the first to p-th function provision instruction groups, performs arrangement determination processing to again determine where to arrange the first to p-th function provision instruction groups. In this case, the initial values of the selection parameters are calculated such that a selection identifier showing a predetermined location is calculated, and therefore the locations of the first to p-th function provision instruction groups determined in the arrangement determination processing will be the same as the predetermined locations.

Here, it is not necessary for the program obfuscation apparatus of the first modification to perform arrangement determination processing to again determine where to arrange the first to p-th function provision instruction groups after first determining where to arrange the first to p-th function provision instruction groups. In this case, after successively executing the first to p-th function provision instruction groups, the control unit 850a calculates the values of the selection parameters, stores the calculated values in the parameter storage area, and controls the selection processing unit 851, the management information updating unit 852, and the update processing unit 853 to perform the subsequent operations. At this time, when executing the arrangement determination processing shown in FIG. 28, step S600 is changed to be i=p+1. This enables the program obfuscation apparatus to omit the arrangement determination processing for the first to p-th function provision instruction group for which the location is already determined, and to determine the location of the (p+1)-th function provision instruction group onwards in the arrangement determination processing.

3.7 Second Modification

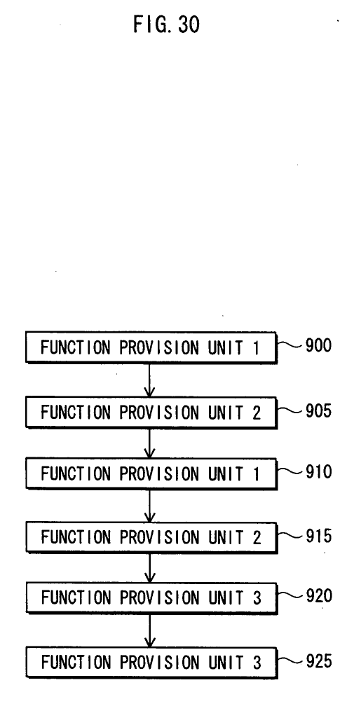

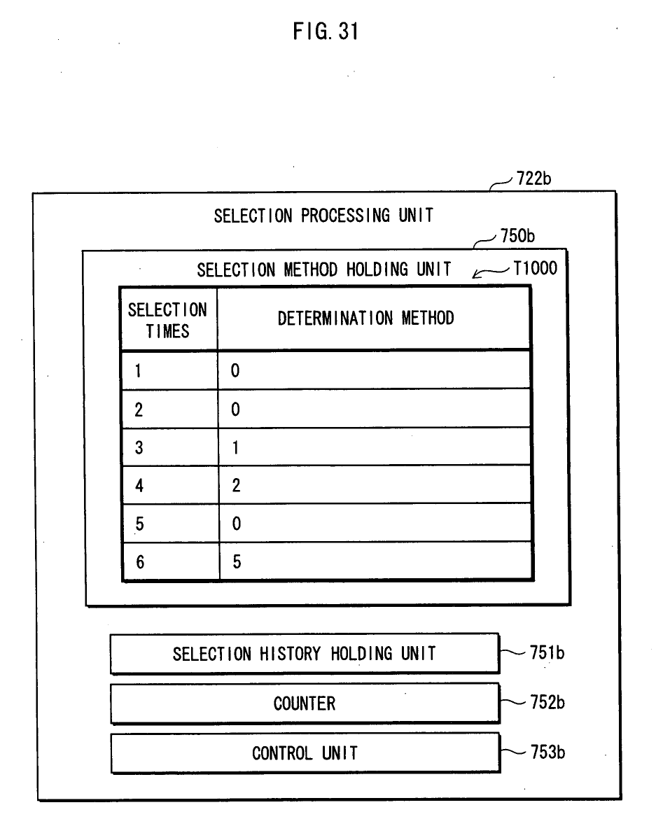

In the second modification, a description is given of a secret processing apparatus that executes the function provision instruction groups 1 to 3 in the order shown in FIG. 30. In other words, this secret processing apparatus may execute the procedure for a same selection-target data piece more than once in general use. The secret processing apparatus of the second modification is realized by substituting the selection processing unit 722 of the third embodiment with a selection processing unit 722b shown in FIG. 31.

3.7.1 Selection Processing Unit 722b

The selection processing unit 722b has a counter that counts the number of times that a selection-target data piece has been selected, and in accordance with the value of the counter, changes the method used to determine the selection identifier.

In the following, “first determination method” denotes a method used to determine the selection identifier that is the same as in the third embodiment, in other words, a determination method that updates the selection identifier until the selection identifier shows an unexecuted selection-target data piece. Furthermore, “second determination method” denotes a determination method that sets the value of the selection identifier to the same value of the selection identifier determined an A-th time (B=1, 2, . . . 6).

As shown in FIG. 31, the selection processing unit 722b is composed of a determination method holding unit 750b, a selection history holding unit 751b, a counter 752b, and a control unit 753b.

(1) Determination Method Holding Unit 750B

As shown in FIG. 31, the determination method holding unit 759b has a determination method table T1000.

The determination method table T1000 has an area for storing at least one set of a selection count and a determination method.

The selection count shows numbers of times selection-target data has been selected, and the determination method shows a selection identifier determination method for each selection count.

When the determination method is set to a value “0”, this shows that the determination method used to determine the selection identifier is the first determination method, and when the determination method is set to a value “A”, which is a value other than “0”, this shows that the determination method used to determine the selection identifier is the second determination method. The set value being the value “A” shows that a same selection identifier as the value selected the A-th time is acquired.

As one example, when the set of the selection count and the determination method is “1, 0”, this expresses that the identifier of the selection-target data piece selected the first time is to be determined using the first determination method. Furthermore, when the set of the selection count and the determination method is “3, 1”, this expresses that the selection identifier of the selection-target data piece selected the third time is determined using the second determination method, and that this selection identifier is to be set to the same value as the value determined the first time.

(2) Selection History Holding Unit 751B

The selection history holding unit 751b holds one or more selection identifiers determined in the past and, in correspondence therewith, the value of the counter at the point in time at which each selection identifier was determined.

(3) Counter 752b

The counter 752b counts which number selection the selection-target data piece selection that is about to be performed is. The initial value of the counter 752a is “1”, and is incremented each time a selection is performed.

(4) Control Unit 753b

The control unit 753b determines a selection identifier determination method with use of the value of the counter 752b and the determination method table T1000. More specifically, when the value of the counter 752b is “1”, the control unit 753 acquires the selection method “0”, which corresponds to the selection times “1” in the determination method table T1000. Since the acquired determination method is “0”, the control unit 753b determines that the selection identifier determination method to be used is the first determination method. Note that when the value of the acquired determination method is a value other than “0”, the control unit 753b determines that the selection identifier determination method to be used is the second determination method.

When the determined determination method is the first determination method, the control unit 753b selects a selection identifier according to processing the same as when the selection processing instruction group 520 is executed.

When the determined determination method is the second determination method, the control unit 753b uses the acquired value “A” to acquire the selection identifier that was determined the A-th time from the selection history holding unit 751b.

The control unit 753b stores the value shown by the counter 752b and the determined selection identifier to the selection history holding unit 751b, and then increments the value of the counter 1340 by “1”.

3.7.2 Operations of the Secret Processing Apparatus

Operations of the secret processing apparatus in the second modification are step S500 shown in FIG. 24 with the addition of processing to set the count of the counter 752b to an initial value of “1”.

Identification calculation processing shown below is then performed, and is followed by step S520 onwards. When the judgment at step S535 is “YES”, the processing ends. When the judgment at step S535 is “NO”, the processing returns to the identifier calculation processing.

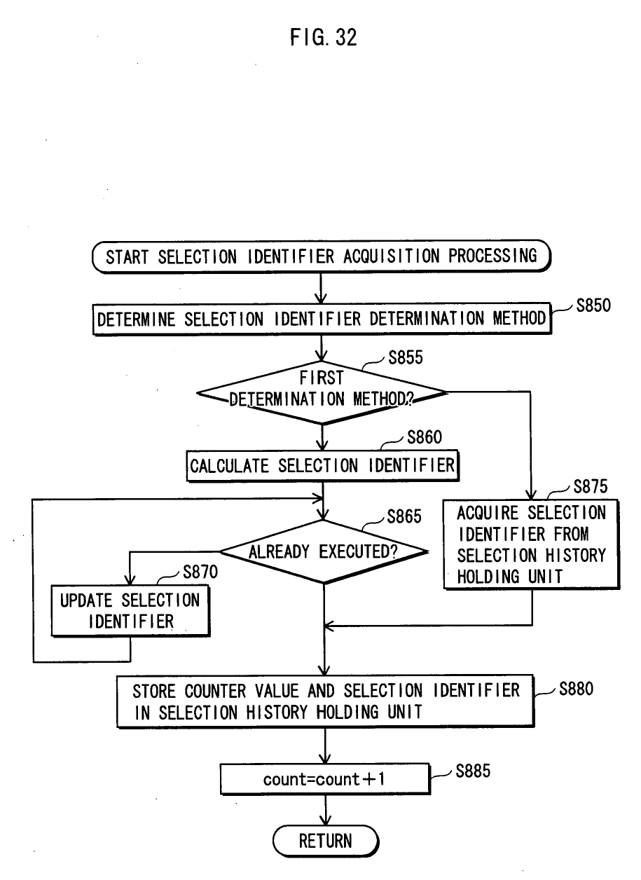

The following describes operations for identifier calculation processing with use of the flowchart shown in FIG. 32.

Note that present explanation is based on the assumption that the number of selection parameters is two, and the expression used to calculate the selection identifier is Expression 3. Furthermore, the compositional elements of the third embodiment are referred to when necessary.

The control unit 753b determines the selection identifier determination method using the value of the counter 752b and the determination method table T1000 (step S850).

The control unit 753b judges whether or not the determined determination method is the first determination method (step S855).

When it is judged that the determined determination method is the first determination method (“YES” at step S855), the control unit 753b calculates a provisional selection identifier using the selection parameters CP_1 and CP_2 stored in the selection parameter holding unit 705, and Expression 3 in the selection processing instruction group (step S860).

Using the management information table T700, the control unit 753b judges whether or not the selection-target data piece corresponding to the calculated provisional selection identifier has already been executed (step S865).

When it is judged that the selection-target data piece corresponding to the calculated provisional selection identifier has already been executed (“YES” at step S865), the control unit 753b updates the provisional selection identifier (step 8870).

When it is judged that the selection-target data piece corresponding to the calculated provisional selection identifier has not yet been executed (“NO” at step S865), the control unit 753b stores the value shown by the counter 752b and the determined selection identifier to the selection history holding unit 751b (step. S880), and increments the value count of the counter 1340 by one (step S885).

When it is judged that the determined determination method is the second determination method (“NO” at step S855), the control unit 753b acquires the selection identifier determined the A-th time from the selection history holding unit 751b, using the value “A” of the determination method acquired from the determination method table T1000 (step S875), and performs the processing of step S880 onwards.

3.7.3 Effects of Second Modification

With the determination method table T1000 shown in FIG. 31, the selection processing unit 722b of the second modification selects one of already-selected selection-target data pieces when selecting a selection-target data piece to execute third, fourth or sixth. Accordingly, even if a malicious analyzer who knows that the obfuscation-target program may execute a same selection-target data piece more than once performs an exhaustive search with respect to the converted program by changing the initial values of the selection parameter group, the analyzer will be unable to figure out the wrong values efficiently based on a same selection-target data piece being executed more than once, regardless of the initial values that are assigned. This achieves the effect of being able to convert an input program into a program that prevents malicious analysis from being performed efficiently in a short amount of time.

3.8 Third Modification

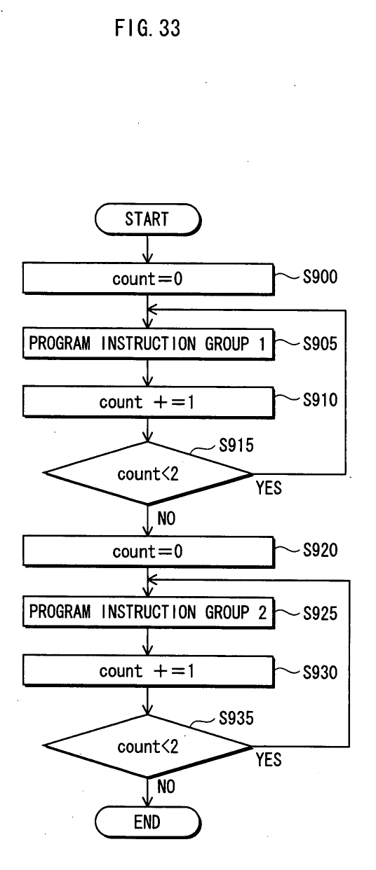

The third modification is a program obfuscation apparatus 50c that generates a secret holding program from an obfuscation-target program that has a loop in which a program instruction group is executed a fixed number of times. As one example, the control flow of the obfuscation-target program in the third modification is shown in FIG. 33. This program has a loop structure in two places, and the program instructions in the respective loops are executed twice each.

A description of the obfuscation-target program shown in FIG. 33.

3.8.1 Program obfuscation Apparatus 50c

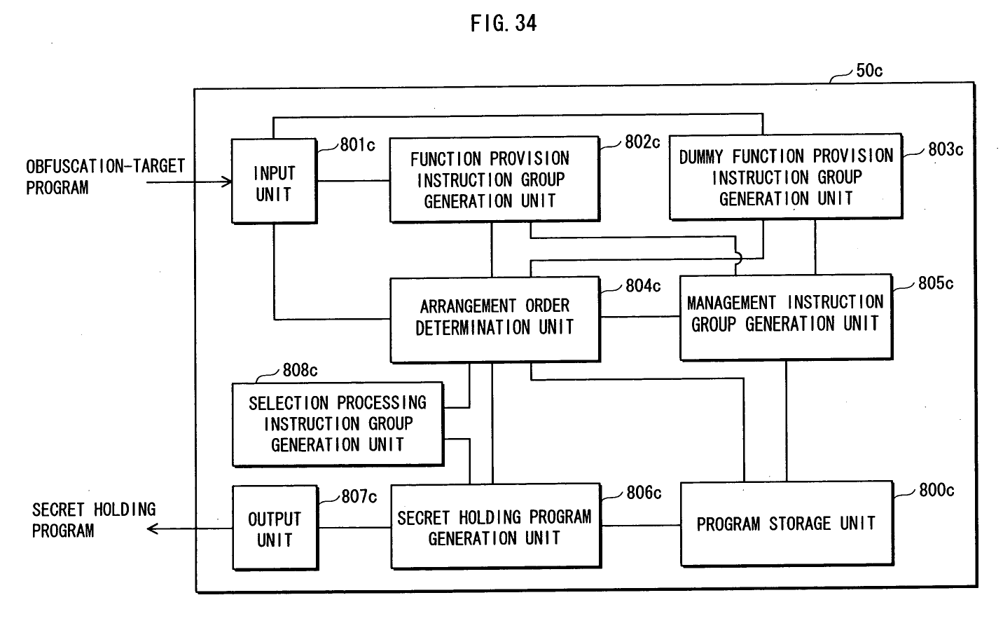

As shown in FIG. 34, the program obfuscation apparatus 50c is composed of a program storage unit 800c, an input unit 801c, a function provision instruction group generation unit 802c, a dummy function provision instruction generation group 803c, an arrangement order determination unit 804c, a management instruction group generation unit 805c, a secret holding program generation unit 806c, an output unit 807, and a selection processing instruction group generation unit 808c.

The program obfuscation apparatus 50c is, specifically, a computer system composed of a microprocessor, a ROM, a RAM, a hard disk unit, a display unit, a keyboard, a mouse, and the like. A computer program is stored in the RAM or the hard disk unit. Here, the computer program is a combination of instruction codes showing instructions for a computer for achieving predetermined functions. The program obfuscation apparatus 50c achieves its functions by the microprocessor operating in accordance with the computer program. In other words, the microprocessor reads the instruction in the computer program one instruction at a time, decodes the read instruction, and operates in accordance with the result of decoding.

Note that in the present example, it is assumed that the program obfuscation apparatus 50c acquires three function provision instruction groups from the obfuscation-target program. Furthermore, the structure of the secret holding program generated by the program obfuscation apparatus 50c is assumed to be the same as the secret holding program 500. The numerical references used in the description of the secret holding program 500 are used in the following description as necessary.

(1) Program Storage Unit 800c

The program storage unit 800c is the same as the program storage unit 800 shown in the third embodiment, and therefore a description thereof is omitted.

(2) Input Unit 801c

The input unit 801c is the same as the input unit 801 shown in the third embodiment, and therefore a description thereof is omitted.

Note that the obfuscation-target program received by the input unit 801c has one or more loops, and the number of times that a program instruction group in each loop is executed is set in advance.

(3) Function Provision Instruction Group Generation Unit 802c

The function provision instruction generation unit 802c generates a plurality of function provision instruction groups from the obfuscation-target program received by the input unit 801c.

Upon the input unit 801c receiving the obfuscation-target program shown in FIG. 33, the function provision instruction group generation unit 802c performs the same operations as the function provision instruction group generation unit 802, with respect to each of the two program instruction groups in the loops (in the present example, the program instruction group 1 executed at step S905 and the program instruction group 2 executed at step S925). This results in a plurality of function provision instruction groups being generated. Here, the function provision instruction group generation unit 802c divides the program instruction group 1 to generate two function provision instruction groups (hereinafter referred to as function provision instruction groups 1 and 2), and generates one function provision instruction group from the program instruction group 2 (hereinafter referred to as function provision instruction group 3).

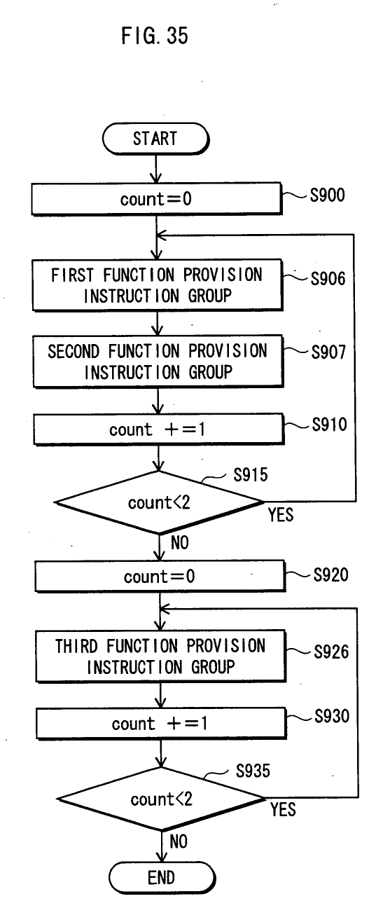

FIG. 35 shows the control flow shown in FIG. 33 when the three generated function provision instruction groups have been substituted therein.

The program instruction group 1 executed at step S905 is replaced by the function provision instruction group 1 executed at step S906 and the function provision instruction group 2 executed at step S907, and the program instruction group 2 executed at step S925 is replaced by the function provision instruction group 3 executed at step S926. Note that the function provision instruction group 2 and the function provision instruction group 3 are identical.

(4) Dummy Function Provision Instruction Group Generation Unit 803c

The dummy function provision instruction group generation unit 803c is the same as the dummy function provision instruction group generation unit 803, and therefore a description thereof is omitted.

(5) Selection Processing Instruction Group Generation Unit 808c

The selection processing instruction group generation unit 808c generates a program instruction group that realizes, in a computer or the like, the selection processing unit 722b shown in the second modification.

The selection processing instruction group generation unit 808c first generates the determination method table T1000 held by the determination method holding unit 750b.

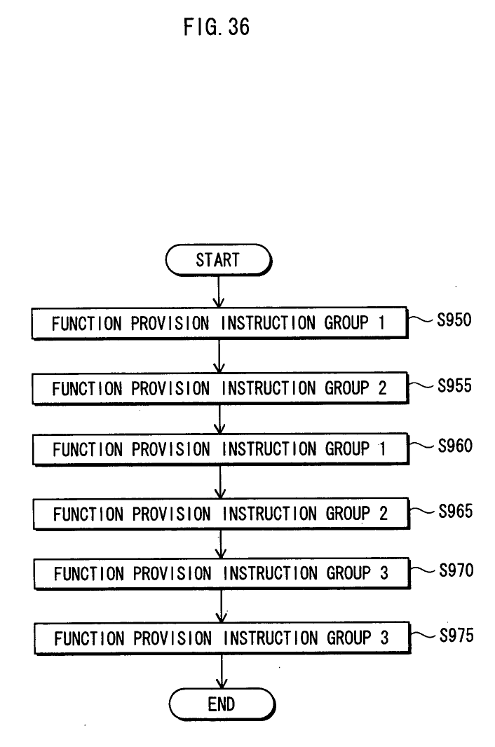

From the control flow shown in FIG. 35, the selection processing instruction generation unit 808c generates control flow of a program in which the loops have been expanded. More specifically, in FIG. 35 the first and second function provision instruction groups, which are the program instructions in a loop, are expanded the number of times that the loop is executed, in other words, twice. Similarly, the third function provision instruction group is also expanded twice. FIG. 36 shows the control flow of a program in which the function provision instruction groups have been expanded.

Next, based on the control flow of the program in which the loops have been expanded, the selection processing instruction group generation unit 808c generates determination methods to be held in the determination method holding unit 750b.

In the control flow in FIG. 36, steps S950 to S975 are the blocks executed first to sixth, respectively. The function provision instruction group 1 executed third in this control flow is identical to the function provision instruction group 1 executed first in this control flow. Accordingly, the selection processing instruction group generation unit 808c sets the value “1” in the determination method corresponding to the selection count “3” in the determination method table T1000. Similarly, the selection processing instruction group generation unit 808c sets the values “2” and “5” in the determination methods corresponding to the selection counts “4” and “6”, respectively, in the determination method table T1000.

Although not existent in the control flow shown in FIG. 36, the selection identifier determination method used when selecting a block that appears only once in the control flow even after the loops have been expanded is a determination method that selects from as-yet unarranged selection-target data.

In this way, the selection processing instruction group generation unit 808c generates the determination method table T1000 held by the determination method holding unit 750b. More specifically, the selection processing instruction group generation unit 808c generates a program instruction group that causes a computer to hold the data structure of the determination method table T1000. Accordingly, the determination method table T1000 is realized such that the determination method table T1000 holds the set of “e, 0” in the case of the e-th selection identifier using a determination method that determinates a selection identifier showing an as-yet unexecuted selection-target data piece, and holds the set of “e, f” in the case of the e-th selection identifier being the same as the f-th determined selection identifier.

Furthermore, the selection processing instruction group generation unit 808c further generates program instruction groups that realize the selection history holding unit 751b, the counter 752b and the control unit 753b on a computer. Here, the program instruction group for realizing the selection history holding unit 751b is a program instruction group that stores one or more selection identifiers in correspondence with respective counter values. The program instruction group for realizing the counter 752b is an instruction group that represents a counter that has an initial value of “1” and is incremented by “1” at a time. Furthermore, the program instruction group that realizes the control unit 753b is a program instruction group that realizes the operations described in the second modification. In the following, the instruction group representing the counter and the instruction group that realizes the control unit 753b are referred to collectively as the determination method control instruction group.

Accordingly, the selection processing instruction group generation unit 808c is able to generate program instruction groups for causing the selection processing unit 722b to operate. The selection processing instruction group generation unit 808c stores the generated instruction groups in the program instruction unit 800c.

(6) Arrangement Order Determination Unit 804c

The arrangement order determination unit 804c determines the order in which to allocate the generated function provision instruction groups (three function provision instruction groups in the present example) and dummy function provision instruction groups (four dummy function provision instruction groups in the present example) to the selection-target main instruction groups 550 to 556. More specifically, the arrangement order determination unit 804c first determines which of the selection-target main instruction groups to arrange the first to third function provision instruction groups in, and determines which of the remaining four selection-target main instruction groups to arrange the dummy function provision instruction groups in.

The arrangement order determination unit 804c stores Expression 3 in advance. In the present example, p1, p2 and NN in Expression 3 are “1”, “2” and “7”, respectively.

The arrangement order determination unit 804c determines the selection-target main instruction groups in which the function provision instruction groups and the dummy function provision instruction groups are to be arranged, by checking what order selection identifiers are actually calculated in, using the two initial values of the selection parameters received by the input unit 801c and the pre-stored Expression 3.

Note that it is assumed here that the selection parameters CP_1 (=1) and CP_2 (=2) are received here by the input unit 801c as the two initial values. The following describes an example of how the arrangement is determined.

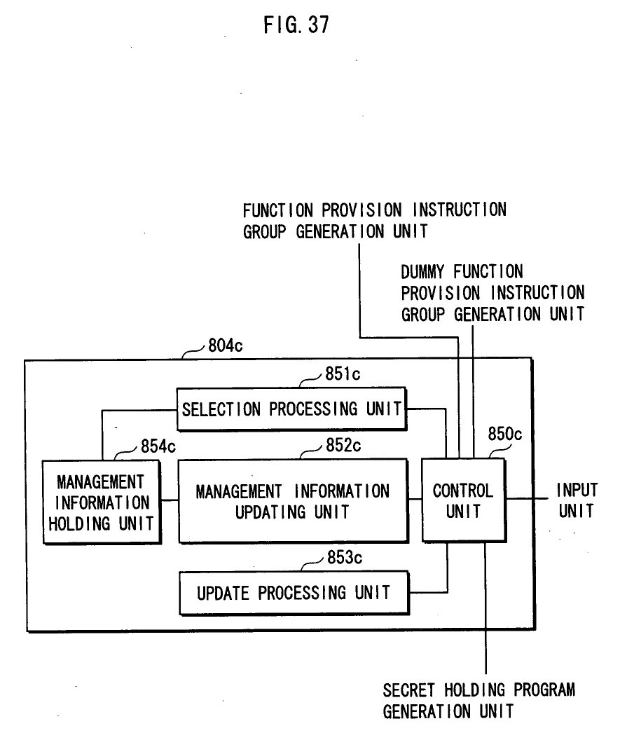

As shown in FIG. 37, the arrangement order determination unit 804c is composed of a control unit 850c, a selection processing unit 851c, a management information updating unit 852c, an update processing unit 853c, and a management information holding unit 854c. The following describes the compositional elements of the arrangement order determination unit 804c.

Management Information Holding Unit 854c

The management information holding unit 854c is the same as the management information holding unit 854, and therefore a description thereof is omitted. Note that the management information table T800 is referred to in the following description when necessary.

The management information holding unit 854c enables the locations where the function provision instruction groups are arranged (the selection-target data piece in which each function provision instruction group is arranged) to be stored.

Control Unit 850c

The control unit 850c has a parameter storage area for storing a selection parameter group.

The control unit 850c stores the initial values CP_1 and CP_2 (here, “1” and “2”, respectively) of the selection parameters received by the input unit 801, in the parameter storage area.

The control unit 850c controls operations of the selection processing unit 851c, the management information updating unit 852c, and the update processing unit 853c.

The control unit 850c puts each of the possible values of Expression 3 in the selection processing unit 851c described later, in other words each of the possible values of selection identifier according to Expression 3, in correspondence with the respective selection-target data pieces stored in the program storage unit 800c.

The control unit 850c acquires the i-th generated function provision instruction group from the function provision instruction group generation unit 802c. Based on the selection identifier acquired by the selection processing unit 851c, the control unit 850c inserts the acquired i-th function provision instruction group in the corresponding selection-target data piece stored in the program storage unit 800c. Here, i is an integer that is no less than 1 and no greater than m. The control unit 850c also temporarily stores the correspondence between i-th function provision instruction group and the selection-target data piece in which the i-th function provision instruction group is inserted.

The control unit 850c acquires one dummy function provision instruction group that has not been inserted into a selection-target data piece, from the dummy function provision instruction group generation unit 803c. The control unit 850c inserts the acquired dummy function provision instruction group into a selection-target data piece into which an i-th function provision instruction group or a dummy function provision instruction group has not been inserted. The control unit 850c performs these operations with respect to all dummy function provision instruction groups.

As a result of these operations, the control unit 850c inserts an i-th function provision instruction group or a dummy function provision instruction group into each selection-target data piece.

A function provision instruction group that is an arrangement target is acquired according to the operations by the control unit 850c for acquiring an i-th function provision instruction group.

Selection Processing Unit 851c

The selection processing unit 851c stores Expression 3 in advance.

The selection processing unit 851c determines where to arrange each of the function provision instruction groups, based on the control flow shown in FIG. 36 and the program instruction group generated by the selection processing instruction group generation unit 808c for causing the selection processing unit 722b to operate.

The selection processing unit 851c acquires the i-th function provision instruction group executed the t-th time according to the control flow shown in FIG. 36. Here, t is an integer no less than 1 and no greater than 6, and i is an integer no less than 1 and no greater than 3.

The selection processing unit 851c acquires the determination method corresponding to the selection times “t”, using the determination method table T1000 generated by the selection processing instruction group generation unit 808c.

When the determination method is “0”, the selection processing unit 851c acquires the selection identifier swVar according to the same operations as the selection processing unit 851. The selection processing unit 851c puts the acquired selection identifier swVar and the i-th function provision instruction group in correspondence. As a result, the control unit 850c inserts the i-th function provision instruction group in the selection-target data piece shown by the corresponding selection identifier swVar.

When the determination method has a value other than “0”, the selection processing, unit 851c acquires the j-th function provision instruction group executed the (t+1)-th time, and performs the described operations.

As a result of the operations by the selection processing unit 851c and the operations by the control unit 850c for inserting the i-th function provision instruction group into a selection-target data piece based on the selection identifier acquired by the selection processing unit 851c, function provision instruction groups are arranged in appropriate locations.

Management Information Updating Unit 852c

The management information updating unit 852c is the same as the management information updating unit 852, and therefore a description thereof is omitted.

Update Processing Unit 853c

The update processing unit 853c is the same as the update processing unit 853, and therefore a description thereof is omitted.

(7) Management Instruction Generation Unit 805c

The management instruction generation unit 805c is the same as the management instruction generation unit 805, and therefore a description thereof is omitted.

(8) Secret Holding Program Generation Unit 806c

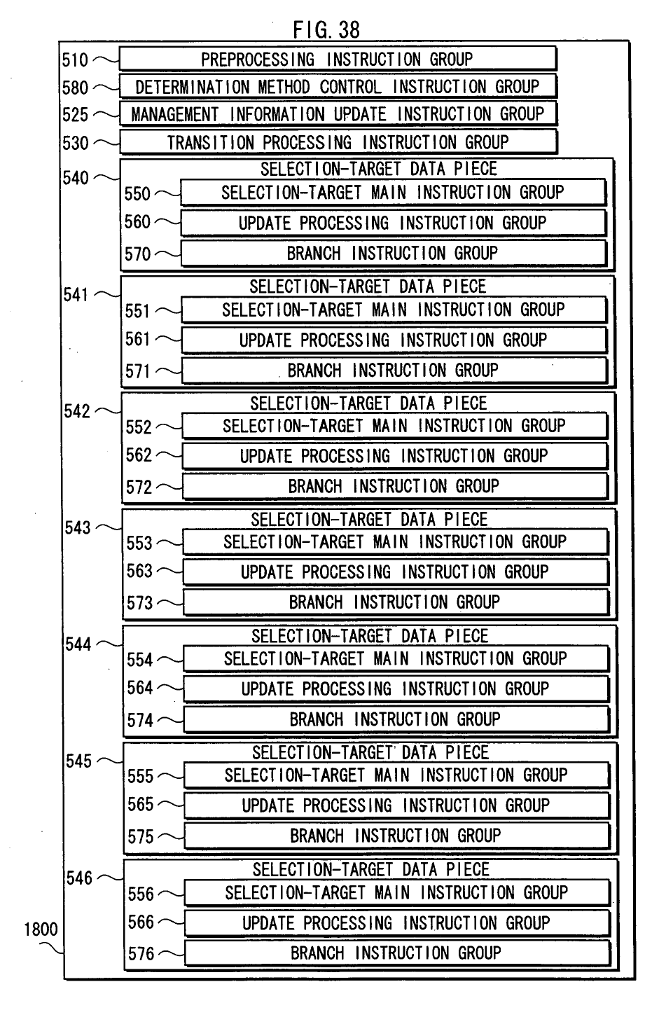

The secret holding program generation unit 806c arranges the instruction groups stored in the program storage unit 800c, thereby generating the secret holding program. More specifically, the secret holding program generation unit 806c arranges the instruction groups generated by the selection processing instruction group generation unit 808c and the selection-target data pieces generated by the arrangement order determination unit 804c, in the order shown in FIG. 38, thereby generating a secret holding program 1800. According to the operations by the management instruction group generation unit 805c for generating the update processing instruction group and the above-described operations by the secret holding program generation unit 806c, the instruction groups are inserted in appropriate locations.

Note that although no particular disclosure is made with regard to the arrangement of instruction groups other than the determination method control instruction group 580 by generated selection processing instruction group generation unit 808c, the instruction group may, for instance, be included in the preprocessing instruction group 510 in order to reserve necessary areas when execution commences, or in order to generate the determination method holding unit 750b.

Furthermore, the secret holding program generation unit 806c arranges the function provision instruction groups generated by the function provision instruction group generation unit 802c and the dummy function provision instruction groups generated by the dummy function provision instruction group generation unit 803c with respect to the selection-target main instruction groups 550 to 556 in a manner that corresponds to the order determined by the arrangement order determination unit 804c.

(9) Output Unit 807c

The output unit 807c is the same as the output unit 807, and therefore a description thereof is omitted.

3.8.2 Operations of Program Obfuscation Apparatus 50c

The following describes operations of the program obfuscation apparatus 50c.

The operations of the program obfuscation apparatus 50c are basically the same as the operations of the program obfuscation apparatus 50. Referring to the flowchart shown in FIG. 27, the following description focuses on aspects that differ from the operations of the program obfuscation apparatus 50.

Step S620 is realized by the arrangement order determination unit 804c.

Furthermore, a step for the selection processing instruction generation unit 808c to operate is added to the flowchart shown in FIG. 27. The step for causing the selection processing instruction group generation unit 808c to operate may come anywhere before the arrangement order determination unit 804c determines the arrangement order, in order words, anywhere before step S620.

3.8.3 Effects of the Third Modification

The program obfuscation apparatus 50c of the third modification converts an obfuscation-target program into a secret holding program such as shown in the third embodiments. Since, unlike the program obfuscation apparatus 50 of the third embodiment, the program obfuscation apparatus 50c of the third modification is capable of obfuscating a program that has loops, the program obfuscation apparatus 50c is able to obfuscate a larger variety of input programs.

3.9 Fourth Modification

The program obfuscation apparatus shown in the fourth modification performs the obfuscation of the program obfuscation apparatus of the third embodiment, and also additionally performs obfuscation by replacing a program instruction that includes a constant, with a program instruction that does not include the constant.

3.9.1 Program Obfuscation Apparatus of the Fourth modification

The program obfuscation apparatus replaces a first constant included in a program instruction group in a function provision group with “(first selection parameter)+(second selection parameter)+(second constant)”. For example, if a program instruction “b=a+30” is included in a function provision instruction group 1, the respective values of the first and second selection parameters when the function provision instruction group 1 is executed are “1” and “2”, “b=a+30” is replaced by “b=a+(selection parameter CP_1)+(selection parameter CP_2)+27”.

The following describes the program obfuscation apparatus that performs this kind of conversion.

In the fourth modification, an arrangement order determination unit 804d (not illustrated) is used instead of the arrangement order determination unit 804 in the third embodiment. The arrangement order determination unit 804d has a program instruction changing unit 810d in addition to the compositional elements described in the third embodiment.

The program instruction changing unit 810d performs processing to replace a constant in an input program as described above with “(first selection parameter)+(second selection parameter)+(second constant)”. More specifically, the program instruction change unit 810d acquires the first and second selection parameters stored in the parameter storage area, when a program instruction that includes a constant is included in a function provision instruction group currently being targeted by the arrangement order determination unit 804d. The program instruction changing unit 810d performs processing to replace the constant with “(first selection-parameter)+(second selection parameter)+(second constant) with use of the acquired first and second selection parameters.

Here, the second constant is calculated by subtracting the value of each of the first and the second selection parameters from the first constant.

3.9.2 Operations

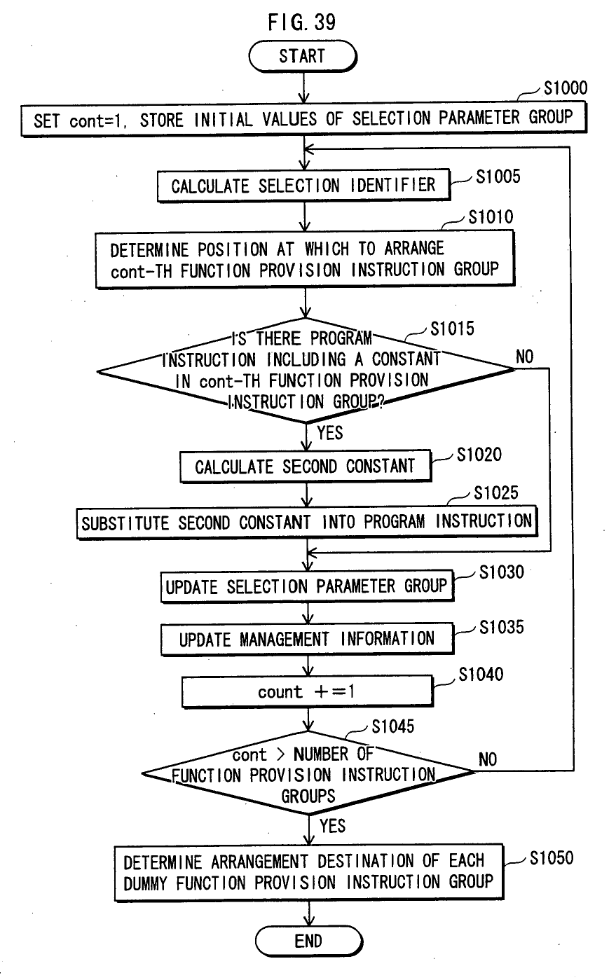

The following describes the operations of the program obfuscation apparatus of the fourth modification with use of FIG. 39, focusing mainly on the flow of processing by the arrangement order determination unit 804d. Note that the operations of the program obfuscation apparatus of modification 4 are the same as those in the third embodiment, with the exception of the operations of the arrangement order determination unit 804d.

The arrangement order determination unit 804d sets the counter count to “1”, and stores the initial values of the selection parameter group in the parameter storage area (step S1000).

The arrangement order determination unit 804d acquires the selection parameters CP_1 and CP_2 stored in the parameter storage area, and calculates a provisional selection identifier using the acquired selection parameters and the pre-stored Expression 3 (step S1005).

The arrangement order determination unit 804d determines where to arrange the (count)-th function provision instruction group (step S1010). More specifically, the arrangement order determination unit 804d performs steps S710, S715 and S720 shown in FIG. 28.

The arrangement order determination unit 804d judges whether or not a program instruction that includes a constant exists in the (count)-th function provision instruction group (step S1015).

When such a program instruction is judged to exist (“YES” at step S1015), the arrangement order determination unit 804d acquires the program instruction that includes the constant, and calculates a second constant with use of the constant in the acquired program instruction and the first and second selection parameters stored in the parameter storage area (step S1020). The arrangement order determination unit 804d replaces the constant included in the acquired program instruction with the first and second selection parameters and the calculated second constant (step S1025). For example, the arrangement order determination unit 804b replaces “b=a+30” with “b=a+(selection parameter 1)+(second selection parameter 2)+27”. Note that the arrangement order determination unit 804d performs the operations of steps S1020 and S1025 with respect to all program instructions in the (count)-th function provision instruction group that include a constant.

The arrangement order determination unit 804d performs updating of the selection parameters CP_1 and CP_2 using the selection parameter group stored in the parameter storage area and the selection identifier acquired by the selection processing unit 851, and overwrites the selection parameter group in the parameter storage area with the updated selection parameter group (step S1030). The arrangement order determination unit 804d updates the value of the one of the management information pieces that corresponds to the acquired selection identifier swVar in the management information table T800 from “0” to “1” (step S1035).

The arrangement order determination unit 804d adds a value “1” to the counter count (step S1040).

The arrangement order determination unit 804d judges whether or not the counter count is greater than the number of function provision instruction groups (step S1045).

When it is judged that the counter count is not greater than the number of function provision instruction groups (“NO” at step S1045), the arrangement order determination unit 804d returns to step S1005.

When it is judged that the counter count is greater than the number of function provision instruction groups (“YES” at step S1045), the arrangement order determination unit 804d determines where to arrange each of function provision instruction groups, such that each of one or more selection-target data pieces in which a function provision instruction group has not been inserted is set as a location (step S1050).

When it is judged that a program instruction that includes a constant does not, exist in the (count)-th function provision instruction group (“NO” at step S1015), the arrangement order determination unit 804d performs steps S1030 onwards.

Note that although the replacement expression “(selection parameter 1)+(selection parameter 2)+(second constant)” is used to replace the constant, another expression may be used instead. In such a case, an expression that finds the second constant from “(replacement expression)=(first constant)” may be created, and the second constant may be calculated using the expression.

Furthermore, the replacement expression may be changed each time a replacement is performed, rather than being a fixed replacement expression.

Note that control structure of the obfuscation-target program, such as the control flow and the number of loops used in the above description is merely one example, and is not limited to that described.

3.9.3 Effects of the Fourth Modification

With the conversion performed in the fourth modification, analysis of a program becomes even more difficult because, in addition to the obfuscation performed in the third embodiment, the constant values in the generated program cannot be found directly. In particular, using the fourth modification to make it impossible to find the value of a key or the like that is secret information, analysis of the value of the secret information is made difficult.

3.10 Other Modifications

The present invention has been described based on, but is by no means limited to, the third embodiment and the first to fourth modifications. Cases such as the following are included in the present invention.

(1) In the third embodiment, the expression used to calculate the selection identifier in not limited to being “1×(selection parameter CP_1)+2×(selection parameter CP_2) MOD 7”. Any other expression by which candidates for the selection identifier can be calculated in some form may be used.

(2) In the third embodiment, the update processing of the selection parameter group (the update processing instruction group) is included in the selection-target data pieces 540 to 546 (e.g., “cp_1=cp_{—}2=sv;” in the selection-target data piece 660 in FIG. 20), but is not limited to being so. The secret holding program may instead be structured so as to refer to the update processing instruction group after executing the selection-target data pieces 540 to 546.

(3) Furthermore, although in FIG. 20, the judgment at step S535 in FIG. 24 is not performed explicitly, and processing ends after executing the selection-target data piece 543 that is executed last in general use, the secret holding program is not limited to having this structure. The secret holding program may execute judgment processing for judging whether or not an executed selection-target data piece is the last selection-target data piece to be executed, in a form that is independent from the selection-target data piece.

(4) Although the selection-target identifier is updated indirectly according to the updating of the selection parameter in the third embodiment, the selection-target identifier is not limited to being updated in this way. The secret holding program may update the selection identifier directly. In this case, the selection identifier updating at step S530 in FIG. 24 is performed, and when the judgment result is “NO” at step S535, operations return to step S510.

(5) In the third embodiment, although the secret holding program stores input values from the invoker program as initial values of the selection parameters, the secret holding program is not limited to this structure. The secret holding program may use values acquired from another device on a network as the initial values of the selection parameters, or may use output values obtained as a result of executing another program in a program execution device as the initial values, of the selection parameters.

(6) In the third embodiment, although the program obfuscation apparatus receives initial values of the selection parameters in the input unit when converting an obfuscation-target program into a secret holding program, the program obfuscation apparatus is not limited to this structure. The initial values of the selection parameters may be set values, and the program obfuscation apparatus may store these set values in advance.

(7) In the third embodiment, it is not necessary for the number of function provision instruction groups to be three and the number of dummy function provision instruction groups to be four as described, as long as the number of function provision groups is a plural number and the number of dummy function provision groups is at least one.

(8) Although the third embodiment describes a case in which the secret holding program is generated with the number of selection-target parts, the number of selection parameters and the expression used to calculate the selection identifier are fixed, these values and the expression are not limited to being fixed, and other values and another expression may be used. For instance, the these values and the expression may be input into the program obfuscation apparatus, or may be determined based on an entire exhaustive search. Note that in the case of these values and the expression being given as input, it is preferable that the expression used to calculate the selection identifier is an expression whose calculation result is always no greater than the number of selection-target data pieces. This is to ensure that the generated secret holding program 500 operates correctly on a computer. Furthermore, in order to make analysis by a malicious analyzer more difficult, it is preferable that the values calculated in accordance with the values of the selection parameters by the expression fluctuate greatly.

Furthermore, the initial values of the selection parameters may be determined randomly for each program that is an obfuscation-target. This means that even if an illegal analyzer is able to obtained the initial values of the selection parameters for one program, he/she will not be able to apply those initial values to another program.

(9) Although a description was given of a simple method for dividing the blocks in the first embodiment, the method used is not limited to the described method. Instead, control structure analysis may be performed in accordance with how blocks are divided, and function provision instruction groups may be generated in accordance with how blocks are divided.

(10) Although in the third embodiment the secret processing apparatus 60 is realized in the form of a program execution apparatus that uses a program as described, the secret processing apparatus 60 is not limited to this, and may instead be implemented as hardware.

(11) In the third embodiment, the secret processing apparatus 60 uses the judgment result at step S535 of FIG. 24 to judge whether to end or whether to continue processing, but is not limited to doing so.

Instead of the judgment shown at step S535 of FIG. 24, the selection processing apparatus 60 may instead judge whether or not the number of pieces of selection processing data that have been selected is the same as the number of blocks resulting from the division.

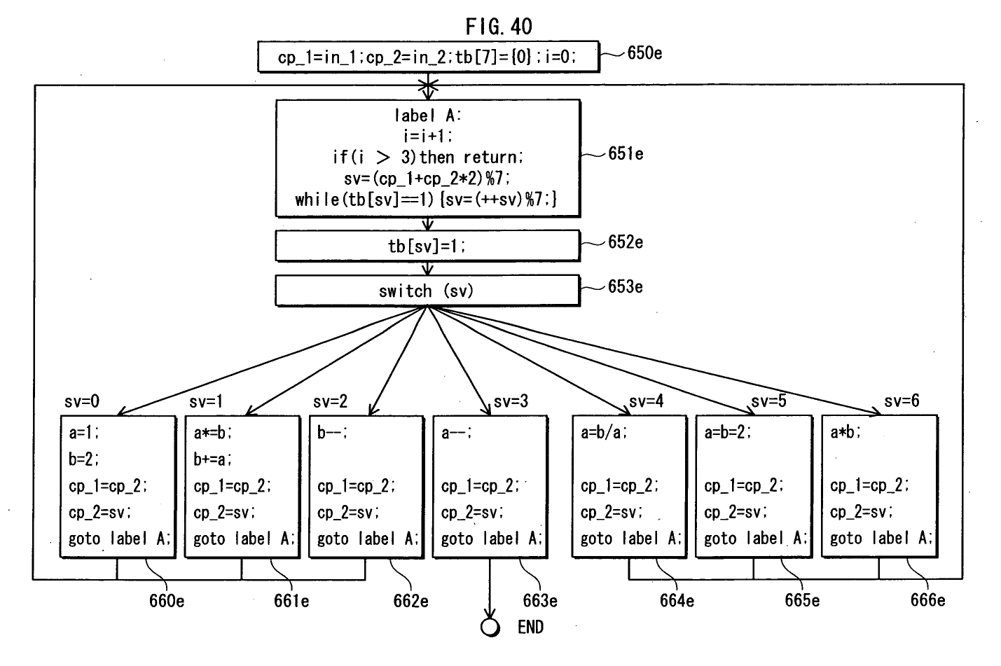

A specific example of the secret holding program 500e in this case is shown in the flowchart of FIG. 40. The flowchart of the program shown in FIG. 40 is a specific example of when the blocks shown in FIG. 18 are written in C language.

The value “i” in FIG. 40 shows the number of times a selection-target data piece has been selected (hereinafter called a “selection times”). A conditional expression “if (i>3) then return;” included in block 651e is used to control whether the secret holding program 500e ends or processing continues. More specifically, when the selection times is greater than 3, the secret processing apparatus 60 ends execution of the secret holding program 500e, and when the selection times is 3 or fewer, the secret processing apparatus 60 continues executing the secret holding program 500e. Here, the value “3” in the conditional expression is the same as the number of blocks resulting from the division.

Furthermore, the branch instruction groups in the selection-target data pieces are all branch instructions for branching to the selection processing instruction group.

This makes it difficult to find the selection-target data piece that is executed last in general use execution.

Furthermore, by making the value in the conditional expression “if (i>3) then return;” the same as the number of blocks resulting from the division, the operations of the secret holding program 500e are guaranteed to end after execution of the selection-target data piece that is executed last in the general use (e.g., the third function provision instruction group).

(12) Although the number of selection parameters is two in the first embodiment, the number is not limited to being two. Any plural number of selection parameters may be used.

In this case Expression 3 will be “p1×(first selection parameter-use variable)+p2×(second selection parameter-use variable)+ . . . +pn×(n-th selection parameter-use variable) mod NN”, where n is an integer no less than 2, and where NN, p1, p2, pn are coprimes. Furthermore, when updating the selection parameters, the value stored in the (i−1)-th parameter is shifted into the i-th parameter. Here, the n-th parameter, the (n−1)-th parameter, the second parameter are shifted successively in the stated order. Furthermore, the value if the selection identifier used in the selection of the selection-target data piece is stored in the n-th parameter. Here, i is an integer that is no less than 2 and no greater than n.

(13) In the first embodiment, the program obfuscation apparatus 50 generates the secret holding program by determining the arrangement of the preprocessing instruction group, the selection processing instruction group; the transition processing instruction group and the selection-target data pieces after a selection-target main instruction group, an update processing instruction group and a branch instruction group have been inserted in selection-target data pieces containing only label names. However, the program obfuscation apparatus 50 is not limited to generating the secret holding program in this manner.

The program obfuscation apparatus 50 may first determine the arrangement of the preprocessing instruction group, a selection processing instruction group, a transition processing instruction group, and the selection-target data pieces containing only label names, and then insert a selection target main instruction group, an update processing instruction group, and a branch instruction group in each selection-target data piece.

(14) The described embodiment and the modification examples may be combined.

### 4. Fourth Embodiment

Referring to the drawings, the following describes a secret holding program 2000, a program obfuscation apparatus 1010 and a secret processing apparatus 1020 as a fourth embodiment of the present invention.

Note that the structure of the system is the same as shown in the third embodiment, and therefore a description thereof is omitted.

Similar to the secret processing apparatus 60 shown in the third embodiment, the secret processing apparatus 1020 is an apparatus that uses secret information.

The compositional elements of the secret processing apparatus 1020 and the secret processing apparatus 60 shown in the third embodiment are the same, with part of their processing differing. Since the following description focuses on the processing by the units, a description of the secret holding program 2000 that realizes a secret processing apparatus on a computer will also serve as a description of the secret processing apparatus, in order to simplify the description. Here, the structure of the secret processing apparatus 1020 and the correlation between parts of the secret holding program 2000 are the same as shown in the third embodiment.

4.1 Secret Holding Program 2000

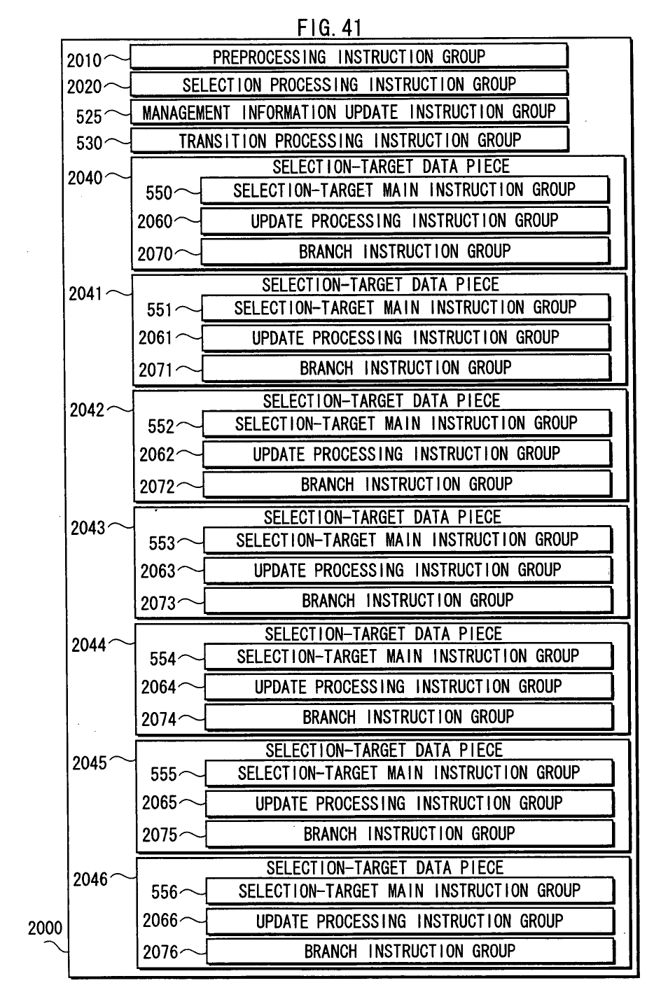

The overall structure of the secret holding program 2000 is shown in FIG. 41. Details of the secret holding program 2000 are given with reference to FIG. 41 in the following description. Parts that are the same as in the secret holding program 500 of the third embodiment have the same numeric references, and a description thereof is omitted.

As with the secret holding program 500 in the third embodiment, the secret holding program 2000 is a program that has been obfuscated such that a malicious analyzer will not be able to analyze the order in which the program instruction groups in the program are executed.

The secret holding program 2000 includes, arranged in the order shown in FIG. 41, the management information update instruction group 525 and the transition processing instruction group 530 the same as in the third embodiment, and a preprocessing instruction group 2010, a selection processing instruction group 2020 and selection-target data pieces 2040, 2041, . . . , 2046 which differ from the third embodiment. A detailed description of these parts is given below.

Each of the selection-target data pieces 2040 to 2046 is composed of respective ones of the selection-target main instruction groups 550 to 556 the same as in the third embodiment, and update processing instruction groups 2060 to 2066 and branch instruction groups 2070 to 2076 different from the third embodiment. The instruction groups are arranged in the order shown in FIG. 41. Each instruction group consists of one or more program instructions.

The secret holding program 2000 is a program instruction group that receives, from an invoker program, three input values in_1, in_2 and in_3, and parameters used when performing processing of the function provided by the program, and performs processing of the function that the program provides. Note that in_k (where k is an index) is a non-negative integer less than (7-k). Note that the number of selection-target data pieces are not limited to being the seven pieces 2040 to 2046 described here. The number of selection-target data pieces may be n+1, where n is a natural number. In such a case, in_k is a non-negative integer less than (n+1−k). Furthermore, the number of input values is not limited to being the three input values in_1, in_2 and in_3 described here. The number of input values may be m (m being a natural number no greater than n+1).

The secret holding program 2000 uses selection parameters CP_1, CP_2, CP_3 of the selection parameter group and a selection parameter index CPI used in processing in the selection processing instruction group 2020, and a selection identifier-use variable that holds a selection identifier.

In the present example it is assumed that the input values in_1, in_2 and in_3 received from an invoker program in general use execution are values “2”, “4” and “3”, respectively. The secret holding program 2000 provided in the present embodiment executes selection-target data (including a selection-target main instruction groups) in the correct order if the values received from the invoker program are used. Given that a malicious analyzer does not know the values received from the invoker program, it is difficult for the analyzer to find out the execution order of the selection-target data pieces (including a selection-target main instruction groups).

4.1.1 Preprocessing Instruction Group 2010

The preprocessing instruction group 2010 is a program instruction group for setting the selection parameters group used in the selection processing instruction group 2020. Note that the selection parameter group consists of the selection parameter CP_1, the selection parameter CP_2, the selection parameter CP_3, and the selection parameter index CPI. The selection parameters CP_1 to CP_3 are non-negative integers, and the selection parameter index CPI is a natural number.

The preprocessing instruction group 2010 is the program instruction group that is executed first when the secret holding program 2000 is run. The preprocessing instruction group 2010 includes a program instruction group that receives the input values in_1, in_2 and in_3 from the invoker program, and stores the received values in the selection parameters CP_1 to CP_3, respectively, in the selection parameter group, and sets the value of the selection parameter index CPI in the selection parameter group to “1”. When executed in general use, the values of in_1, in_2 and in_3 are “2”, “4” and “3”, respectively, and the program instruction group performs processing to store the values “2”, “4” and “3” in the selection parameters CP_1 to CP_3, respectively. Note that the number of selection parameters is the same as the number of input values in_1, in_2, . . . (three in the present embodiment).

4.1.2 Selection Processing Instruction Group 2020

The selection processing instruction group 2020 includes a program instruction group for calculating a selection identifier using the selection parameter group. Note that as in the third embodiment, the selection identifier is a value used when executing the transition processing instruction group.

In the processing for calculating the selection identifier, the selection processing instruction group first selects a selection parameter CP_CPI in the selection parameter group, with respect to the selection parameter index CPI in the selection parameter group (in other words, when CPI=1, the selection processing instruction group selects the selection parameter CP_1).

Next, using the management information in the secret processing apparatus 1020, the selection processing instruction group 2020 selects the (CP_CPI)-th one of unexecuted selection-target data pieces, and stores the number of the selected selection-target data piece in the selection identifier-use variable. Here, the number of the selection-target data piece is counted not from “1”, but from “0”. For instance, if the selection-target data piece 2040 is unexecuted and CP_CPI=0, the selection processing instruction group 2020 selects the selection-target data piece 2040, and stores “0” in the selection identifier-use variable.

4.1.3 Selection-Target Data Pieces 2040 to 2046

Each of the selection-target data pieces 2040 to 2046 is a program instruction group, and one of these program instruction groups is executed after branching by the transition processing instruction group 530.

Each of the selection target data pieces 2040 to 2046 is composed of respective ones of the selection-target main instruction groups 150 to 156 the same as in the third embodiment, and update processing instruction groups 2060 to 2066 and branch instruction groups 2070 to 2076 different from the third embodiment.

In the present embodiment, the processing of the function provided by the secret holding program is performed by executing the selection-target main instruction groups 552, 555 and 554 in the stated order in general use execution. In other words, the first to third function provision instruction groups are inserted in the selection-target main instruction groups 552, 555 and 554, respectively, and a dummy function provision group is inserted in each of the selection-target main instruction groups 550, 551, 553 and 556.

(1) Update Processing Instruction Groups 2060 to 2066

Each of the update processing instruction groups 2060 to 2066 is a program instruction group for updating the values of the selection parameter group to be used in the next selection. More specifically, the update processing instruction groups 2060 to 2066 increment the selection parameter index CPI. This means that the selection processing instruction group 2020 directly specifies the selection parameters to be used in the selection.

(2) Branch Instruction Groups 2070 to 2076

Each of the branch instruction groups 2070 to 2076 is composed of either a program instruction group that branches to the selection processing instruction group 2020 which is outside the selection-target data pieces 2040 to 2046, or a program instruction group for processing to return control to the invoker program.

The branch instruction group 2074 included in the selection-target data piece 2044 is a program instruction group for processing to return control to the invoker program, and the other the branch instruction group for branching to outside a selection target included in other selection-target data pieces is a program instruction group for branching to a selection processing instruction group 2020.

4.1.4 Operations

(1) Operations when Executing Secret Holding Program License Ticket Distribution Server 2000

Referring to FIG. 24, the following describes aspects that differ between operations of the secret processing apparatus 60 and operations of the secret processing apparatus 1020 and when the secret holding program 2000 is executed.

In the operations of the secret processing apparatus 1020, the following changes are made to the operations of step S500, step S505 and step S530 in FIG. 24.

In the present embodiment, step S500 is changed so as to acquire initial values of selection parameters equal in number to the function provision instruction groups, initialize the value of the selection parameter index CPI, and executed preprocessing.

In the present embodiment, step S505 is changed so as to select a selection identifier by selecting a selection parameter having a number shown by the selection parameter index CPI. For instance, in the case of the selection parameter index CPI being “1”, the selection parameter CP_1 is selected.

In the present embodiment, step S530 is changed so as to increment the value of the selection parameter index CPI.

(2) Specific Example of Operations

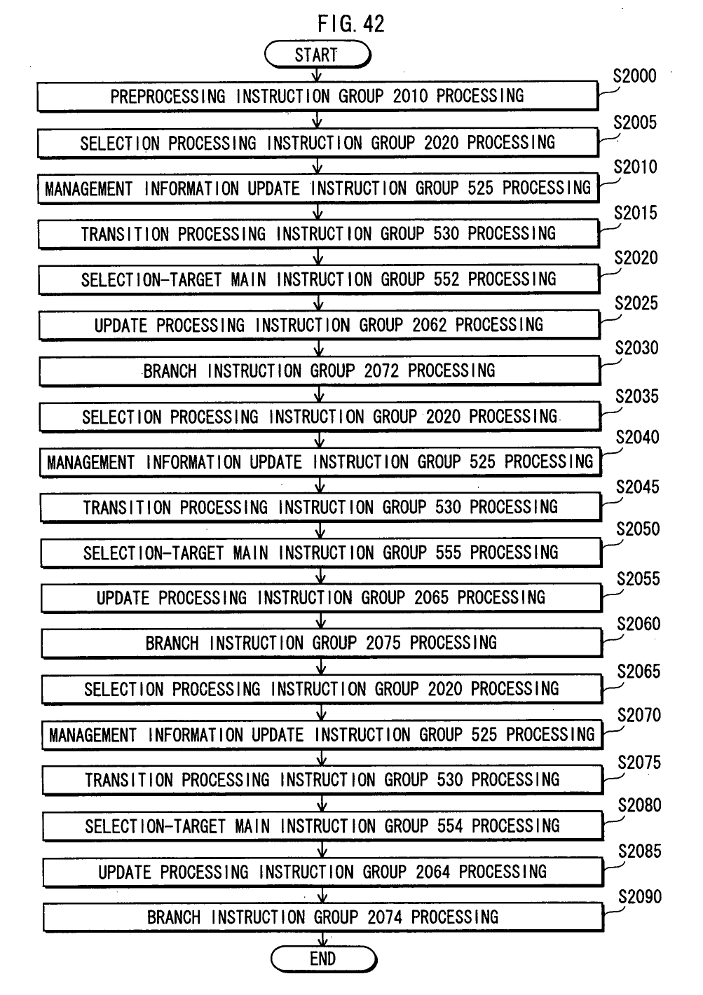

Referring to FIG. 42, the flowing describes a specific example of operations of the secret holding program 2000 of the present embodiment.

As described, the first to third function provision instruction groups are included in the selection-target main instruction groups 552, 555 and 554, respectively, and a dummy function provision instruction group is included in each of the selection-target main instruction groups 550, 551, 553, and 556. In general use execution, processing of the function provided by the secret holding program is performed by the selection-target main instruction groups 552, 555 and 554 being executed in the stated order.

The secret holding program 2000 performs the processing of the preprocessing instruction group 2010 (step S2000). More specifically, the preprocessing instruction group 2010 in the secret holding program 2000 receives values “2”, “4” and “3” as the respective input values in1, in2 and in3, from the invoker program, performs processing to store the values “2”, “4” and “3” in the first to third selection parameter-use variables, respectively, performs processing to initialize the selection parameter index CPI to “1”, and then branches to the selection processing instruction group 2020.

The secret holding program 2000 performs the processing of the selection processing instruction group 2020 (step S2005). More specifically, the selection processing instruction group 2020 acquires one selection parameter based on the value stored in the selection parameter index CPI. The selection processing instruction group 2020 selects one of the selection-target data pieces based on the acquired selection parameter. Here, since the selection parameter index CPI is “1”, the selection processing instruction group 2020 acquires the selection parameter CP_1 (=2). Using the management information held by the secret processing apparatus 1020, the selection processing instruction group 2020 selects the (CP_1 (=2)-th unexecuted-one of the selection-target data pieces (2040, 2041, 2042, 2043, 2044, 2045 and 2046), which is the selection-target data piece 2042 positioned second. The selection processing instruction group 2020 stores the value “2” in the selection identifier-use variable.

The secret holding program 2000 performs the processing of the management information update instruction group 525 (step S2010). More specifically, the management information update instruction group 525 updates the management information piece of the selection-target data piece 2042 corresponding to the selection identifier-use variable “2” so as to show “already executed”.

The secret holding program 2000 performs processing of the transition processing instruction group 530 (step S2015). More specifically, the transition processing instruction group 530 performs the processing to branch to the selection-target data piece 2042 corresponding to the selection identifier-use variable “2”.

The secret holding program 2000 performs processing of the selection-target main instruction group 552 included in the selection-target data piece 2042 (step S2020). More specifically, the selection-target data piece 2042 performs processing equivalent to the first function provision instruction group that is part of the function provided by the program.

The secret holding program 2000 performs processing of the update processing instruction group 2062 (step S2025). More specifically, the update processing instruction group 2062 increments the selection parameter index CPI of the selection parameter group. Here, the value of the selection parameter index is updated from “1” to “2”.

The secret holding program 2000 performs the processing of the branch instruction group 2072 (step S2030). More specifically, the branch instruction group 2072 performs processing to branch to the selection processing instruction group 2020.

The secret holding program 2000 performs processing of the selection processing instruction group 2020 (step S2035). More specifically, since the value stored in the selection parameter index CPI is “2”, the selection processing instruction group 2020 acquires the selection parameter CP_2 (=4). The selection processing instruction group 2020 selects (CP_2 (=4))-th unexecuted one of the selection-target data pieces (2040, 2041, 2042, 2043, 2044, 2045 and 2046), which is the selection-target data piece 2045. The selection processing instruction group 2020 stores the value “5” in the selection identifier-use variable.

The secret holding program 2000 performs the processing of the management information update instruction group 525 (step S2040). More specifically, the management information update instruction group 525 updates the management information piece of the selection-target data piece 2045 corresponding to the selection identifier-use variable “5” so as to show “already executed”.

The secret holding program 2000 performs processing of the transition processing instruction group 530 (step S2045). More specifically, the transition processing instruction group 530 performs processing to branch to the selection-target data piece 2045 corresponding to the selection identifier-use variable “5”.

The secret holding program 2000 performs the processing of the selection-target main instruction group 555 included in the selection-target data piece 2045 (step S2050). More specifically, the selection-target data piece 2045 performs processing equivalent to the second provision instruction group that is part of the function provided by the program.

The secret holding program 2000 performs processing of the update processing instruction group 2065 (step S2055). More specifically, the update processing instruction group 2065 increments the selection parameter index CPI of the selection parameter group. Here, the value of the selection parameter index is updated from “2” to “3”.

The secret holding program 2000 performs the processing of the branch instruction group 2075 (step S2060). More specifically, the branch instruction group 2075 performs processing for branching to the selection processing instruction group 2020.

The secret holding program 2000 performs processing of the branch instruction group 2020 (step S2065). More specifically, since the value stored in the selection parameter index CPI is “3”, the selection processing instruction group 2020 acquires the selection parameter CP_3 (=3). The selection processing instruction group 2020 selects (CP_3 (=3))-th unexecuted one of the selection-target data pieces (2040, 2041, 2043, 2044 and 2046), which is the selection-target data piece 2044. The selection processing instruction group 2020 stores the value “4” in the selection identifier-use variable.

The secret holding program 2000 performs the processing of the management information update instruction group 525 (step S2070) More specifically, the management information update instruction group 525 updates the management information piece of the selection-target data piece 2044 corresponding to the selection identifier-use variable “4” so as to show “already executed”.

The secret holding program 2000 performs processing of the transition processing instruction group 530 (step S2075). More specifically, the transition processing instruction group 530 performs processing to branch to the selection-target data piece 2044 corresponding to the selection identifier-use variable “4”.

The secret holding program 2000 performs the processing of the selection-target main instruction group 554 included in the selection-target data piece 2044 (step S2080). More specifically, the selection-target data piece 2044 performs processing equivalent to the third provision instruction group that is part of the function provided by the program.

The secret holding program 2000 performs processing of the update processing instruction groups 2064 (step S2085). More specifically, the update processing instruction group 2064 increments the selection parameter index CPI of the selection parameter group. Here, the value of the selection parameter index is updated from “3” to “4”.

The secret holding program 2000 performs the processing of the branch instruction group 2074 (step S2090). More specifically, the branch instruction group 2074 performs processing to return control to the program that invoked the secret holding program 2000.

4.2 Program Obfuscation Apparatus 1010

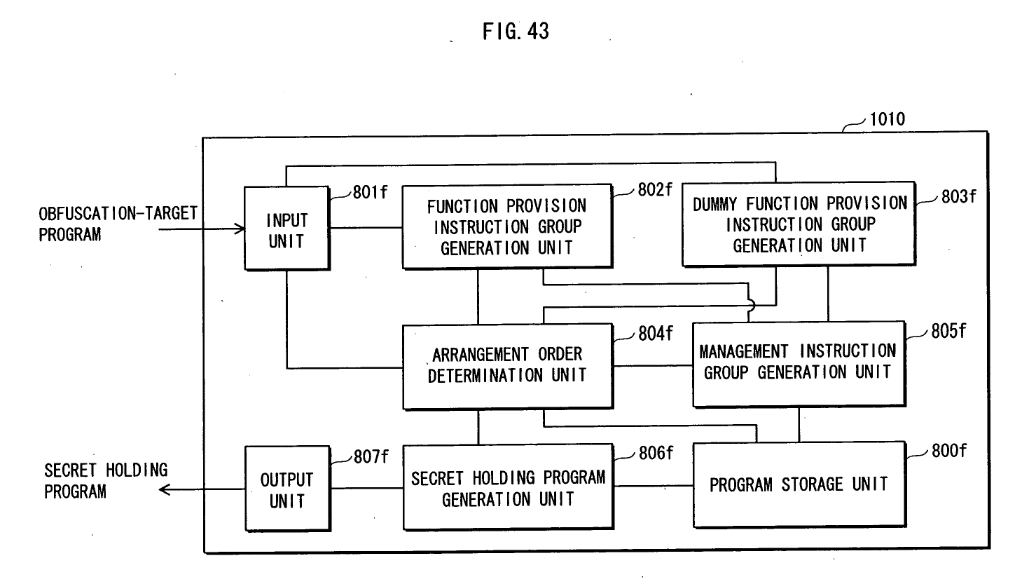

As shown in FIG. 43, the program obfuscation apparatus 1010 is composed of a program storage unit 800f, an input unit 801f, a function provision instruction group generation unit 802f, a dummy function provision instruction group generation unit 803f, an arrangement order determination unit 804f, a management instruction group generation unit 805f, a secret holding program generation unit 806f, and an output unit 807f.

The program obfuscation apparatus 1010 is, specifically, a computer system composed of a microprocessor, a ROM, a RAM, a hard disk unit, a display unit, a keyboard, a mouse, and the like. A computer program is stored in the RAM or the hard disk unit. Here, the computer program is a combination of instruction codes showing instructions for a computer for achieving predetermined functions. The program obfuscation apparatus 1010 achieves its functions by the microprocessor operating in accordance with the computer program. In other words, the microprocessor reads the instruction in the computer program one instruction at a time, decodes the read instruction, and operates in accordance with the result of decoding.

Note that the program storage unit 800f, the input unit 801f, the function provision instruction group generation unit 802f, the dummy function provision instruction group generation unit 803f, the management instruction group generation unit 805f, the secret holding program generation unit 806f, and the output unit 807f are the same as the program storage unit 800, the input unit 801, the function provision instruction group generation unit 802, the dummy function provision instruction group generation unit 803, the management instruction group generation unit 805, the secret holding program generation unit 806, and the output unit 807, respectively, shown in the third embodiment, and therefore a description thereof is omitted.

The difference between the arrangement order determination unit 804 and the arrangement order determination unit 804f is that the former calculates the selection identifier using the initial values of the selection parameters and an arithmetic expression for calculating the selection identifier, whereas the latter uses the initial values of the selection parameters, but does not use an arithmetic expression.

The following describes the arrangement order determination unit 804f.

Although not illustrated, the arrangement order determination unit 804f includes a control unit 850f; a selection processing unit 851f, a management information updating unit 852f, an update processing unit 853f and a management information holding unit 854f. These compositional elements are connected to each other in the same way as the compositional elements of the arrangement order determination unit 804 shown in FIG. 26.

Using the initial values of the selection parameters, the arrangement order determination unit 804f determines selection-target main instruction groups in which the function provision instruction groups and the dummy function provision instruction groups are to be arranged, by checking what order the selection identifier will actually be calculated in.

Note that, as in the third embodiment, in the present embodiment it is assumed that the initial values of the selection parameters are received here by the input unit 801f, and that the initial values of the selection parameters CP_1 to CP_3 are “2”, “4” and “3”.

(1) Management Information Holding Unit 854f

The management information holding unit 854f is the same as the management information holding unit 854, and therefore a description is omitted. Note that the management information table T800 is referred in the following description when necessary.

This enables the position in which the function provision instruction groups are arranged (the selection-target data piece in which each function provision instruction group is arranged) to be stored.

(2) Control Unit 850f

The control unit 850f has a parameter storage area for storing the selection parameter group.

The control unit 850f stores the initial values CP_1, CP_2 and CP_3 (here, “2”, “4” and “3”, respectively) of the selection parameters received by the input unit 801f, in the parameter storage area.

Furthermore, at the commencement of processing, the control unit 850f sets an initial value “1” in the selection parameter index CPI, and stores the initial value of the selection parameter index in the parameter storage area.

The control unit 850f controls the operations of the selection processing unit 851f, the management information updating unit 852f, and the update processing unit 853f.

The control unit 850f puts in correspondence each of the possible values of the selection identifier with the respective selection-target data pieces stored in the program storage unit 800f.

The control unit 850f acquires the i-th generated function provision instruction group from the function provision instruction group generation unit 802f. Based on the selection identifier acquired by the selection processing unit 851f, the control unit 850f inserts the acquired i-th function provision instruction group in the corresponding selection-target data piece stored in the program storage unit 800f. Here, i is an integer that is no less than 1 and no greater than m. The control unit 850f also temporarily stores the correspondence between i-th function provision instruction group and the selection-target data piece in which the i-th function provision instruction group is inserted.

The control unit 850f acquires one of the dummy function provision instruction groups that has not been inserted into a selection-target data piece, from the dummy function provision instruction group generation unit 803f. The control unit 850f inserts the acquired dummy function provision instruction group into a selection-target data piece that has not had an i-th function provision instruction group or a dummy function provision instruction group inserted therein. The control unit 850f performs these operations with respect to all dummy function provision instruction groups.

As a result of these operations, the control unit 850f inserts an i-th function provision instruction group or a dummy function provision instruction group into each selection-target data piece.

The operations by the control unit 850f for acquiring an i-th function provision instruction group enable acquisition of a function provision instruction group that is an arrangement-target.

(3) Selection Processing Unit 851f

The selection processing unit 851f acquires the selection parameter index CPI stored in the parameter storage area, and based on the acquired CPI, acquires a selection parameter CP_k. Here, k is a number no less than 1 and no greater than 3.

The selection processing unit 851f acquires the selection identifier with use of the value of the acquired CP_k and the management information table T800.

The following describes how the selection identifier is acquired.

Assume that the management information pieces in the management information table T800 are an 0-th piece, a 1st piece, and so on, in order starting from the management information piece having the value “0”. The selection processing unit 851f acquires the management information piece matching the value of the acquired CP_k, and acquires the selection identifier of the selection-target data piece corresponding to the acquired management information piece.

The operations by the selection processing unit 851f, and the operations by the control unit 850f for inserting the i-th function provision instruction group into a selection-target data piece based on the selection identifier acquired by the selection processing unit 851f enable function provision instruction groups to be arranged in appropriate locations.

(4) Management Information Updating Unit 852f

The management information updating unit 854f is the same as the management information updating unit 852, and therefore a description is omitted.

(5) Update Processing Unit 853f

The update processing unit 853f updates the selection parameter index CPI stored in the parameter storage areas More specifically, the update processing unit 853f increments the selection parameter index CPI stored in the parameter storage area by “1”.

4.3 Operations of Program Obfuscation Apparatus 1010

The program obfuscation apparatus 1010 generates a secret holding program by executing arrangement determination processing described below, instead of step S620 shown in FIG. 27.

4.3.1 Arrangement Determination Processing

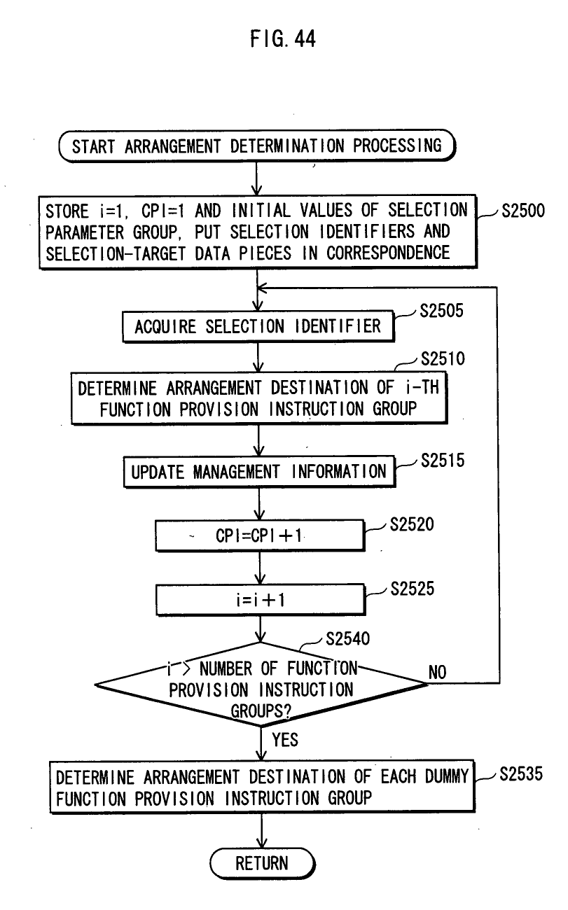

Referring to the flowchart in FIG. 44, the following describes operations for arrangement determination processing.

The control unit 850f sets the count i to “1”, sets the selection parameter index CPI to an initial value “1”, and stores the selection parameter index CPI and the initial values “2”, “4” and “3” of the selection parameters CP_1, CP_2 and CP_3 in the parameter storage area. The control unit 850f puts each value of the selection identifier in correspondence with a selection-target data piece (step S2500). The counter i expresses which number in the execution order the function provision instruction group is currently being focused on should be executed. In other words, here the control unit 850f determines the order of arrangement in order starting from the first function provision group.

The selection processing unit 851f acquires the selection parameter index CPI, and acquires a selection parameter CP_k based on the acquired CPI. The selection processing unit 851f acquires the selection identifier with use of the acquired CP_k and the management information table T800 (step S2505). Here, k is a number no less than 1 and no greater than 3. As one example, when the selection parameter index CPI is “1”, the selection processing unit 851f acquires a selection parameter CP_1 (=2), and with use of the acquired CP_1 and the management information table T800, acquires a selection identifier “2”.

The control unit 850f inserts the i-th function provision instruction group in the corresponding selection-target data piece, based on the selection identifier acquired by the selection processing unit 851f (step S2510). As one example, if cont=1 and the value of the selection identifier is “2”, the first function provision instruction group will be arranged in the selection-target data piece 2042.

The management information updating unit 852f updates, from “0” to “1”, the value of the one of the management information pieces in the management information table T800 that corresponds to the selection identifier acquired by the selection processing unit 851f (step S2515). As one example, when the value of the selection identifier is “2”, the management information updating unit 852f changes the management information piece corresponding to the selection-target data piece 2042 in the management information table T800 of the selection information holding unit 854f from showing “unarranged” to “already arranged”.

The update processing unit 853f increments the selection parameter index CPI stored in the parameter storage area, by “1”, to update the value of the selection parameter index CPI, and writes the updated value to the parameter storage area (step S2520).

The control unit 850f adds “1” to the value of the counter (step S2525).

The control unit 850f judges whether or not the value of the counter i is greater than the number of function provision instruction groups (step S2530).

When it is judged that the value of the counter i is not greater (“NO” at step S2530), the control unit 850f returns to step S2505, and controls operations of the selection processing unit 851f.

When it is judged that the value of the counter i is greater (“YES” at step S2530), the control unit 850f determines where to arrange the dummy function provision instruction groups, such that each is arranged in a selection-target data piece that does not yet have a function provision group inserted therein (step S2535). As one example, when the selection-target data pieces 540, 541, 542 and 544 have not yet been executed, the control unit 850f determines that the dummy function provision instruction groups are to be arranged in the selection-target data pieces 2040, 2041, 2042 and 2044, and inserts the dummy function provision groups in the selection-target data pieces.

4.4 Modifications

(1) In the fourth embodiment, although the secret holding program stores input values from the invoker program as initial values of the selection parameters, the secret holding program is not limited to this structure. The secret holding program may use values acquired from another device on a network as the initial values of the selection parameters, or may use output values obtained as a result of executing another program in a program execution device as the initial values of the selection parameters.

(2) In the fourth embodiment, it is not necessary for the number of function provision instruction groups to be three and the number of dummy function provision instruction groups to be four as described, as long as the number of function provision groups is a plural number and the number of dummy function provision groups is at least one.

(3) Although in the fourth embodiment the secret processing apparatus 1020 is realized in the form of a program execution apparatus that uses a program as described, the secret processing apparatus is not limited to this, and may instead be implemented as hardware.

(4) The described embodiment and the modification examples may be combined.

4.5 Effects of the Fourth Embodiment

In the present embodiment, the selection processing instruction group 2020 selects the selection-target data piece to be selected next only from among unexecuted selection-target data pieces. Therefore, even if a malicious analyzer whose knows that the obfuscation-target data does not execute the same selection-target data piece twice performs an exhaustive search changing the initial values of the selection parameter group, no selection-target data piece will be selected twice, regardless of the initial values. This makes it difficult for the analyzer to figure out the wrong values efficiently based on whether or not a same program instruction is executed twice.

Furthermore, in the present embodiment, the same number of input values as function provision instruction groups is provided, and selection-target data pieces corresponding to the input values are selected. The effect of this implementation is described with use of a specific example. In the above-described example, since the number of function provision instruction groups is three, selection-target data pieces are selected according to input values in_1, in_2 and in_3. In the secret holding program 2000 of the present embodiment, first, a non-negative integer in_1 that is 6 or lower (seven types exists) is used to select one of the seven selection-target data pieces 2040 to 2046. Here, “seven types exist” shown in parenthesis means that seven possible values exist of in_1 that a malicious analyzer may set. Next, a non-negative integer in_2 that is 5 or lower (six types exists) is used to select one of the six unexecuted selection-target data pieces (i.e., six pieces excluding the one of the selection-target data pieces 2040 to 2046 selected with use of in_1). Furthermore, a non-negative integer in_3 that is 4 or lower (five types exists) is used to select one of the five unexecuted selection-target data pieces (i.e., five pieces excluding the two of the selection-target data pieces 2040 to 2046 selected with use of in_1 and in_2). By selecting the selection-target data pieces uniquely in this way, the number of variations for selecting a selection-target data piece with respect to the input values does not decrease, and the number of combinations when an attacker performs an exhaustive search does not decrease.

### 5. Fifth Embodiment

Referring to the drawings, the following describes a secret holding program 2200, a program obfuscation apparatus 3010 and a secret processing apparatus 3020 as a fifth embodiment of the present invention.

Note that the structure of the system is the same as shown in the third embodiment, and therefore a description thereof is omitted.

Similar to the secret processing apparatus 60 shown in the third embodiment, the secret processing apparatus 3020 is an apparatus that uses secret information.

The compositional elements of the secret processing apparatus 3020 and the secret processing apparatus 60 shown in the third embodiment are the same, with part of their processing differing. Since the following description focuses on the processing by the units, a description of the secret holding program 2200 that realizes a secret processing apparatus on a computer will also serve as a description of the secret processing apparatus, in order to simplify the description. Here, the structure of the secret processing apparatus 3020 and the correlation between the parts of the secret holding program 2200 is the same as shown in the third embodiment.

5.1 Secret Holding Program 2200

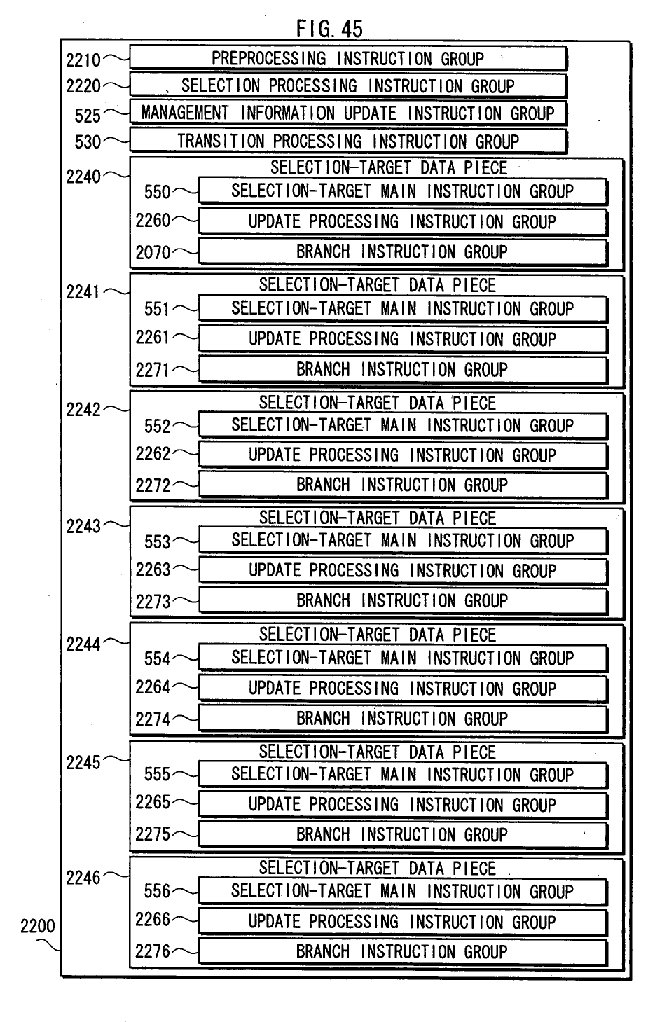

The overall structure of the secret holding program 2200 is shown in FIG. 45. Details of the secret holding program 2200 are given with reference to FIG. 45 in the following description. Parts that are the same as in the secret holding program 500 of the third embodiment have the same numeric references, and a description thereof is omitted.

As with the secret holding program 500 in the third embodiment, the secret holding program 2200 is a program that has been obfuscated such that a malicious analyzer will not be able to analyze the order in which the program instruction groups in the program are executed.

The secret holding program 2200 includes, arranged in the order shown in FIG. 45, the management information update instruction group 525 and the transition processing instruction group 530, and a preprocessing instruction group 2210, a selection processing instruction group 2220 and selection-target data pieces 2240, 2241, . . . , 2246 which differ from the third embodiment.

Each of the selection-target data pieces 2240 to 2246 is composed of respective ones of the selection-target main instruction groups 550 to 556 the same as in the third embodiment, and update processing instruction groups 2260 to 2266 and branch instruction groups 2270 to 2276 different from the third embodiment. The instruction groups are arranged in the order shown in FIG. 45. Each instruction group consists of one or more program instructions.

The secret holding program 2200 is a program instruction group that receives, from an invoker program, two input values in_1 and in_2, and parameters used when performing processing of the function provided by the program, and performs processing of the function that the program provides. Note that in_k (where k is an index) is a non-negative integer less than (7−k). Note that the number of selection-target data pieces are not limited to being the seven pieces 2240 to 2246 described here. The number of selection-target data pieces may be n+1, where n is a natural number. In such a case, in_k is a non-negative integer less than (n+1−k). Furthermore, the number of input values is not limited to being the two input values in_1, and in_2 described here. The number of input values may be m (m being a natural number no greater than n+1).

The secret holding program 2200 uses selection parameters CP_1 and CP_2 of the selection parameter group and a modulus value NN used in processing in the selection processing instruction group 2220, and a selection identifier-use variable that holds a selection identifier described later.

In the present example it is assumed that the input values in_1 and in_2 received from an invoker program are values “2” and “4”, respectively. The secret holding program 2200 provided in the present embodiment executes selection-target, data (including a selection-target main instruction group) in the correct order if the values received from the invoker program are used. Given that a malicious analyzer does not know the values received from the invoker program, it is difficult for the analyzer to find out the execution order of the selection-target data pieces (including a selection-target main instruction group).

5.1.1 Preprocessing Instruction Group 2210

The preprocessing instruction group 2210 is a program instruction group for setting the selection parameters group used in the selection processing instruction group 2220. Note that the selection parameter group consists of the selection parameter CP_1, the selection parameter CP_2, and the modulus value NN. The selection parameters CP_1 and CP_2 are non-negative integers, and the modulus value is a natural number.

The preprocessing instruction group 2210 is the program instruction group that is executed first when the secret holding program 2200 is run. The preprocessing instruction group 2210 includes a program instruction group that receives the input values in_1 and in_2 from the invoker program, and stores the received values in the selection parameters CP_1 and CP_2, respectively, in the selection parameter group, and sets the modulus value NN to “7”. The preprocessing instruction group 2210 also includes a program instruction group for branching to the selection processing instruction group 2220. The program instruction groups are executed in the stated order. When executed in general use, the values of in_1 and in_2 are “2” and “4”, respectively, and the program instruction group performs processing to store the values “2” and “4” in the selection parameters CP_1 and CP_2, respectively. Note that the number of selection parameters is the same as the number of input values in_1, in_2, . . . (two in the present embodiment). Furthermore, in the present embodiment, the initial value of the modulus value is “7”, in accordance with the number of selection-target data pieces.

5.1.2 Selection Processing Instruction Group 2220

The selection processing instruction group 2220 includes a program instruction group for calculating a selection identifier using the selection parameter group, and a program instruction group for branching to the transition processing instruction group 530, which are executed in the stated order. Note that as in the third embodiment, the selection identifier is a value used when executing the transition processing instruction group 530.

In the processing for calculating the selection identifier, the selection processing instruction group 2220 calculates Expression 20 “p1×(selection parameter CP_1)+p2×(selection parameter CP_2) mod NN”, and calculates a calculation result IND. Note that p1 and p2 are coprimes with NN with respect to the selection parameters CP_1 and CP_2 and the modulus value NN of the selection parameter group. Hereinafter, IND denotes the selection identifier. Furthermore, p1 and NN being coprime shows that the greatest common denominator of p1 and NN is “1”. Note that the operator “×” expresses multiplication. Next, using the management information held by the secret processing apparatus 3020, the selection processing instruction group 2220 selects the IND-th unexecuted selection-target data piece, and stores the number of the selected selection-target data piece in the selection-identifier-use variable. Here, the number of the selection-target data piece is counted not from “1”, but from “0”. For instance, if the selection-target data piece 2240 is unexecuted and IND=0, the selection processing instruction group 2220 selects the selection-target data piece 2240, and stores “0” in the selection identifier-use variable.

In the present embodiment, the values of p1 and p2 are assumed to be “1” and “2”, and Expression 20 is “1×(selection parameter CP_1)+2×(selection parameter CP_2) mod NN).

5.1.3 Selection Target Data Pieces 2240 to 2246

The selection target data pieces 2240 to 2246 are program instruction groups executed when a branch is made from the transition processing instruction group 530.

Each of the selection target data pieces 2240 to 2246 is composed of respective ones of the selection-target main instruction groups 550 to 556 the same as in the third embodiment, and update processing instruction groups 2260 to 2266 and branch instruction groups 2270 to 2276 different from the third embodiment.

In the present embodiment, the processing of the function provided by the secret holding program is performed by executing the selection-target main instruction groups 553, 555 and 554 in the stated order in general use execution. In other words, the first to third function provision instruction groups are inserted in the selection-target main instruction groups 553, 555 and 554, respectively, and a dummy function provision group is inserted in each of the selection-target main instruction groups 550, 551, 552 and 556.

(1) Update Processing Instruction Groups 2260 to 2266

Each of the update processing instruction groups 2260 to 2266 is a program instruction group for updating the values of the selection parameter group to be used in the next selection. The value of the selection parameter CP_2 is assigned to the selection parameter CP_1, the value stored in the selection identifier-use variable is assigned to the selection parameter CP_2, and the modulus value of the selection parameter group is decremented. Note that although the number of selection parameters is two here, in the case that the number of selection parameters is m, the value of the selection parameter CP_m is assigned to the selection parameter CP_(m−1), and the value of the selection parameter CP_(m−1) is assigned to the selection parameter CP_(m−2), . . . , the value of the selection parameter CP_2 is assigned to the selection parameter CP_1, the value stored in the selection identifier-use variable is assigned to the selection parameter CP_m, and the modulus value is decremented. Furthermore, when decrementing the modulus value, it is unnecessary for the modulus value to be decremented to a value that is coprime with p1 and p2.

(2) Branch Instruction Groups 2270 to 2276

Each of the branch instruction groups 2270 to 2276 is composed of either a program instruction groups that branches to the selection processing instruction group 520 which is outside the selection-target data pieces 2240 to 2246, or a program instruction group for processing to return control to the invoker program. The branch instruction group 2274 included in the selection-target data piece 2244 is a program instruction group for processing to return control to the invoker program, and the other the branch instruction group for branching to outside a selection target included in other selection-target data pieces is a program instruction group for branching to a selection processing instruction group 520.

5.1.4 Operations

Referring to FIG. 24, the following describes aspects that differ between operations of the secret processing apparatus 60 and operations of the secret processing apparatus 3020 and when the secret holding program 2200 is executed.

In the operations of the secret processing apparatus 3020, the following changes are made to the operations of step S500, step S505 and step S530 in FIG. 24.

In the present embodiment, step S500 is changed so as to perform updating of the modulus value NN in addition to the initialization of the selection parameters and the execution of the preprocessing. Here, the initial value of the modulus value is the same as the number of selection-target data pieces.

In the present embodiment, step S505 is changed so as to acquire the modulus value NN included in the selection parameter group, and to calculate the selection identifier with use of Expression 20 and the acquired modulus value NN. Note that here NN is the modulus value, not the number of selection-target data pieces.

In the present embodiment, step S530 is changed so as to decrement modulus value NN, in addition to updating the selection parameters.

(2) Specific Example of Operations

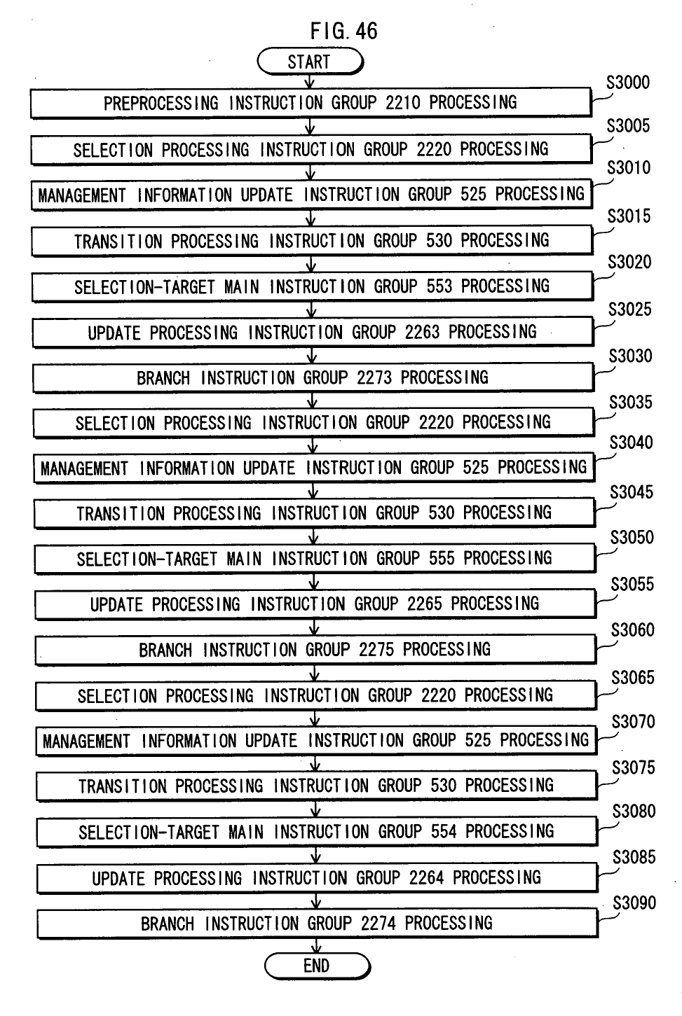

Referring to FIG. 46, the flowing describes a specific example of operations of the secret holding program 2200 of the present embodiment.

As described, the first to third function provision instruction groups are included in the selection-target main instruction groups 553, 555 and 554, respectively, and a dummy function provision instruction group is included in each of the selection-target main instruction groups 550, 551, 552, and 556. In general use execution, processing of the function provided by the secret holding program is performed by the selection-target main instruction groups 553, 555 and 554 being executed in the stated order.

The secret holding program 2200 performs the processing of the preprocessing instruction group 2210 (step S3000). More specifically, the preprocessing instruction group 2210 stores values “2” and “4” in the selection parameters CP_1 and CP_2, respectively, and sets the modulus value NN to “7”.

The secret holding program 2200 performs the processing of the selection processing instruction group 2220 (step S3005). More specifically, the selection processing instruction group 2220 calculates the value IND with use of Expression 20, the selection parameters CP_1 (=2) and CP_2 (=4), and the modulus value NN (=7). Here, the calculated value IND will be “1×2+2×4 mod 7=3”. Using the management information held by the secret processing apparatus 3020, the selection processing instruction group 2220 selects the third unexecuted one of the selection-target data pieces (2240, 2241, 2242, 2243, 2244, 2245 and 2246). The value of the selection identifier-use variable will be “3”.

The secret holding program 2200 performs the processing of the management information update instruction group 525 (step S3010). More specifically, the management information update instruction group 525 updates the management information piece of the selection-target data piece 2243 corresponding to the selection identifier-use variable “3” so as to show “already executed”.

The secret holding program 2200 performs processing of the transition processing instruction group 530 (step S3015). More specifically, the transition processing instruction group 530 performs the processing to branch to the selection-target data piece 2243 corresponding to the selection identifier-use variable “3”.

The secret holding program 2200 performs processing of the selection-target main instruction group 553 included in the selection-target data piece 2243 (step S3020). More specifically, the selection-target data piece 2243 performs processing equivalent to the first function provision instruction group that is part of the function provided by the program.

The secret holding program 2200 performs processing of the update processing instruction group 2263 (step S3025). More specifically, the update processing instruction group 2263 assigns the value of the selection parameter CP_2 to the selection parameter CP_1, and assigns the value of the selection identifier to the selection parameter CP_2. Here, the values of the selection parameters CP_1 and CP_2 change from “2” and “4”, respectively, to “4” and “3”, respectively. The update processing instruction group 2263 also decrements the modulus value NN. Here, the modulus value NN is updated from “7” to “6”.

The secret holding program 2200 performs the processing of the branch instruction group 2273 (step S3030). More specifically, the branch instruction group 2273 performs processing to branch to the selection processing instruction group 2220.

The secret holding program 2200 performs processing of the selection processing instruction group 2220 (step S3035). More specifically, the selection processing instruction group 2220 calculates the value IND with use of Expression 20, the selection parameters CP_1 (=4), CP_2 (=3), and the modulus value NN (=6). Here, the calculated value IND will be “1×4+2×3 mod 6=4”. The selection processing instruction group 2220 selects the fourth unexecuted one of the selection-target data pieces (2240, 2241, 2242, 2244, 2245 and 2246), which is the selection-target data piece 2245. The value of the selection identifier-use variable will be “5”.

The secret holding program 2200 performs the processing of The management information update instruction group 525 (step S3040).

More specifically, the management information update instruction group 525 updates the management information piece of the selection-target data piece 2245 corresponding to the selection identifier-use variable “5” so as to show “already executed”.

The secret holding program 2200 performs processing of the transition processing instruction group 530 (step S3045). More specifically, the transition processing instruction group 530 performs processing to branch to the selection-target data piece 2245 corresponding to the selection identifier-use variable “5”.

The secret holding program 2200 performs the processing of the selection-target main instruction group 555 included in the selection-target data piece 2245 (step S3050). More specifically, the selection-target data piece 2245 performs processing equivalent to the second provision instruction group that is part of the function provided by the program.

The secret holding program 2200 performs processing of the update processing instruction group 2265 (step S3055). More specifically, the update processing instruction group 2265 assigns the value of the selection parameter CP_2 to the selection parameter CP_1, and assigns the value of the selection identifier to the selection parameter CP_2. Here, the values of the selection parameters CP_1 and CP_2 change from “4” and “3”, respectively, to “3” and “5”, respectively. The update processing instruction group 2265 also decrements the modulus value NN. Here, the modulus value NN is updated from “6” to “5”.

The secret holding program 2200 performs the processing of the branch instruction group 2275 (step S3060). More specifically, the branch instruction group 2275 performs processing to branch to the selection processing instruction group 2220.

The secret holding program 2200 performs processing of the selection processing instruction group 2220 (step S3065). More specifically, the selection processing instruction group 2220 calculates the value IND with use of Expression 20, the selection parameters CP_1 (=3), CP_2 (=5), and the modulus value NN (=5). Here, the calculated value IND will be “1×3+2×5 mod 5=3”. The selection processing instruction group 2220 selects the third unexecuted one of the selection-target data pieces (2240, 2241, 2242, 2244, and 2246), which is the selection-target data piece 2244. The value of the selection identifier-use variable will be “4”.

The secret holding program 2200 performs the processing of the management information update instruction group 525 (step S3070). More specifically, the management information update instruction group 525 updates the piece of management information of the selection-target data piece 2244 corresponding to the selection identifier-use variable “4” so as to show “already executed”.

The secret holding program 2200 performs processing of the transition processing instruction group 530 (step S3075). More specifically, the transition processing instruction group 530 performs the processing to branch to the selection-target data piece 2242 corresponding to the selection identifier-use variable “4”.

The secret holding program 2200 performs the processing of the selection-target main instruction group 554 included in the selection-target data piece 2244 (step S3080). More specifically, the selection-target data piece 2244 performs processing equivalent to the third provision instruction group that is part of the function provided by the program.

The secret holding program 2200 performs processing of the update processing instruction group 2264 (step. S3085). More specifically, the update processing instruction group 2264 assigns the value of the selection parameter CP_2 to the selection parameter CP_1, and assigns the value of the selection identifier to the selection parameter CP_2. Here, the values of the selection parameters CP_1 and CP_2 change from “3” and “5”, respectively, to “5” and “4”, respectively. The update processing instruction group 2264 also decrements the modulus value NN. Here, the modulus value NN is updated from “5” to “4”.

The secret holding program 2200 performs the processing of the branch instruction group 2274 (step S3090). More specifically, the branch instruction group 2274 performs processing to branch to the program that invoked the secret holding program 2200.

5.2 Program Obfuscation Apparatus 3010

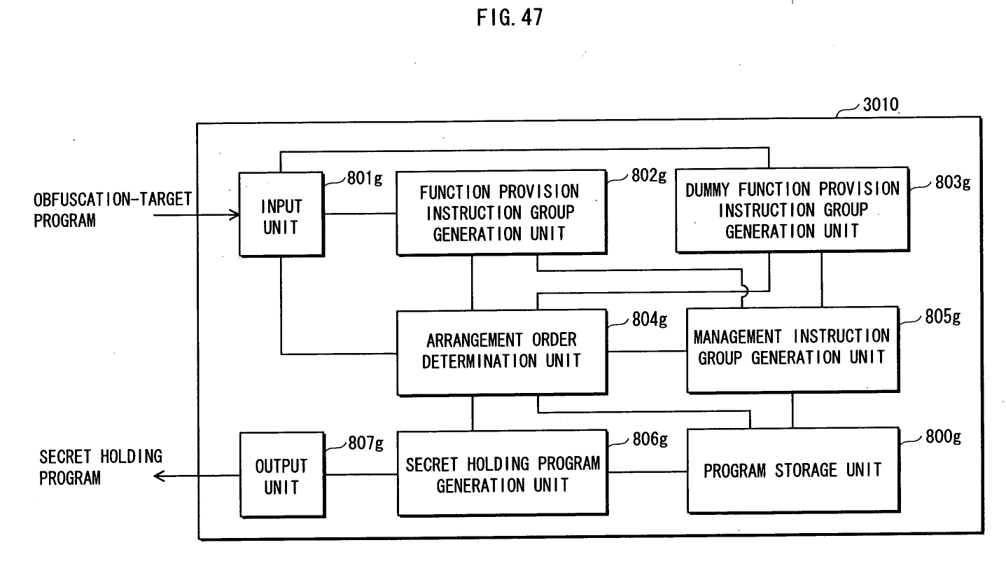

As shown in FIG. 47, the program obfuscation apparatus 3010 is, composed of a program storage unit 800g, an input unit 801g, a function provision instruction group generation unit 802g, a dummy function provision instruction group generation unit 803g, an arrangement order determination unit 804g, a management instruction group generation unit 805g, a secret holding program generation unit 806g, and an output unit 807g.

The program obfuscation apparatus 3010 is, specifically, a computer system composed of a microprocessor, a ROM, a RAM, a hard disk unit, a display unit, a keyboard, a mouse, and the like. A computer program is stored in the RAM or the hard disk unit. Here, the computer program is a combination of instruction codes showing instructions for a computer for achieving predetermined functions. The program obfuscation apparatus 3010 achieves its functions by the microprocessor operating in accordance with the computer program. In other words, the microprocessor reads the instruction in the computer program one instruction at a time, decodes the read instruction, and operates in accordance with the result of decoding.

Note that the program storage unit 800g, the input unit 801g, the function provision instruction group generation unit 802g, the dummy function provision instruction group generation unit 803g, the management instruction group generation unit 805g, the secret holding program generation unit 806g, and the output unit 807g are the same as the program storage unit 800, the input unit 801, the function provision instruction group generation unit 802, the dummy function provision instruction group generation unit 803, the management instruction group generation unit 805, the secret holding program generation unit 806, and the output unit 807, respectively, shown in the third embodiment, and therefore a description thereof is omitted.

The difference between the arrangement order determination unit 804 and the arrangement order determination unit 804g is that the two use different arithmetic expression for calculating the selection identifier, and in the latter, the modulus value changes in the arithmetic expression.

The following describes the arrangement order determination unit 804g.

Although not illustrated, the arrangement order determination unit 804g includes a control unit 850g, a selection processing unit 851.g, a management information updating unit 852g, an update processing unit 853g and a management holding unit 854g. These compositional elements are connected to each other in the same way as the compositional elements of the arrangement order determination unit 804 shown in FIG. 26.

Using the initial values of the selection parameters, the arrangement order determination unit 804g determines selection-target main instruction groups in which the function provision instruction groups and the dummy function provision instruction groups are to be arranged, by checking-what order the selection identifier will actually be calculated in. Note that, as in the third embodiment, in the present embodiment it is assumed that the initial values of the selection parameters are received hereby the input unit 801g, and that the initial values of the selection parameters CP_1 and CP_2 are “2” and “4”.

(1) Management Information Holding Unit 854g

The management information holding unit 854g is the same as the management information holding unit 854, and therefore a description is omitted. Note that the management information table T800 is referred in the following description when necessary.

(2) Control Unit 850g

The control unit 850g has a parameter storage area for storing the selection parameter group.

The control unit 850g stores the initial values CP_1 and CP_2 (here, “2” and “4”, respectively) of the selection parameters received by the input unit 801g, in the parameter storage area.

Furthermore, at the commencement of processing, the control unit 850g sets an initial value “7” in the modulus value NN, and stores the initial value of the modulus value NN in the parameter storage area.

The control unit 850g controls the operations of the selection processing unit 851g, the management information updating unit 852g, and the update processing unit 853g.

The control unit 850g puts in correspondence each of the possible values of Expression 20 of the selection processing unit 851g, in other words the possible values that the selection identifier may have according to Expression 20, with the respective selection-target data pieces stored in the program storage unit 800g.

The control unit 850g acquires the i-th generated function provision instruction group from the function provision instruction group generation unit 802g. Based on the selection identifier acquired by the selection processing unit 851g, the control unit 850g inserts the acquired i-th function provision instruction group in the corresponding selection-target data piece stored in the program storage unit 800g. Here, i is an integer that is no less than 1 and no greater than m. The control unit 850g also temporarily stores the correspondence between i-th function provision instruction group and the selection-target data piece in which the i-th function provision instruction group is inserted.

The control unit 850g acquires one of the dummy function provision instruction groups that has not been inserted into a selection-target data piece, from the dummy function provision instruction group generation unit 803g. The control unit 850g inserts the acquired dummy function provision instruction group into a selection-target data piece that has not had an i-th function provision instruction group or a dummy function provision instruction group inserted therein. The control unit 850g performs these operations with respect to all dummy function provision instruction groups.

As a result of these operations, the control unit 850g inserts an i-th function provision instruction group or a dummy function provision instruction group into each selection-target data piece.

The operations by the control unit 850g for acquiring an i-th function provision instruction group enable acquisition of a function provision instruction group that is an arrangement-target.

(3) Selection Processing Unit 851g

The selection processing unit 851g acquires the selection parameters CP_1 and CP_2 and the modulus value NN stored in the parameter storage area, and calculates the value IND with use of the acquired values and Expression 20.

The selection processing unit 851g acquires the selection identifier with use of the calculated value IND and the management information table T800.

The following describes how the selection identifier is acquired.

Assume that the management information pieces in the management information table T800 are an 0-th piece, a 1st piece, and so on, in order starting from the management information piece having the value “0”. The selection processing unit 851g acquires the management information piece matching the calculated value IND. The selection processing unit 851g acquires the selection identifier of the selection-target data piece corresponding to the acquired management information piece.

The operations by the selection processing unit 851g, and the operations by the control unit 850g for inserting the i-th function provision instruction group into a selection-target data piece based on the selection identifier acquired by the selection processing unit 851g enable function provision instruction groups to be arranged in appropriate locations.

(4) Management Information Updating Unit 852g

The management information updating unit 854g is the same as the management information updating unit 852, and therefore a description is omitted.

The update processing instruction unit 853g updates the selection parameters CP_1 and CP_2, and the modulus value NN stored in the parameter storage area.

Here, the update processing instruction unit 853g assigns the value of the selection parameter CP_2 to the selection parameter CP_1, and assigns the value of the selection identifier-use variable to the selection parameter CP_2, thereby updating the values of the selection parameters. The update processing instruction unit 853g overwrites the selection parameters CP_1 and CP_2 in the parameter storage area with the updated selection parameters CP_1 and CP_2. The update processing unit 853g decrements the value of the modulus value NN, and overwrites the modulus value NN in the parameter storage area with the updated modulus value NN.

5.3 Operations of Program Obfuscation Apparatus 3010

The program obfuscation apparatus 3010 generates a secret holding program by executing arrangement determination processing described below, instead of step S620 shown in FIG. 27.

5.3.1 Arrangement Determination Processing

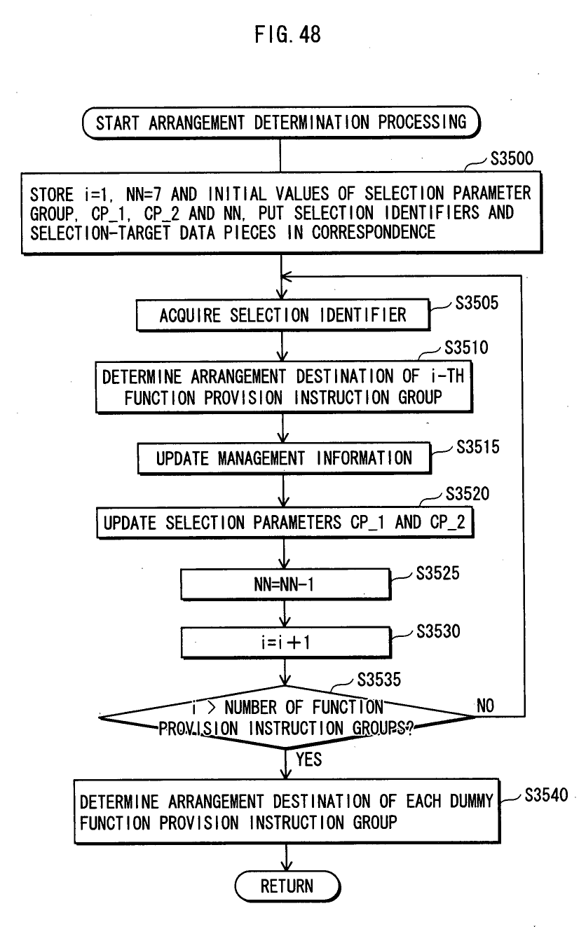

Referring to the flowchart in FIG. 48, the following describes operations for arrangement determination processing.

The control unit 850g sets the count i to “1”, sets the modulus value NN to an initial value of “7”, and stores the initial values “2”, “4” and “7” of the selection parameters CP_1 and CP_2, and the modulus value NN in the parameter storage area. The control unit 850g puts each value of the selection identifier in correspondence with a selection-target data piece (step S3500). The counter i expresses which number in the execution order the function provision instruction group is currently being focused on should be executed. In other words, here the control unit 850g determines the order of arrangement in order starting from the first function provision group.

The selection processing unit 851g acquires the selection parameters CP_1 and CP_2 and the modulus value NN stored in the parameter storage area, calculates the value IND with use of the acquired values and Expression 20. The selection processing unit 851g acquires the selection identifier with use of the calculated value IND and the management information table T800 (step S3505). As one example, when the values of the selection parameters CP_1 and CP_2 are “2” and “4” and the modulus value NN is “7”, the value of Expression 20 will be “1×2+2×4 MOD 7=3”. Using the management information table T800, the selection processing unit 851g selects the third unexecuted one of the selection-target data pieces (2240, 2241, 2242, 2243, 2244, 2245 and 2246), which is the selection-target data piece 2243. The value of the selection identifier-use variable will be “3”. Here, “unexecuted” denotes that the function provision instruction group has not been arranged in a selection-target data piece, and “already executed” denotes that the function provision instruction group has already been arranged in a selection-target data piece.

The control unit 850g inserts the i-th function provision instruction group in the corresponding selection-target data piece, based on the selection identifier acquired by the selection processing unit 851g (step S3510). As one example, if cont=1 and the value of the selection identifier is “3”, the first function provision instruction group will be arranged in the selection-target data piece 2243.

The management information updating unit 852g updates, from “0” to “1”, the value of the one of the management information pieces in the management information table T800 that corresponds to the selection identifier acquired by the selection processing unit 851g (step S3515). As one example, when the value of the selection identifier is “3”, the management information updating unit 852g changes the management information piece corresponding to the selection-target data piece 2243 in the management information table T800 of the selection information holding unit 854g from showing “unarranged” to “already arranged”.

The update processing unit 853g updates the selection parameters CP_1 and CP_2 stored in the parameter storage area, and writes the updated value to the parameter storage area (step S3520). A description of how the updating is performed is omitted here as it is has been described above. As one example, when the values of the selection parameters CP_1 and CP_2 are “2” and “4”, respectively, and the value of the selection identifier is “3”, the value of the selection parameters CP_1 and CP_2 will be “4” and “3”, respectively. The update processing unit 853g decrements the value of the modulus value NN, and overwrites the modulus value NN in the parameter storage area with the updated modulus value NN (step S3525).

The control unit 850g adds “1” to the value of the counter (step S3530).

The control unit 850g judges whether or not the value of the counter i is greater than the number of function provision instruction groups (step S3535).

When it is judged that the value of the counter i is not greater (“NO” at step S3535), the control unit 850g returns to step S3505, and controls operations of the selection-processing unit 851g.

When it is judged that the value of the counter i is greater (“YES” at step S3535), the control unit 850g determines where to arrange the dummy function provision instruction groups, such that each is arranged in a selection-target data piece that does not yet have a function provision group inserted therein (step S3540). As one example, when the selection-target data pieces 540, 541, 542 and 544 have not yet been executed, the control unit 850g determines that the dummy function provision instruction groups are to be arranged in the selection-target data pieces 2240, 2241, 2242 and 2244, and inserts the dummy function provision groups in the selection-target data pieces.

5.4 Modifications

(1) In the fifth embodiment, although the secret holding program stores input values from the invoker program as initial values of the selection parameters, the secret holding program is not limited to this structure. The secret holding program may use values acquired from another device on a network as the initial values of the selection parameters, or may use output values obtained as a result of executing another program in a program execution device as the initial values of the selection parameters.

(2) In the fifth embodiment, it is not necessary for the number of function provision instruction groups to be three and the number of dummy function provision instruction groups to be four as described, as long as the number of function provision groups is a plural number and the number of dummy function provision groups is at least one.

(3) Although in the fifth embodiment the secret processing apparatus 3020 is realized in the form of a program execution apparatus that uses a program as described, the secret processing apparatus is not limited to this, and may instead be implemented as hardware.

(4) The described embodiment and the modification examples may be combined.

5.5 Effects of the Fifth Embodiment

In the present embodiment, the selection processing instruction group 2220 selects the selection-target data piece to be selected next only from among unexecuted selection-target data pieces. Therefore, even if a malicious analyzer whose knows that the obfuscation-target data does not execute the same selection-target data piece twice performs an exhaustive search changing the initial values of the selection parameter group, no selection-target data piece will be selected twice, regardless of the initial values. This makes it difficult for the analyzer to figure out the wrong values efficiently based on whether or not a same program instruction is executed twice.

Furthermore, in the present embodiment, selection-target data pieces are selected uniquely one at a time according to the input values in_1 and in_2. The reason for this is as follows. First, a non-negative integer in_1 that is 6 or lower (seven types exists) is used to select one of the seven selection-target data pieces 2240 to 2246. Next, a non-negative integer in_2 that is 5 or lower (six types exists) is used to select one of the six unexecuted selection-target data pieces (i.e., six pieces excluding the one of the selection-target data pieces 2040i to 2046 selected with use of in1). Since the possible number of values of the input in_k (k=1, 2) is the same as the number of possible selections of selection-target data pieces, these selections determine uniquely with use of in_1 and in_2. Therefore, selection-target data pieces as selected uniquely according to the input values in_1 and in_2. By selecting selection-target data pieces uniquely in this way, the number of variations for selecting a selection-target data piece with respect to the input values does not decrease, and the number of combinations when an attacker performs an exhaustive search does not decrease.

### 6. Modifications

The present invention has been described based on, but is by no means limited to, the above embodiments, and may be implemented in various forms that do not depart from the scope thereof. Cases such as the following are included in the present invention.

(1) The expression that the selection processing instruction group uses to calculate the selection identifier in the third embodiment is not limited to being Expression 3 “p1×(selection parameter CP_1)+p2×(selection parameter CP_2) mod NN”. For instance, it is suitable for the expression to fulfill a condition that the calculation results correspond one-to-one with the values of the selection parameter CP_2 if the value of the selection parameter CP_1 is fixed. In Expression 3, if the selection parameter CP_2 has a value less than NN, since p2 and NN are coprimes, if NN possible values of the selection parameter CP_2 exist, a number NN of “p2×(selection parameter CP_2) mod NN” will correspondingly also exist.

Similarly, the arithmetic expression used in the fifth embodiment is not limited to being Expression 20. For instance, it is suitable for the expression to fulfill a condition that the calculation results of the expression correspond one-to-one with the values of the selection parameter CP_2 if the value of the selection parameter CP_1 is fixed.

(2) In each of the embodiments, the order of the selection-target main instruction groups and the transition processing instruction groups may be switched. Furthermore, in the third embodiment, although the update processing instruction groups 560 to 566 are included in the selection-target data pieces 540 to 546, an alternative structure is to arrange only one update processing instruction group after the management information update processing instruction group 525. Furthermore, although only one exists of each of the selection processing instruction group 520, the management update processing instruction group 525 and the transition processing instruction group 530, an alternative structure is to arrange these three instruction groups instead of the branch instruction groups 570 to 576 in the selection-target data pieces.

This also applies to the fourth and fifth embodiments.

(3) It is not imperative that each instruction group is an independent instruction group. A means that combines the functions provided by a plurality of function groups may be used.

(4) In the third, fourth and fifth embodiments, a method is used by which, when the calculated selection identifier corresponds to already-executed selection-target data, the next closest value corresponding to an unexecuted selection identifier is calculated. However, the calculation method is not limited to this. For instance, a calculation method may be used by which a selection identifier is repeatedly calculated at random, and then a judgment may be made as to whether or not the corresponding selection-target data piece has been executed or not. This calculation method makes analysis by a malicious analyzer difficult.

(5) In each of the embodiments and modifications, the function provision instruction groups, the dummy function provision instruction groups and the management instruction groups are not limited to being generated in the described order. The steps may be executed in any order as long as they are completed before the step for generating the secret holding program using the generated instruction groups. As one example, the order in which the dummy function provision instruction groups and the function provision instruction groups are generated may be opposite to the described order.

(6) Each of the numerical values given in the preferred embodiments is simply one example, and the numerical values used are not limited to these examples. For instance, the number of selection-target data pieces and the number of initial values may be increased, or the initial values may be different ones to those described.

Increasing the number of initial values makes analysis more difficult.

(7) In the first embodiment, the secret holding program is not limited to including one or more dummy function provision groups.

It is not necessary for the secret holding program to include any dummy function provision instruction groups.

Similarly, in the third, fourth and fifth embodiments, it is also unnecessary for the secret holding program to include any dummy function provision instruction groups.

(8) In each of the secret processing apparatuses and the secret holding programs in the described embodiments, the selection-target data pieces are instruction groups generated by dividing a program. Not limited to this structure, any information by which an appropriate result can be obtained when the information is used in some kind order is possible. As one specific example, in the case of multiple layers of encryption that have a particular order according to a plurality of encryption keys, the encryption keys could be treated as selection-target data pieces. This also applies to the secret holding program.

(9) The secret processing apparatuses and secret holding programs of the described embodiments have a structure of receiving initial values of selection parameters, and updating those values internally, but are not limited to this structure. For instance, the values of the selection parameters may be updated outside the secret processing apparatus or the like, and then the secret processing apparatus or the like may receive the updated values. Alternatively, all selection parameters used until the end of processing by the secret processing apparatus may be received as data in an array, and operations may be performed according to the data array. This also applies to the secret holding program.

(10) The selection identifier calculation method used in the first embodiment may be any of the selection identifier calculation methods used in the third embodiment, the fourth embodiment, and the fifth embodiment.

(11) In the first embodiment, the program obfuscation apparatus 10 is not limited to calculating the values corresponding to the arrangement positions of the blocks using Expression 1.

The program obfuscation apparatus 10 may use an arithmetic expression for calculating an address of where to arrange a block. Here, using the arithmetic expression, the program execution apparatus 20 calculates the address of the next block to execute.

Similarly, in the third, fourth and fifth embodiments, the program obfuscation apparatus may use the arithmetic expression to calculate the address of where to arrange a block.

(12) In the present invention, “variable” is not limited to a variable in a specific language, but may be the storage contents of a register, cache, RAM, HDD or any other rewritable memory, or storage contents at a location designated by a value written in any of these memories.

(13) In the first embodiment, the update processing instruction group is not limited to being arranged so as to be directly after the selection-target main instruction group. The update processing instruction group may instead be inserted in the selection-target main instruction group.

Here, a case in which the update processing instruction group is arranged to be directly after the program instruction group that is last among the one or more program instruction groups in the selection-target main instruction group is also considered to be a case of the update processing instruction group being inserted in the selection-target main instruction group.

The update processing instruction group being inserted directly after the program instruction group that is last among the one or more program instruction groups in the selection-target main instruction group is the same as the update processing instruction group being arranged so as to be directly after the selection-target main instruction group.

(14) In the above embodiments, when updating the selection parameters, a previously calculated selection identifier is assigned to a selection parameter. However, the selection parameters are not limited to being updated in this manner.

A calculation may be applied to the calculated selection identifier, and the selection parameter updated using the calculation result. As one example, A=(value of calculated selection identifier)+1, and the value of A is assigned to the selection parameter. As another example, A=(value of calculated selection identifier)×3, and the value of A is assigned to the selection parameter.

Furthermore, the value of a selection identifier showing a selection-target data piece processed at some point in the past may be assigned to the selection parameter. One example of this is the selection-target data piece selected two selections ago. In other words, any manner of assigning a value to a selection parameter that reflects a selection identifier showing a selection-target data piece selected in the past is suitable. Here, a selection identifier showing a selection-target data piece selected at some point in the past includes a selection identifier showing a selection-target data piece currently selected.

For instance, a selection parameter may be updated using a selection identifier showing a selection-target data piece calculated the previous time, and a selection identifier showing a selection-target data piece calculated two or more times ago. As one specific example, A=(selection identifier calculated previous time)+(selection identifier calculated two times ago), and the selection parameter is assigned to A.

(15). In the present invention, an instruction group consists of one or more instructions. In other words, an instruction group in the present invention may consist of only one instruction.

(16) The selection identifier is not limited to being calculated using a plurality of selection parameters in the first embodiment.

The selection identifier may be calculated using one or more of the plurality of selection parameters. For instance, if three selection parameters A, B and C exist, the selection parameters A and B may be used when calculating a particular selection identifier, and the selection parameters A and C may be used when calculating another selection identifier.

Similarly, in the second, third, fourth and fifth embodiments, a selection parameter may be calculated using one or more of a plurality of selection parameters.

(17) In the second embodiment, although each selection-target data piece stores one data piece, the selection-target data pieces are not limited to storing only one data piece.

The number of pieces of data stored in a selection-target data piece may be one or greater.

(18) In the second embodiment, the selection parameters are not limited to being updated by assigning the value of the selection identifier to an update-target selection parameter.

A calculation may be applied to the value of the selection identifier, and the calculation result may be assigned to the update-target selection parameter. For instance, a constant may be added to the value of the selection identifier, and the result of the addition may be assigned to the update-target selection parameter.

Similarly, in the third, fourth and fifth embodiment, a calculation may be applied to the value of the selection identifier, and the calculation result may be assigned to the update-target selection parameter.

Furthermore, the program obfuscation apparatus in the second embodiment is not limited to converting secret information into a secret information-use variable when generating the secret holding program.

The program obfuscation apparatus may convert the secret information into an arithmetic expression that includes a secret information-use variable. For instance, the secret information may be converted into an arithmetic expression that is the sum of the secret information-use variable and a constant.

(19) All or part of the compositional elements of each apparatus may be composed of one system LSI (Large Scale Integrated circuit). The system LSI is a super-multifunctional LSI on which a plurality of compositional units are manufactured integrated on one chip, and is specifically a computer system that includes a microprocessor, a ROM, a RAM, or the like. A computer program is stored in the RAM. The system LSI achieves its functions by the microprocessor operating according to the computer program. Furthermore, the units that are the compositional elements of each of the apparatuses may be realized separately with individual chips, or part or all may be included on one chip. Here, the LSI may be an IC, a system LSI, a super LSI, or ultra LSI, depending on the degree of integration. Furthermore, the integration of circuits is not limited to being realized with LSI, but may be realized with a special-purpose circuit or a general-use processor. Alternatively, the integration may be realized with use of an FPGA (field programmable gate array) that is programmable after manufacturing of the LSI, or a re-configurable processor that enables re-configuration of the connection and settings of circuit cells in the LSI.

Furthermore, if technology for an integrated circuit that replaces LSIs appears due to advances in or derivations from semiconductor technology, that technology may be used for integration of the functional blocks. Bio-technology is one possible application.

(20) Part or all of the compositional elements of each apparatus may be composed of a removable IC card or a single module. The IC card or the module is a computer system composed of a microprocessor, a ROM, a RAM, or the like. The IC card or the module may be included the aforementioned super-multifunctional LSI. The IC card or the module achieves its functions by the microprocessor operating according to computer program. The IC card or the module may be tamper-resistant.

(21) The present invention may be methods shown by the above. Furthermore, the methods may be a computer program realized by a computer, and may be a digital signal of the computer program.

(22) Furthermore, the present invention may be a computer-readable recording medium such as a flexible disk, a hard disk, a CD-ROM, an MO, a DVD, a DVD-ROM, a DVD-RAM, a BD (Blu-ray Disc) or a semiconductor memory, that stores the computer program or the digital signal. Furthermore, the present invention may be the computer program or the digital signal recorded on any of the aforementioned recording media.

(23) Furthermore, the present invention may be the computer program or the digital signal transmitted on a electric communication network, a wireless or wired communication network, a network of which the Internet is representative, or a data broadcast.

(24) Furthermore, the present invention may be a computer system that includes a microprocessor and a memory, the memory storing the computer program, and the microprocessor operating according to the computer program.

(25) Furthermore, by transferring the program or the digital signal to the recording medium, or by transferring the program or the digital signal via a network or the like, the program or the digital signal may be executed by another independent computer system.

(26) The present invention may be any combination of the above-described embodiment and modifications.

### INDUSTRIAL APPLICABILITY

The secret processing apparatus and secret holding program of the present invention make it difficult for a malicious attacker to make an attack when processing of secret information, such as an encryption key, is performed. Therefore, the secret processing apparatus and the secret holding program of the present invention are useful in the field of apparatuses and the like that perform processing using secret information that should not be leaked to a malicious analyzer due to the detrimental effect of such leakage.

Furthermore, by converting a program that processes secret information such as an encryption key, into a form that is difficult to analyze, the program obfuscation apparatus of the present invention is useful in the field of software and the like that performs processing using secret information that should hot be leaked to a malicious analyzer due to the detrimental effect of such leakage.

The described program obfuscation apparatus can be manufactured and sold managerially, in other words, repeatedly and continuously, in the electronic device manufacturing industry.

1. A program conversion apparatus for generating a secret holding program from an original program, comprising:
a program acquisition unit operable to acquire an original program;
a selection-target data generation unit operable to generate a plurality of selection-target data pieces that, by processing in a predetermined order, output an execution result identical to a result of the original program, each of the selection-target data pieces being in correspondence with a different selection identifier;
a preprocessing instruction group generation unit operable to generate a preprocessing instruction group that assigns a value to each of a plurality of selection parameters;
a selection processing instruction group generation unit operable to generate a selection processing instruction group that includes an instruction group that acquires, in accordance with an arithmetic expression that uses the selection parameters, a selection identifier that shows a one of the selection-target data pieces that is to be processed next;
an update processing instruction group generation unit operable to generate an update processing instruction group that updates a value of each selection parameter so as to reflect one of (a) a selection identifier showing one of the selection-target data pieces that has already been processed, and (b) at least one of one or more values that have already been assigned to the selection parameters; and
a secret holding program generation unit operable to generate a secret holding program that (a) includes the preprocessing instruction group, the selection processing instruction group, the update processing instruction group, and the selection-target data pieces, and (b) repeatedly performs (i) processing to execute the selection processing instruction group, (ii) processing to process a one of the selection-target data pieces that is shown by the selection identifier acquired by the selection processing instruction group, and (iii) processing to execute the update processing instruction group.

2. The program conversion apparatus of claim 1, wherein
the predetermined order is an order of selection identifiers successively calculated by, after giving a predetermined initial value to each selection parameter, repeatedly executing the selection processing instruction group and the update processing instruction group.

3. The program conversion apparatus of claim 2, wherein
each selection-target data piece is composed of one or more data pieces.

4. The program conversion apparatus of claim 3, wherein
the original program includes secret information that is to be kept confidential,
the selection processing instruction group generation unit generates a selection processing instruction group composed of an instruction group that calculates the selection identifier according to a first arithmetic expression that uses the selection parameters,
the update processing instruction group generation unit generates an update processing instruction group for updating the selection parameters in accordance with a value of the one of the selection-target data pieces shown by the calculated selection target identifier, and
the program conversion apparatus further comprises:
a transition processing instruction group generation unit operable to generate a transition processing instruction group for calculating a value the same as a value of the secret information, according to a second arithmetic expression that uses the updated selection parameters,
wherein the secret holding program generation unit arranges the generated transition processing instruction group in a position that is between a position of the update processing instruction group and a position of the secret information, and replaces the secret information with processing for calculating the secret information by way of the transition processing instruction group.

5. The program conversion apparatus of claim 2, further comprising:
a dividing unit operable to divide the original program into one or more blocks, wherein
each of the selection-target data pieces includes a different one of the blocks.

6. The program conversion apparatus of claim 5, wherein
each of the selection parameters is a different one of first to n-th selection parameters,
the update processing instruction group generation unit generates an update processing instruction processing group for, with respect to each selection-target data piece, shifting a value stored in a (j−1)-th selection parameter to a j-th selection parameter, and storing a constant value in the first selection parameter, where j is an integer no less than 2 and no greater than n.

7. The program conversion apparatus of claim 6, wherein
the number of selection-target data pieces is a predetermined number that is equal to or greater than the number of blocks,
the arithmetic expression calculates a Pi×i-th selection parameter with respect to each of the first to n-th selection parameters, adds each of results of the calculations, subjects a result of the addition to a modulo operation in which a modulo value N is the predetermined number, and thereby generates a selection identifier,
where i is an integer no less than 1 and no greater than n, and
Pi and the modulo value N are coprimes.

8. The program conversion apparatus of claim 5, wherein
the selection-target data generation unit includes:
an identifier storage sub-unit operable to store each selection identifier that has been calculated according to the arithmetic expression up to a current point in time;
an execution sub-unit operable to select one value for one of the blocks, shift a value stored in a (j−1)-th selection parameter to a j-th selection parameter, store the selected value in a first selection parameter, and then execute the arithmetic expression, where j is an integer no less than 2 and no greater than n;
a judgment sub-unit operable to judge whether or not any of the selection identifiers stored in the storage sub-unit is identical to a calculated value;
a block storing sub-unit operable to, when a result of the judgment by the judgment sub-unit is negative, set the selection value as the constant value for the one block, and store the one block in a one of the selection-target data pieces shown by the calculated value; and
a repeat control unit operable to, when the result of the judgment by the judgment sub-unit is affirmative, control such that the processing by the execution sub-unit and the judgment sub-unit is repeated until the constant value is determined and the one selection block is stored in the one of the selection-target data pieces, wherein
the processing by the selection-target data generation unit is executed with respect to all of the blocks.

9. The program conversion apparatus of claim 5, wherein
the selection processing instruction group generation unit generates a selection processing instruction group that always acquires an identifier showing an unexecuted selection-target data piece.

10. The program conversion apparatus of claim 9, wherein
the selection processing instruction group generation unit generates a selection processing instruction group for acquiring an identifier showing an unexecuted selection-target data piece with use of management information that shows, for each of the selection-target data pieces, whether the selection-target data piece has already been executed or not.

11. The program conversion apparatus of claim 10, wherein
each of the selection parameters is a different one of first to n-th selection parameters, the management information is an array table showing a status of each of the selection-target data pieces at a current point in time, the status being one of already-executed and unexecuted,
the number of selection-target data pieces is a predetermined number that is equal to or greater than the number of blocks,
the selection processing instruction group generation unit generates
(a) the array table,
(b) the arithmetic expression that calculates a Pi×i-th selection parameter with respect to each of the first to n-th selection parameters, adds each of results of the calculations, subjects a result of the addition to a modulo operation in which a modulo value N is the predetermined number, and thereby generates a provisional selection identifier showing a one of the selection-target data pieces that includes a one of the blocks to be executed next, where i is an integer no less than 1 and no greater than n, and
(c) an acquisition program generation group for, (i) when the one of the selection-target data pieces shown by the calculated provisional selection identifier is shown in the array table as being unexecuted, setting the provisional selection identifier as a true selection identifier showing a one of the selection-target data pieces that includes the block to be executed next, and (ii) when the one of the selection-target data pieces shown by the calculated provisional selection identifier is shown in the array table as being already-executed, continue to acquire provisional selection identifiers in accordance with a predetermined selection order, until an unexecuted one of the selection-target data pieces is acquired, and
the selection processing instruction group includes the array table, the arithmetic expression, and the acquisition program instruction group,
where Pi and the modulo value N are coprimes.

12. The program conversion apparatus of claim 11, wherein
the update processing instruction group generation unit generates the update processing instruction group for shifting a value stored in a j-th selection parameter to a (j−1)-th selection parameter, and storing the true selection identifier in an n-th variable,
where j is an integer no less than 2 and no greater than n.

13. The program conversion apparatus of claim 10, wherein
the arithmetic expression is a first acquisition program instruction group that acquires one selection parameter from among the selection parameters, with use of an index showing the one selection parameter,
the management information is an array table showing a status of each of the selection-target data pieces at a current point in time, the status being one of already-executed and unexecuted,
the selection processing instruction group generation unit generates
(a) the first program instruction group,
(b) the array table, and
(c) a second acquisition program instruction group that, in accordance with an array order of one or more selection identifiers showing one or more selection-target data pieces that are shown in the array table as being unexecuted, acquires a selection identifier whose place in the order is shown by a value of the selection parameter acquired by the acquisition program instruction group, and
the selection processing instruction group includes the first program instruction group, the array table, and the second acquisition program instruction group.

14. The program conversion apparatus of claim 13, wherein
the update processing instruction group generation unit generates the update processing instruction group that increments a value of the index.

15. The program conversion apparatus of claim 10, wherein
the number of selection-target data pieces is a predetermined number that is equal to or greater than the number of blocks,
each of the selection parameters is a different one of first to n-th selection parameters,
the management information is an array table showing a status of each of the selection-target data pieces at a current point in time, the status being one of already-executed and unexecuted,
the selection processing instruction group generation unit generates
(a) the array table,
(b) the arithmetic expression that calculates a Pi×i-th selection parameter with respect to each of the first to n-th selection parameters, adds each of results of the calculations, subjects a result of the addition to a modulo operation in which a modulo value N is the predetermined number, and thereby calculates a value showing a one of the selection-target data pieces that includes a one of the blocks to be executed next, where i is an integer no less than 1 and no greater than n, and
(c) an acquisition program generation group for, in accordance with an array order of one or more selection identifiers showing one or more selection-target data pieces that are shown as being unexecuted in a table that is identical to the array table, acquiring a selection identifier whose place in the order is shown by a value of the selection parameter acquired according to the arithmetic expression, and
the selection processing instruction group includes the array table, the arithmetic expression, and the acquisition program instruction group.

16. The program conversion apparatus of claim 5, wherein
the number of selection-target data pieces is a predetermined number that is equal to or greater than the number of blocks, and
after the blocks have been incorporated into the selection-target data pieces, the secret holding program generation unit inserts a dummy block in each one or more of the selection-target data pieces into which none of the blocks has been incorporated, each dummy block being composed of one or more program instructions.

17. A secret processing apparatus for executing secret processing to be kept confidential, by processing a plurality of selection-target data pieces that have a predetermined order of processing, the secret processing apparatus comprising:
a preprocessing execution unit operable to assign a value to each of a plurality of selection parameters;
a selection processing execution unit operable to, in accordance with an arithmetic expression that uses the selection parameters, acquire a selection identifier that shows a one of the selection-target data pieces that is to be processed next;
an update processing execution unit operable to update a value of each selection parameter so as to reflect one of (a) a selection identifier showing one of the selection-target data pieces that has already been processed, and (b) at least one of one or more values that have already been assigned to the selection parameters; and
a selection-target data execution unit operable to process the one of the selection-target data pieces shown by the acquired selection identifier, wherein
the processing by the selection processing execution unit, the update processing execution unit and the selection-target data execution unit is repeated until it is deemed that the secret holding program ends.

18. The secret processing apparatus of claim 17, wherein
each selection-target data piece is composed of one or more data pieces.

19. The secret processing apparatus of claim 18, wherein
the secret processing is processing that calculates the secret information by executing predetermined processing instead of using the secret information to be kept confidential,
the selection processing execution unit calculates the selection identifier according to the arithmetic expression that uses the selection parameters,
the update processing execution unit updates the selection parameters in accordance with a value of the one of the selection-target data pieces shown by the selection identifier, and
the secret processing apparatus further comprises:
a transition processing instruction unit operable to calculate a value the same as a value of the secret information, according to the predetermined processing that uses the updated selection parameters.

20. The secret processing apparatus of claim 17, wherein
the secret processing is processing that executes an original program that has been divided into one or more blocks by an external apparatus,
each block includes one or more program instructions, and
each of the selection-target data pieces includes a different one of the blocks.

21. The secret processing apparatus of claim 20, wherein
each of the selection parameters is a different one of first to n-th selection parameters,
the update processing execution unit, with respect to each selection-target data piece, shifts a value stored in a (j−1)-th selection parameter to a j-th selection parameter, and stores a constant value in the first selection parameter, where j is an integer no less than 2 and no greater than n, and
the constant value is a value that is set in advance when the external apparatus generates the secret holding program, and set such that a selection identifier showing a one of the selection-target data piece to be executed next is calculated using the arithmetic expression.

22. The secret processing apparatus of claim 21, wherein
the number of selection-target data pieces is a predetermined number that is equal to or greater than the number of blocks, and
the arithmetic expression calculates a Pi×i-th selection parameter with respect to each of the first to n-th selection parameters, adds each of results of the calculations, subjects a result of the addition to a modulo operation in which a modulo value N is the predetermined number, and thereby generates a selection identifier,
where i is an integer no less than 1 and no greater than n, and
Pi and the modulo value N are coprimes.

23. The secret processing apparatus of claim 20, wherein
the selection processing execution unit always acquires an identifier showing an unexecuted selection-target data piece.

24. The secret processing apparatus of claim 23, wherein
the selection processing execution unit acquires an identifier showing an unexecuted selection-target data piece with use of management information that shows, for each of the selection-target data pieces, whether the selection-target data piece has already been executed or not.

25. The secret processing apparatus of claim 24, wherein
each of the selection parameters is a different one of first to n-th selection parameters,
the number of selection-target data pieces is a predetermined number that is equal to or greater than the number of blocks,
the management information is an array table showing a status of each of the selection-target data pieces at a current point in time, the status being one of already executed and unexecuted,
the selection processing execution unit holds the array table,
the arithmetic expression calculates a Pi×i-th selection parameter with respect to each of the first to n-th selection parameters, adds each of results of the calculations, subjects a result of the addition to a modulo operation in which a modulo value N is the predetermined number, and thereby generates a provisional selection identifier showing a one of the selection-target data pieces that includes a one of the blocks to be executed next, where i is an integer no less than 1 and no greater than n, and
the selection processing execution unit, (i) when the one of the selection-target data pieces shown by the calculated provisional selection identifier is shown in the array table as being unexecuted, sets the provisional selection identifier as a true selection identifier showing a one of the selection-target data pieces that includes the block to be executed next, and (ii) when the one of the selection-target data pieces shown by the calculated provisional selection identifier is shown in the array table as being already-executed, continues to acquire provisional selection identifiers in accordance with a predetermined selection order, until an unexecuted one of the selection-target data pieces is acquired,
where Pi and the modulo value N are coprimes.

26. The secret processing apparatus of claim 25, wherein
the update processing execution unit shifts a value stored in a j-th selection parameter to a (j−1)-th selection parameter, and store the true selection identifier in an n-th variable,
where j is an integer no less than 2 and no greater than n.

27. The secret processing apparatus of claim 24, wherein
the management information is an array table showing a status of each of the selection-target data pieces at a current point in time, the status being one of already-executed and unexecuted, and
the selection processing execution unit
(a) holds the array table, and
includes:
a first acquisition sub-unit operable to, using an index that shows a selection parameter, execute the arithmetic expression, to acquire the first selection parameter from the plurality of selection parameters; and
a second acquisition sub-unit operable to, in accordance with an array order of one or more selection identifiers showing one or more selection-target data pieces that are shown in the array table as being unexecuted, acquire a selection identifier whose place in the order is shown by a value of the selection parameter acquired by the acquisition program instruction group.

28. The secret processing apparatus of claim 27, wherein
the update processing execution unit increments a value of the index.

29. The secret processing apparatus of claim 24, wherein
the number of selection-target data pieces is a predetermined number that is equal to or greater than the number of blocks,
each of the selection parameters is a different one of first to n-th selection parameters,
the management information is an array table showing a status of each of the selection-target data pieces at a current point in time, the status being one of already-executed and unexecuted,
the selection processing execution unit holds the array table,
the arithmetic expression that calculates a Pi×i-th selection parameter with respect to each of the first to n-th selection parameters, adds each of results of the calculations, subjects a result of the addition to a modulo operation in which a modulo value N is the predetermined number, and thereby calculates a provisional selection identifier showing a one of the selection-target data pieces that includes a one of the blocks to be executed next, where i is an integer no less than 1 and no greater than n, and
the selection processing execution unit, in accordance with an array order of one or more selection identifiers showing one or more selection-target data pieces that are shown as being unexecuted in a table that is identical to the array table, acquires a selection identifier whose place in the order is shown by a value of the selection parameter acquired according to the arithmetic expression.

30. The secret processing apparatus of claim 20, wherein
the secret processing is processing that executes a secret holding program generated from the original program by the external apparatus,
the number of selection-target data pieces is a predetermined number that is equal to or greater than the number of blocks,
each of one or more of the selection-target data pieces that do not include a block includes a dummy block, each dummy block being composed of one or more program instructions, and
the secret holding program includes the blocks divided from the original program, and one or more dummy blocks.

31. A conversion method used in a program conversion apparatus for generating a secret holding program from an original program, the conversion method comprising:
a program acquisition step of acquiring an original program;
a selection-target data generation step of generating a plurality of selection-target data pieces that, by processing in a predetermined order, output an execution result identical to a result of the original program, each of the selection-target data pieces being in correspondence with a different selection identifier;
a preprocessing instruction group generation step of generating a preprocessing instruction group that assigns a value to each of a plurality of selection parameters;
a selection processing instruction group generation step of generating a selection processing instruction group that includes an instruction group that acquires, in accordance with an arithmetic expression that uses the selection parameters, a selection identifier that shows a one of the selection-target data pieces that is to be processed next;
an update processing instruction group generation step of generating an update processing instruction group that updates a value of each selection parameter so as to reflect one of (a) a selection identifier showing one of the selection-target data pieces that has already been processed, and (b) at least one of one or more values that have already been assigned to the selection parameters; and
a secret holding program generation step of generating a secret holding program that (a) includes the preprocessing instruction group, the selection processing instruction group, the update processing instruction group, and the selection-target data pieces, and (b) repeatedly performs (i) processing to execute the selection processing instruction group, (ii) processing to process a one of the selection-target data pieces that is shown by the selection identifier acquired by the selection processing instruction group, and (iii) processing to execute the update processing instruction group.

32. A conversion program used in a program conversion apparatus for generating a secret holding program from an original program, the conversion program causing the program conversion apparatus to execute the following steps:
a program acquisition step of acquiring an original program;
a selection-target data generation step of generating a plurality of selection-target data pieces that, by processing in a predetermined order, output an execution result identical to a result of the original program, each of the selection-target data pieces being in correspondence with a different selection identifier;
a preprocessing instruction group generation step of generating a preprocessing instruction group that assigns a value to each of a plurality of selection parameters;
a selection processing instruction group generation step of generating a selection processing instruction group that includes an instruction group that acquires, in accordance with an arithmetic expression that uses the selection parameters, a selection identifier that shows a one of the selection-target data pieces that is to be processed next;
an update processing instruction group generation step of generating an update processing instruction group that updates a value of each selection parameter so as to reflect one of (a) a selection identifier showing one of the selection-target data pieces that has already been processed, and (b) at least one of one or more values that have already been assigned to the selection parameters; and
a secret holding program generation step of generating a secret holding program that (a) includes the preprocessing instruction group, the selection processing instruction group, the update processing instruction group, and the selection-target data pieces, and (b) repeatedly performs (i) processing to execute the selection processing instruction group, (ii) processing to process a one of the selection-target data pieces that is shown by the selection identifier acquired by the selection processing instruction group, and (iii) processing to execute the update processing instruction group.

33. The conversion program of claim 32, stored on a computer-readable recording medium.

34. A secret processing method used in a secret processing apparatus for executing secret processing to be kept confidential, by processing a plurality of selection-target data pieces that have a predetermined order of processing, the secret processing method comprising:
a preprocessing execution step of assigning a value to each of a plurality of selection parameters;
a selection processing execution step of, in accordance with an arithmetic expression that uses the selection parameters, acquiring a selection identifier that shows a one of the selection-target data pieces that is to be processed next;
an update processing execution step of updating a value of each selection parameter so as to reflect one of (a) a selection identifier showing one of the selection-target data pieces that has already been processed, and (b) at least one of one or more values that have already been assigned to the selection parameters; and
a selection-target data execution step of processing the one of the selection-target data pieces shown by the acquired selection identifier.

35. A secret processing program used in a secret processing apparatus for executing secret processing to be kept confidential, by processing a plurality of selection-target data pieces that have a predetermined order of processing, the secret processing program causing the secret processing apparatus to execute the following steps:
a preprocessing execution step of assigning a value to each of a plurality of selection parameters;
a selection processing execution step of, in accordance with an arithmetic expression that uses the selection parameters, acquiring a selection identifier that shows a one of the selection-target data pieces that is to be processed next;
an update processing execution step of updating a value of each selection parameter so as to reflect one of (a) a selection identifier showing one of the selection-target data pieces that has already been processed, and (b) at least one of one or more values that have already been assigned to the selection parameters; and
a selection-target data execution step of processing the one of the selection-target data pieces shown by the acquired selection identifier.

36. The secret processing program of claim 35, stored on a computer-readable recording medium.

37. An integrated circuit for a program conversion apparatus for generating a secret holding program from an original program, the integrated circuit comprising:
a program acquisition unit operable to acquire an original program;
a selection-target data generation unit operable to generate a plurality of selection-target data pieces that, by processing in a predetermined order, output an execution result identical to a result of the original program, each of the selection-target data pieces being in correspondence with a different selection identifier;
a preprocessing instruction group generation unit operable to generate a preprocessing instruction group that assigns a value to each of a plurality of selection parameters;
a selection processing instruction group generation unit operable to generate a selection processing instruction group that includes an instruction group that acquires, in accordance with an arithmetic expression that uses the selection parameters, a selection identifier that shows a one of the selection-target data pieces that is to be processed next;
an update processing instruction group generation unit operable to generate an update processing instruction group that updates a value of each selection parameter so as to reflect one of (a) a selection identifier showing one of the selection-target data pieces that has already been processed, and (b) at least one of one or more values that have already been assigned to the selection parameters; and
a secret holding program generation unit operable to generate a secret holding program that (a) includes the preprocessing instruction group, the selection processing instruction group, the update processing instruction group, and the selection-target data pieces, and (b) repeatedly performs (i) processing to execute the processing selection instruction group, (ii) processing to process a one of the selection-target data pieces that is shown by the selection identifier acquired by the selection processing instruction group, and (iii) processing to execute the update processing instruction group.

38. An integrated circuit for a secret processing apparatus for executing secret processing to be kept confidential, by processing a plurality of selection-target data pieces that have a predetermined order of processing, the integrated circuit comprising:
a preprocessing execution unit operable to assign a value to each of a plurality of selection parameters;
a selection processing execution unit operable to, in accordance with an arithmetic expression that uses the selection parameters, acquire a selection identifier that shows a one of the selection-target data pieces that is to be processed next;
an update processing execution unit operable to update a value of each selection parameter so as to reflect one of (a) a selection identifier showing one of the selection-target data pieces that has already been processed, and (b) at least one of one or more values that have already been assigned to the selection parameters; and
a selection-target data execution unit operable to process the one of the selection-target data pieces shown by the acquired selection identifier, wherein
the processing by the selection processing execution unit, the update processing execution unit and the selection-target data execution unit is repeated until it is deemed that the secret holding program ends.
